(19) United States
(12) Patent Application Publication
(10) Pub. No.: US 2018/0046956 A1
(43) Pub. Date: Feb. 15, 2018

(54) Warning About Steps That Lead to an Unsuccessful Execution of a Business Process

(71) Applicant: Panaya Ltd., Hod Hasharon (IL)

(72) Inventors: Nir Marcu, Hod HaSharon (IL); Alexandra Zhmudyak, Rehovot (IL); Shir Uziely, Raanana (IL)

(73) Assignee: Panaya Ltd., Hod Hasharon (IL)

(21) Appl. No.: 15/665,646

(22) Filed: Aug. 1, 2017

Related U.S. Application Data
(60) Provisional application No. 62/373,479, filed on Aug. 11, 2016.

(51) Int. Cl. G06Q 10/06

(52) U.S. Cl. CPC G06Q 10/0635; G06Q 10/06375; G06Q 10/067; G06Q 10/0633; G06Q 10/06316

(57) ABSTRACT

Described herein are systems, methods, and computer programs that may be utilized to warn about performance of steps that lead to an unsuccessful execution of a Business Process (BP). In one embodiment, a monitoring agent monitors interactions with an instance of a software system belonging to a certain organization and generates a stream comprising steps performed as part of the interaction. A warning module utilizes a model generated based on training data comprising prefixes of sequences corresponding to unsuccessful executions of one or more BPs, and determines whether the stream comprises a certain sequence of steps that corresponds to a prefix of an unsuccessful execution of a BP. Optionally, the training data comprises various sequences corresponding to executions of the BP associated with different organizations. The warning module also issues a warning responsive to determining that the stream comprises the certain sequence.

### CROSS-REFERENCE TO RELATED APPLICATIONS

This Application claims priority to U.S. Provisional Patent Application No. 62/1373,479, filed Aug. 11, 2016 that is herein incorporated by reference in its entirety.

### BACKGROUND

Much of an organization's activity involves executing Business Processes (BPs) on instances of various software systems, such as Enterprise Resource Planning (ERP) systems. Different organizations often execute the same or similar BPs, and often encounter the same types of errors. Without sharing and utilizing of the experience acquired from executing BPs, users at each organization need to go through the same learning process, with the accompanying delays, frustration, and cost. Thus, there is a need for a way to leverage experience of some organizations in order to improve execution of BPs by other organizations.

### SUMMARY

Some aspects of this disclosure involve various systems, methods, and computer programs that enable sharing of the experience crowd-based knowledge) accrued from execution of Business Processes (BPs) by some organizations in order to help executions of BPs by other organizations.

Some aspects of this disclosure involve various applications that utilize data that is obtained by monitoring interactions with instances of one or more software systems. A “software system”, as used in this disclosure, may refer to one or more of various types of prepackaged business applications, such as enterprise resource planning (ERP), supply chain management (SCM), supplier relationship management (SRM), product lifecycle management (PLM), and customer relationship management (CRM), to name a few. Additionally, a “software system” may refer to a computer system with which a user and/or a computer program (e.g., a software agent) may communicate in order to receive and/or provide information, and/or in order to provide and/or receive a service.

In some embodiments, the monitoring is performed by one or more monitoring agents. Each monitoring agent generates a stream comprising steps performed as part of an interaction with an instance of a software system. Optionally, data collected through monitoring may include one or more of the following types of data: data provided by a user (e.g., as input in fields in screens), data provided by a software system (e.g., messages returned as a response to operations), data exchanged between a user interface and a server used to run an instance of a software system (e.g., network traffic between the two), logs generated by an operating system (e.g., on a client used by a user or a server used by an instance of a software system), and logs generated by the instance of the software system (e.g., “event logs” generated by the software system).

One aspect of this disclosure involves utilizing models of BPs in order to identify executions of BPs from data obtained using monitoring. Various types of models of BPs may be utilized in embodiments described in this disclosure. Optionally, the models of the BPs may be utilized to identify successful executions of BPs and/or unsuccessful executions of BPs. In one example, a model of a BP may describe one or more sequences of steps involved in executions of the BP. In another example, a model of a BP may be described via a graphical representation (graph) such as a Petri net or a depiction of a BPMN model. In still another example, a model of a BP may include parameters of an automaton that accepts sequences of steps corresponding to executions of the BP. And in still another example, a model of a BP may include parameters of a machine learning-based model that may be utilized to identify executions of the BP.

In some embodiments, models of BPs are generated based on data describing executions of the BP associated with multiple organizations, and then these models may be used to identify executions of BPs by a different organization. Herein, an execution of a BP is associated with an organization if at least one of the following statements is true: (i) at least some steps involved in the execution of the BP are performed by a user belonging to the organization, and (ii) at least some steps involved in the execution of the BP are executed on a certain instance of a software system belonging to the organization.

By utilizing a model of BP generated based on executions of other organizations, the different organization may be able to utilize certain knowledge of the other organizations (“crowd knowledge”) regarding what steps arc involved in executing the BP. Such a model may be able to capture what is generally considered the essence of executing the BP (as determined based on how multiple other organizations execute the BP). Additionally, by utilizing such a crowd-based model, the different organization does not need to invest the vast resources required to perform such a modeling effort from scratch. Furthermore, when the same type of model is utilized by multiple organizations, it enables easier comparison between performance metrics of different organizations, which can assist in finding bottlenecks and opportunities to optimize how each organization executes BPs.

In some embodiments, models of BPs can correspond to sequences of steps that may lead to unsuccessful executions of one or more BPs. Such models may be utilized to identify situations in which a steps being performed may lead to an unsuccessful execution of a BP, and issue a warning thereof. The following is a description of some aspects of this disclosure that relate to generation of such models and their utilization.

One aspect of this disclosure involves a system that is configured to generate a model of sequences of steps leading to unsuccessful executions of one or more business processes (BPs). In one embodiment, the system includes memory that is configured to store computer executable modules and one or more processors that are configured to execute the computer executable modules. In this embodiment, the computer executable modules include a sequence parser module, a negative example collector, and a model trainer module.

The sequence parser module is configured to receive streams of steps performed during interactions with instances of one or more software systems and to select, from among the streams, sequences of steps. The negative example collector module is configured to select, from among the sequences, a negative set comprising sequences corresponding to unsuccessful executions of BPs; each sequence corresponding to an unsuccessful execution of a BP does not comprise a step indicative of the sequence being a successful execution of any of the BPs.

The model trainer module is configured to generate a model based on prefixes of the sequences belonging to the negative set. Optionally, at least 50% of occurrences of the prefixes in the streams correspond to unsuccessful executions of at least one BP from among the BPs. Optionally, the prefixes of the sequences belonging to the negative set comprise at least one prefix that is a prefix of: (i) a first sequence corresponding to an unsuccessful execution of a first BP, and a second sequence corresponding to an unsuccessful execution of a second BP, which is different from the first BP. Optionally, the first sequence is different from the second sequence. Optionally, each sequence corresponding to an unsuccessful execution of a BP from among the BPs comprises a step indicative of an error in an execution of the BP.

In one embodiment, the streams comprise at least a first stream comprising steps performed on a first instance of a software system, which belongs to a first organization, and a second stream comprising steps performed on a second instance of the software system, which belongs to a second organization that is different from the first organization. Optionally, the sequences corresponding to unsuccessful executions of BPs comprise first and second sequences comprising steps performed while interacting with the first and second instances, respectively.

In one embodiment, the system includes a positive example collector module configured to select, from among steps in the streams, a positive set comprising sequences corresponding to successful executions of BPs; each sequence corresponding to a successful execution of a BP does not comprise a step indicative of the sequence corresponding to an unsuccessful execution of any of the BPs. In this embodiment, the model trainer module is further configured to generate the model based on prefixes of the sequences belonging to the positive set. Optionally, at least 50% of occurrences of the prefixes of the sequences belonging to the positive set in the streams each correspond to a successful execution of at least one BP from among the BPs.

Another aspect of this disclosure involves a method for generating a model of sequences of steps leading to unsuccessful executions of one or more business processes (BPs). In one embodiment, the method includes at least the following steps: receiving streams of steps performed during interactions with instances of one or more software systems; selecting, from among the streams, sequences of steps; selecting, from among the sequences, a negative set comprising sequences corresponding to unsuccessful executions of BPs (where each sequence corresponding to an unsuccessful execution of a BP does not comprise a step indicative of the sequence being a successful execution of any of the BPs); and generating a model based on prefixes of the sequences belonging to the negative set. Optionally, at least 50% of occurrences of the prefixes in the streams correspond to unsuccessful executions of at least one BP from among the BPs.

In one embodiment, the method may optionally include the following steps: selecting, from among steps in the streams, a positive set comprising sequences corresponding to successful executions of BPs (where each sequence corresponding to a successful execution of a BP does not comprise a step indicative of the sequence corresponding to an unsuccessful execution of any of the BPs); and generating the model based on prefixes of the sequences belonging to the positive set. Optionally, at least 50% of occurrences of the prefixes of the sequences belonging to the positive set in the streams each correspond to a successful execution of at least one BP from among the BPs.

Yet another aspect of this disclosure involves a computer program that contains computer instructions, which when executed on a system comprising memory and one or more processors, perform the steps of the method described above for generating a model of sequences of steps leading to unsuccessful executions of one or more BPs.

One aspect of this disclosure includes a system that is configured to warn about performance of steps that lead to an unsuccessful execution of a Business Process (BP). n one embodiment, the system includes memory configured to store computer executable modules and one or more processors configured to execute the computer executable modules. The computer executable modules in this embodiment include a monitoring agent and a warning module.

The monitoring agent is configured to monitor interactions with an instance of a software system belonging to a certain organization and to generate a stream comprising steps performed as part of the interaction.

The warning module is configured to receive a model generated based on training data comprising prefixes of sequences corresponding to unsuccessful executions of one or more BPs, and to utilize the model to make a determination whether the stream comprises a certain sequence of steps that corresponds to a prefix of an unsuccessful execution of a BP; the training data comprises first and second sequences corresponding to executions of the BP associated with first and second organizations, respectively. The warning module is further configured to issue a warning responsive to a determination that the stream comprises the certain sequence.

Another aspect of this disclosure includes a method for warning about performance of steps that lead to an unsuccessful execution of a Business Process (BP). In one embodiment, the method involves performing the following steps: monitoring interactions with an instance of a software system belonging to a certain organization and generating a stream comprising steps performed as part of the interaction; receiving a model generated based on training data comprising prefixes of sequences corresponding to unsuccessful executions of BPs (where the training data comprises first and second sequences corresponding to executions of the BP associated with first and second organizations, respectively); determining, utilizing the model, whether the stream comprises a certain sequence of steps that corresponds to a prefix of an unsuccessful execution of the BP; and responsive to a determination that the stream comprises the certain sequence, issuing a warning.

Yet another aspect of this disclosure involves a computer program that contains computer instructions, which when executed on a system comprising memory and one or more processors, perform the steps of the method described above for warning about performance of steps that lead to an unsuccessful execution of a BP.

### BRIEF DESCRIPTION OF THE DRAWINGS

The embodiments are herein described by way of example only, with reference to the accompanying drawings. No attempt is made to show structural details of the embodiments in more detail than is necessary for a fundamental understanding of the embodiments. In the drawings:

FIG. 1 illustrates an embodiment of a system configured to generate a warning about performance of steps that lead to an unsuccessful execution of a Business Process (BP);

FIG. 2 illustrates steps of one embodiment of a method for warning about performance of steps that lead to an unsuccessful execution of a BP;

FIG. 3 illustrates steps of one embodiment of a method for generating a model of sequences of steps leading to unsuccessful executions of one or more BPs;

FIG. 4 illustrates one embodiment of a system configured to identify a discordance between a sequence of steps and a pattern of a BP;

FIG. 5 illustrates steps of one embodiment of a method for identifying a discordance between a sequence of steps and a pattern of a BP;

FIG. 6 illustrates steps of one embodiment of a method for a step that is missing in an execution of BP;

FIG. 7 illustrates one embodiment of a system configured to suggest a next step to perform after a sequence of steps was performed in an execution of a BP;

FIG. 8 illustrates an embodiment of a system configured to generate a model that is used to suggest a next step to perform after a sequence of steps was performed in an execution of a BP;

FIG. 9 illustrates steps of one embodiment of a method for suggesting a next step to perform after a sequence of steps was performed in an execution of a BP;

FIG. 10 illustrates one embodiment of a system configured to suggest a next step to perform after a sequence of steps was performed;

FIG. 11 illustrates an embodiment of a system configured to generate a model that is used to suggest a next step to perform after a sequence of steps was performed;

FIG. 12 illustrates steps of one embodiment of a method for suggesting a next step to perform after a sequence of steps;

FIG. 13 illustrates one embodiment of a system configured to suggest a frequently performed next step in an execution of a BP;

FIG. 14 illustrates an embodiment of a system configured to generate a table used to suggest a frequently performed next step in an execution of a BP;

FIG. 15 illustrates steps of one embodiment of a method for suggesting a frequently performed next step in an execution of a BP;

FIG. 16 illustrates one embodiment of a system configured to suggest a BP to execute after one or more BPs have been executed;

FIG. 17 illustrates an embodiment of a system configured to generate a model that is used to suggest a BP to execute after one or more BPs have been executed;

FIG. 18 illustrates steps of one embodiment of a method for suggesting a BP to execute after one or more BPs have been executed;

FIG. 19 illustrates one embodiment of a system configured to suggest a value for a certain field in an execution of a BP;

FIG. 20 illustrates an embodiment of a system configured to generate a model of values for a certain field in executions of a BP;

FIG. 21 illustrates steps of one embodiment of a method for suggesting a value for a certain field in an execution of a BP;

FIG. 22 illustrates some of the different monitoring agents that may be utilized in some of the embodiments described in this disclosure;

FIG. 23 illustrates an example of selection of sequences by the sequence parser module;

FIG. 24 illustrates an example of selection of sequences from multiple streams of steps by the sequence parser module;

FIG. 25a is a schematic illustration of selection of consecutively performed sequences of steps;

FIG. 25b is a schematic illustration of selection of a sequence comprising nonconsecutively performed steps from the same stream;

FIG. 25c is a schematic illustration of selection of a sequence comprising nonconsecutively performed steps from different streams;

FIG. 26 illustrates an embodiment of a system configured to identify executions of a Business Process (BP) utilizing a crowd-based model of the BP; and

FIG. 27 is a schematic illustration of a computer that is able to realize one or more of the embodiments discussed herein.

### DETAILED DESCRIPTION

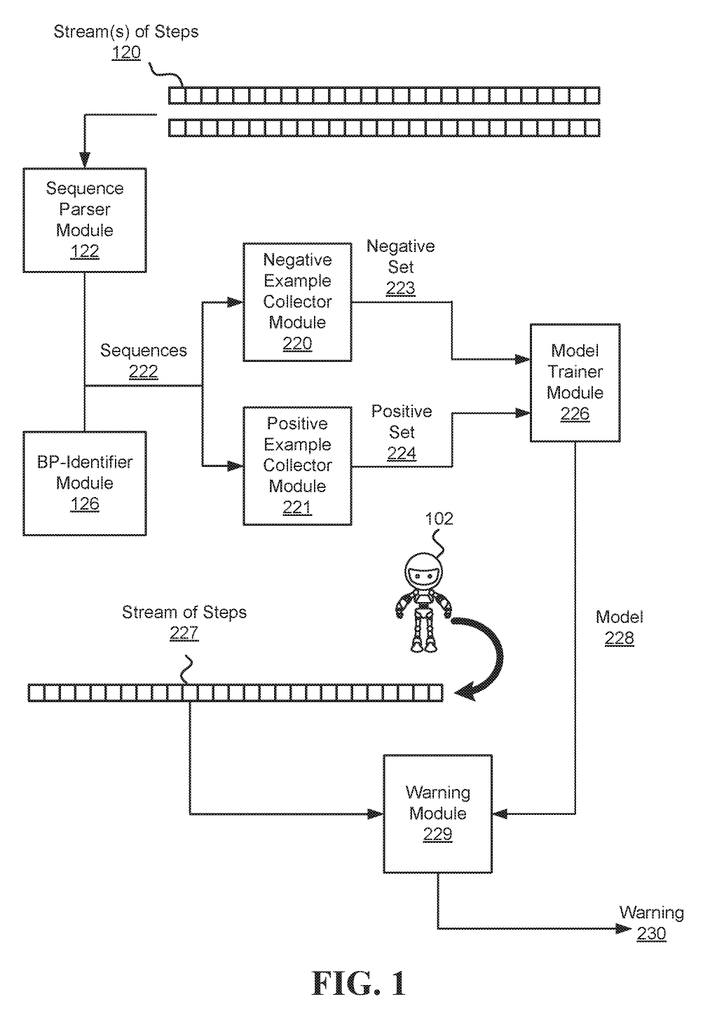

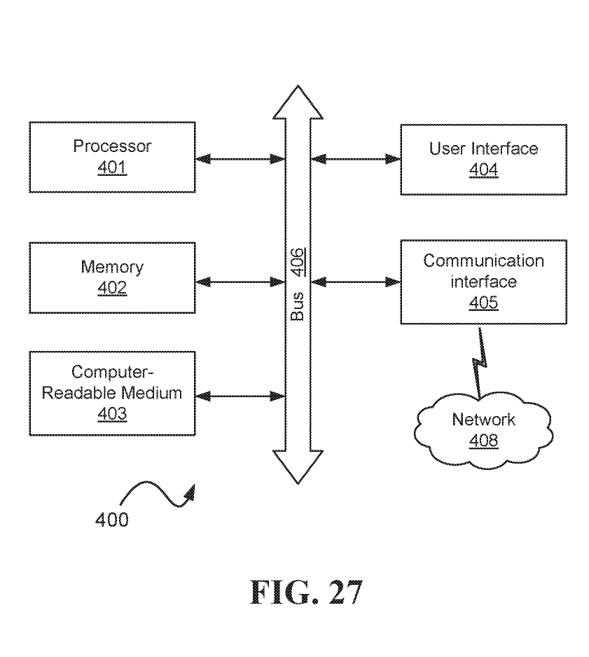

FIG. 1 illustrates one embodiment of a system configured to generate a warning about performance of steps that lead to an unsuccessful execution of a BP. The system includes at least the following modules: a monitoring agent 102 and a warning module 229. The embodiment illustrated in FIG. 1. as other systems described in this disclosure, may be realized utilizing a computer, such as the computer 400 (illustrated in FIG. 27), which includes at least a memory 402 and a processor 401. The memory 402 stores code of computer executable modules, such as the modules described above, and the processor 401 executes the code of the computer executable modules stored in the memory 402.

The monitoring agent 102 is configured, in one embodiment, to monitor interactions with an instance of a software system belonging to a certain organization and to generate a stream 227 comprising steps performed as part of the interaction. A discussion about the various types of software systems that may be interacted with in embodiments described in this disclosure, as well as what it means for a software system to “belong” to an organization, is provided in Section 1—Software Systems and Organizations. Additionally, that section also includes more details regarding what constitutes an “organization”.

A monitoring agent may be categorized, in some embodiments, as being an “internal monitoring agent” and/or an “interface monitoring agent”. Generally put, an internal monitoring agent is a monitoring agent that utilizes functionality of the instance of the software system with which an interaction occurs, while the interface monitoring agent, as it names suggests, relies more on data that is provided and/or received via a user interface. The following are some examples of various monitoring agents that may be utilized, Additional discussion regarding monitoring agents and the data they examine/produce may be found in this disclosure at least in Section 2—Monitoring Activity.

In one example, the monitoring agent 102 comprises a software element installed on a client machine on which runs a user interface (UI) used by a user to execute a BP from among one or more BPs. The software element, in this example, may monitor information exchanged between the client and the instance of the software system, but does not alter the information in a way that affects the execution of the BP. Optionally, disabling the software element does not impede the execution of the BP.

In another example, the monitoring agent 102 is configured to utilize an Application Program Interface (API) of the software system, which causes the instance of the software system to execute a certain procedure that provides the monitoring agent 102 with data indicative of at least some steps that belong to the stream 227.

In still another example, a user executes a packaged application on the instance of the software system, and the monitoring agent 102 is configured to perform at least one of the following operations: (i) initiate an execution, on the instance of the software system, of a function of the packaged application, (ii) retrieve, via a query sent to the instance of the software system, a record from a database, and (iii) access a log file created by the instance of the software system.

In yet another example, the monitoring agent 102 is an interface monitoring agent, which is configured to extract information from data presented on a user interface (UI) used by a user while interacting with the instance of the software system (e.g., while the user executes BPs). Optionally, the monitoring agent 102 may be configured to perform image analysis (e.g., optical character recognition to images on a display), semantic analysis to text presented to the user, and/or speech recognition applied verbal output presented to the user. Additionally or alternatively, the monitoring agent 102 may be configured to analyze input provided by a user via a UI.

In some embodiments, a step belonging to the stream 227 describes one or more of the following aspects of the interaction: a certain transaction that is executed, a certain program that is executed, a certain screen that is displayed during the interaction, a certain form that is accessed during the interaction, a certain field that is accessed during the interaction, a certain value entered in a field belonging to a form, a certain operation performed from within a form, and a certain message returned by the software system during the interaction or following the interaction. Additional information regarding steps and generation of streams of steps may be found in this disclosure at least in Section 3—Streams and Steps.

The warning module 229 is configured, in one embodiment, to receive a model 228, which is generated based on training data comprising prefixes of sequences corresponding to unsuccessful executions of one or more BPs. The warning module 229 is configured to utilize the model 228 to make a determination whether the stream 227 comprises a certain sequence of steps that corresponds to a prefix of an unsuccessful execution of a certain BP. Optionally, the certain sequence does not comprise a step indicative of the unsuccessful execution of the certain BP. Optionally, the warning module 229 evaluates multiple sequences selected from among the steps belonging to the stream 227 by a sequence parser module 122. Selection of sequences by the sequence parser module 122 is discussed in more detail in Section 4—Selecting Sequences from Streams.

In one example, the certain BP is one of the one or more BPs whose unsuccessful executions were used as training data for generating the model 228, In another example, the certain BP is not of the one or more BPs (but may, for example, include similar steps to the steps performed to execute at least some of the one or more BPs). In yet another example, the training data used to generate the model 228 includes at least one or more sequences corresponding to unsuccessful executions of a second BP, which is different from the certain BP.

The warning module 229 is further configured to issue a warning 230 responsive to a determination that the stream 227 comprises the certain sequence of steps that leads to an unsuccessful execution. Optionally, the warning 230 is provided to a user who performed the certain sequence of steps. Optionally, the warning 230 is indicative of one or more steps, among the steps belonging to the certain sequence, which may lead to an unsuccessful execution of the certain BP. Optionally, the warning 230 is indicative of one or more steps that may be performed instead of, or in addition to, at least some of the steps belonging to the certain sequence. Optionally, the warning 230 is issued to a user interface used by a user to execute one or more steps belonging to the certain sequence. For example, the warning 230 may be displayed as text and/or an image on a screen such as a monitor or some other display (e.g., an augmented reality display), which is used by the user.

Herein, an execution of a BP may be considered an “unsuccessful execution” of the BP if performing steps involved in an execution of the BP causes a system (e.g., an instance of a software system with which a user interacts) to return a message that is indicative of an error and/or cause the system to enter into a first certain state (which may be interpreted as not corresponding to a successful execution of the BP). Optionally, the message may be stored in a log and/or reported to a user interface. Additionally or alternatively, an execution of a BP may be considered an “unsuccessful execution” of the BP if performing steps involved in the execution of the BP do not cause the system to enter into a second certain state (e.g., a state indicative of a successful execution) and/or do not cause the system to return a message that is indicative of a successful execution of the BP.

In one embodiment, the warning module 229 is further configured to utilize the model 228 to calculate a value indicative of a probability that the certain sequence is a prefix of a sequence corresponding to an unsuccessful execution of a BP. Optionally, when the probability reaches a threshold, the warning module 229 issues the warning 230. In one example, the value is a indicative of the extent to which the certain sequence may be classified as belonging to a class of sequences corresponding to an unsuccessful execution (e.g., when the model is a logistic regression model or some other model used for classification).

In some embodiments, the model 228 may be considered a crowd-based model. In one example, the training data used to generate the model 228 comprises at least first and second sequences corresponding to executions of the certain BP by first and second organizations, respectively. Optionally, in this example, the first and second organizations are different from the certain organization. In another example, the training data used to generate the model 228 comprises at least a first sequence corresponding to an unsuccessful execution of a first BP associated with a first organization and a second sequence corresponding to an unsuccessful execution of a second BP associated with a second organization. In this example, the first and second organizations are different from the certain organization.

Herein, an execution of a BP is associated with an organization if at least one of the following statements is true: (i) at least some steps involved in the execution of the BP are performed by a user belonging to the organization, and (ii) at least some steps involved in the execution of the BP are performed on a certain instance of a software system belonging to the organization.

In some embodiments, the warning module 229 may evaluate steps belonging to the stream 227 in essentially real time (e.g., within less than a second from when they were executed and/or within a few minutes of when they were executed). In one example, the warning module 229 evaluates steps in the stream 227 after each step is performed. In other embodiments, evaluation of steps in the stream 227 occurs after certain steps are performed (e.g., steps that indicate an end to a certain stages of execution of the BP like switching screens or finishing entry of data of a certain type). In still other embodiments, evaluation of steps in the stream 227 may occur periodically (e.g., every few seconds).

The model 228 may be utilized in various ways in different embodiments. Following are some examples of different types of models that may be utilized in embodiments described herein. A more detailed discussion regarding generation of the model 228 is given further below.

In one embodiment, the model 228 comprises a description of one or more patterns, with each pattern describing one or more sequences of steps (e.g., a pattern may he regular expression). In this embodiment, the one or more patterns comprise a pattern describing a sequence of steps involved in unsuccessful executions of one or more BPs. For example, the pattern may describe a series of steps that typically culminate in the failed execution of a BP. In this embodiment, the warning module 229 may compare a sequence of steps from among the steps belonging to the stream 227 to the one or more patterns. Optionally, if a similarity between the sequence of steps and a pattern from among the one or more patterns reaches a threshold, the warning module 229 issues the warning 230. Optionally, for most sequences of steps belonging the stream 227, there is no pattern, from among the one or more patterns, for which a similarity reaches the threshold.

In another embodiment, the model 228 describes one or more automatons, each configured to recognize a prefix of a sequence corresponding to an unsuccessful execution of one or more BPs. In this embodiment, the warning module 229 may simulate a running of the one or more automatons on an input comprising the stream 227. Optionally, responsive to at least one of the one or more automatons reaching an accepting state, which is indicative of the presence of a sequence corresponding to an unsuccessful execution of a BP, the warning module 229 issues the warning 230.

In yet another embodiment, the model 228 comprises parameters used by a machine learning-based predictor configured to receive feature values determined based on a sequence of steps and to calculate a value indicative of a probability that the sequence of steps represents a prefix of a sequence corresponding to an unsuccessful execution of a BP. Optionally, if the probability reaches a threshold, the warning module 229 issues the warning 230. Optionally, for most of the sequences of steps in the stream 227, the probability computed based on the model 228 is below the threshold,

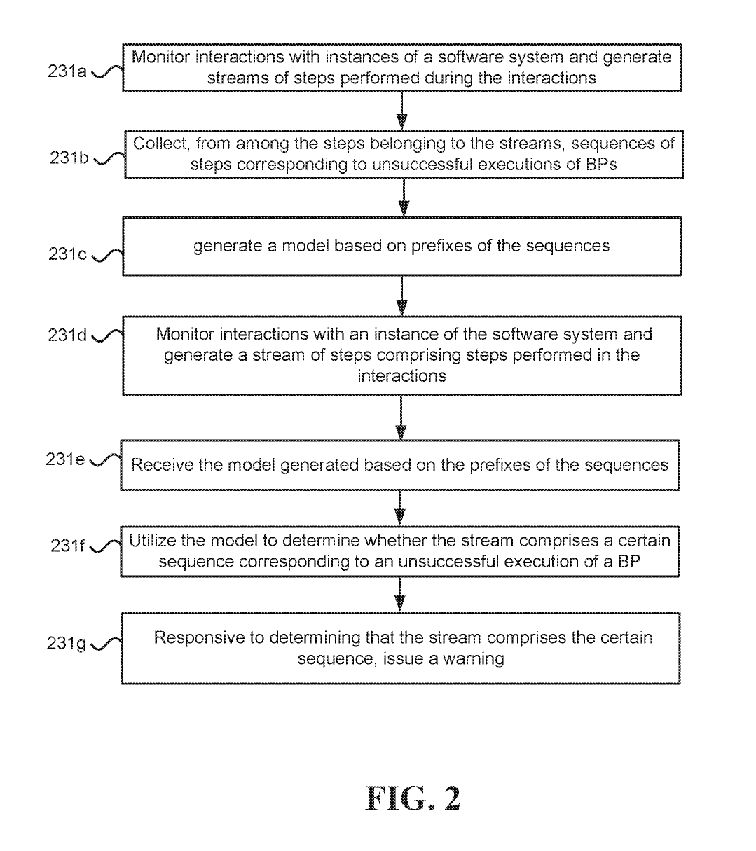

FIG. 2 illustrates steps that may be performed in one embodiment of a method for warning about performance of steps that lead to an unsuccessful execution of a BP. The steps described below may be, in some embodiments, part of the steps performed by an embodiment of a system described above, which is illustrated in FIG. 1. In some embodiments, instructions for implementing the method described below may be stored on a computer-readable medium, which may optionally be a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for warning about performance of steps that lead to an unsuccessful execution of a BP includes at least the following steps:

In Step 231d, monitoring interactions with an instance of a software system belonging to a certain organization and generating a stream comprising steps performed as part of the interaction.

In Step 231c, receiving, by a system comprising a processor and memory, a model generated based on training data comprising prefixes of sequences corresponding to unsuccessful executions of one or more BPs. Optionally, the training data comprises first and second sequences corresponding to executions of the BP associated with first and second organizations, respectively. Optionally, the first and second organizations are different form the certain organization.

In Step 231f, determining, utilizing the model received in Step 231e, whether the stream comprises a certain sequence of steps that corresponds to a prefix of an unsuccessful execution of a BP.

And in Step 231g, responsive to making a determination in Step 231f that the stream comprises the certain sequence, issuing a warning. Optionally, the warning is indicative of the fact that the stream includes the certain sequence of steps that corresponds to a prefix of an unsuccessful execution of a BP. Optionally, the warning is indicative of which sequence of steps corresponds to the unsuccessful execution of a BP.

In one embodiment, Step 231f involves utilizing the model to determine a value indicative of a probability that the certain sequence is a prefix of a sequence corresponding to an unsuccessful execution of a BP and Step 231g involves issuing the warning when the probability reaches a threshold.

In one embodiment, the method may optionally include Step 231c, which involves generating the model based on the training data. Optionally, the training data comprises at least a third sequence corresponding to an unsuccessful execution of a second BP, which is associated with the first organization. There are various ways in which the model may be generated in Step 231c.

In one example, generating the model in Step 231c comprises determining one or more patterns based on the sequences belonging to the training data. Optionally, the one or more patterns comprise a pattern describing a sequence of steps involved in unsuccessful execution of one or more BPs. Optionally, the model in this example comprises a description of the one or more patterns.

In another example, generating the model in Step 231c comprises generating one or more automatons, each configured to recognize a prefix of a sequence corresponding to an unsuccessful execution of one or more of the BPs. Optionally, the model in this example comprises a description of the one or more automatons.

In yet another example, generating the model in Step 231c comprises calculating parameters used by a machine learning-based predictor configured to receive feature values determined based on a sequence of steps and to calculate a value indicative of a probability that the sequence of steps represents a prefix of a sequence corresponding to an unsuccessful execution of a BP from among one or more BPs. Optionally, the model in this example comprises a description of the parameters.

In one embodiment, the method may optionally include Step 231a, which involves monitoring interactions with instances of a software system and generating streams of steps based on data collected from the monitoring. Optionally, the streams include steps performed during interactions of users belonging to the first and/or second organizations mentioned above. Additionally or alternatively, the method may optionally include Step 231b which involves collecting, from among the steps belonging to the streams, sequences of steps corresponding to unsuccessful executions of BPs. Optionally, each sequence corresponding to an unsuccessful execution of a BP does not comprise a step indicative of the sequence being a successful execution of any of the BPs. Optionally, collecting the sequences is done utilizing the sequence parser module 122 (which selects sequences from streams), the BP-Identifier module 126 (which may be utilized to identify to which BPs the sequences correspond), and/or a negative examples collector 220.

The following is a description of an embodiment of a system that is configured to generate a model of sequences of steps leading to unsuccessful executions of one or more BPs, such as the model 228 described above. In one embodiment, the system includes at least the following computer executable modules: the sequence parser module 122, a negative example collector module 220, and a model trainer module 226. The system may optionally include additional modules, such as a positive example collector module 221.

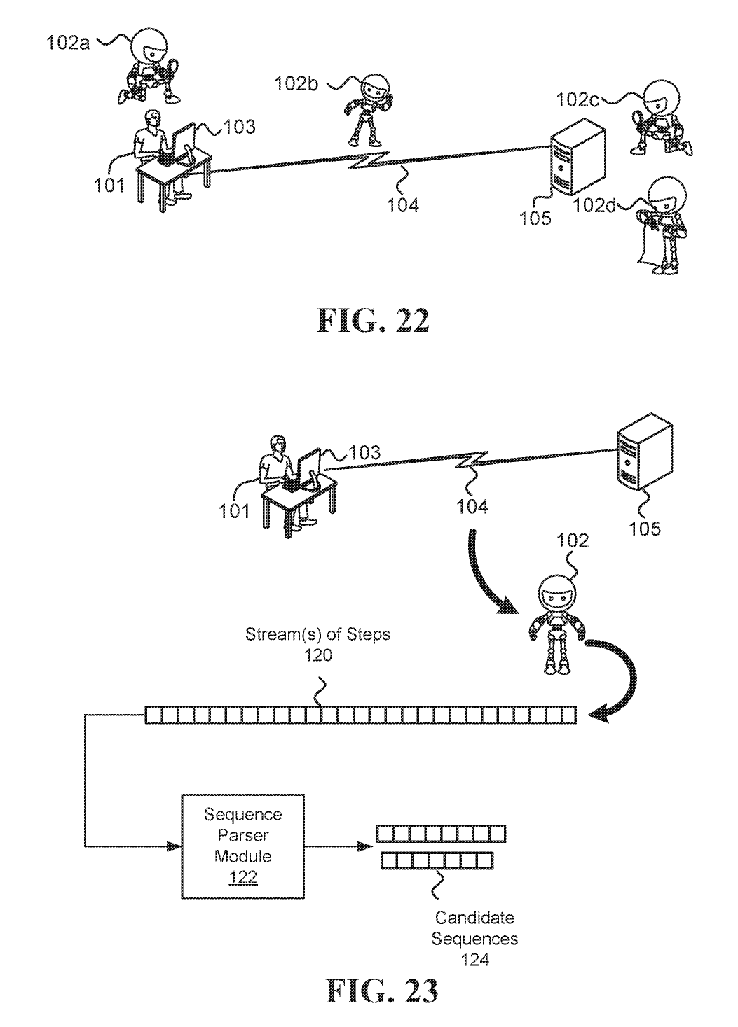

The sequence parser module 122 is configured, in one embodiment, to receive one or more streams 120 of steps performed during interactions with instances of one or more software systems and to select, from among the streams, sequences of steps. Optionally, the streams 120 are generated by a plurality of monitoring agents (e.g., from among the monitoring agents 102a to 102d illustrated in FIG. 22). Optionally, each monitoring agent generates a stream comprising steps performed as part of an interaction with an instance of a software system from among the one or more software systems. Additional information regarding the monitoring agents and the generation of the streams 120 may be found in this disclosure at least in the sections 2—Monitoring Activity and 3—Streams and Steps.

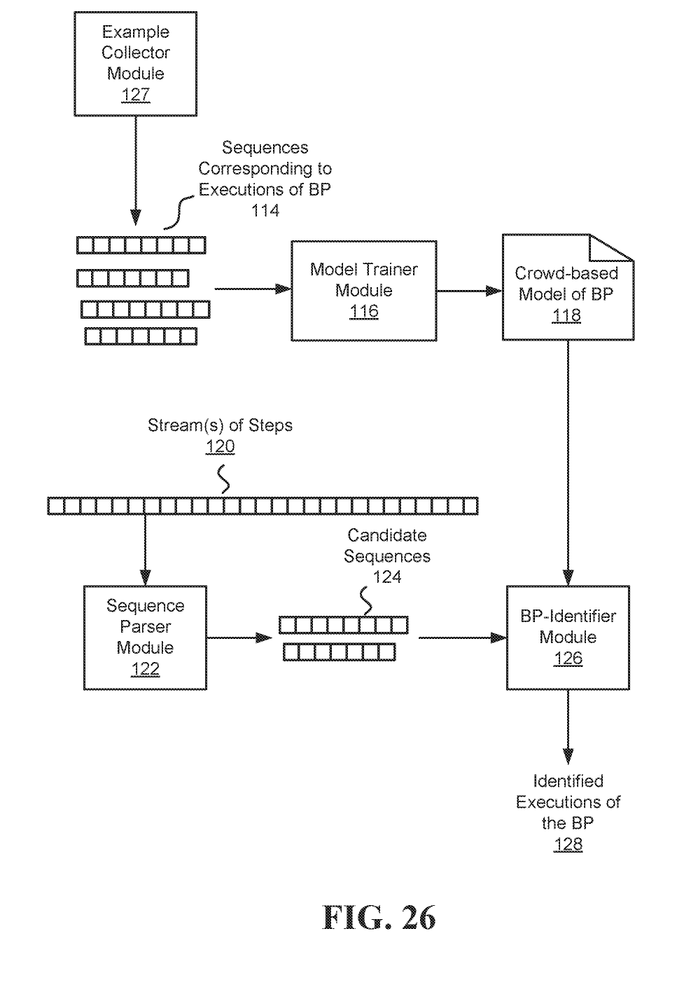

In one embodiment, the sequence parser module 122 is configured to receive the one or more streams 120 of steps and to select, from among the streams 120, sequences 222 of steps. Optionally, the one or more streams 120 of steps may comprise at least two streams of steps, which include a certain first stream of steps performed during interactions with an instance of a first software system and a certain second stream of steps performed during interactions with an instance of a second software system, which is different from the first software system. Optionally, the sequences 222 are forwarded to BP-Identifier module 126 (illustrated in FIG. 26) for the purpose of identifying BPs to which the sequences 222 correspond.

It is to be noted that depending on how they were selected, the sequences 222 may include some sequences that include only consecutively performed steps and/or or some sequences that include some nonconsecutively performed steps. Additional discussion regarding selecting sequences by the sequence parser module 122 is given in this disclosure at least in Section 4—Selecting Sequences from Streams.

The negative example collector module 220 is configured, in one embodiment, to select, from among the sequences 222, a negative set 223 comprising sequences corresponding to unsuccessful executions of BPs. Optionally, each sequence corresponding to an unsuccessful execution of a BP does not comprise a step indicative of the sequence being a successful execution of any of the BPs. Optionally, at least some of the sequences in the negative set 223 comprise a step indicating that the sequence corresponds to an unsuccessful execution of a BP (e.g., an error message returned by a system).

Some of the prefixes of sequences in the negative set may correspond to multiple BPs. For example, in one embodiment, the prefixes of the sequences belonging to the negative set 223 comprise at least one prefix that is a prefix of: (i) a first sequence corresponding to an unsuccessful execution of a first BP, and (ii) a second sequence corresponding to an unsuccessful execution of a second BP, which is different from the first BP. In this example, the first sequence is different from the second sequence.

The model trainer module 226 is configured to generate the model 228 based on prefixes of the sequences belonging to the negative set. Optionally, occurrences of the prefixes of the sequences in streams of steps typically correspond to unsuccessful executions of BPs. For example, at least 50% of occurrences of the prefixes in the streams 120 correspond to unsuccessful executions of at least one BP In another example, at least 80% of occurrences of the prefixes in the streams 120 correspond to unsuccessful executions of at least one BP. In some cases, the prefixes may be proper prefixes of the sequences in the negative set 223; a proper prefix of a sequence is a prefix that does not include the entire sequence. In some cases, at least some of the prefixes may be complete sequences from among the sequences 222.

The model 228 may be considered, in sonic embodiments, to be a crowd-based model. For example, the streams 120 may include at least a first stream comprising steps performed on a first instance of a software system, which belongs to a first organization, and a second stream comprising steps performed on a second instance of the software system, which belongs to a second organization that is different from the first organization. Optionally, the sequences corresponding to unsuccessful executions of BPs in the negative set 223 comprise first and second sequences comprising steps performed while interacting with the first and second instances, respectively. Optionally, the first and second organizations are different from the certain organization to which the stream 227 corresponds.

In some embodiments, the model 228 may be considered similar to a model of a BP, as described elsewhere in this disclosure, with the exception that a model of a BP typically corresponds to a sequence of steps involved in a successful execution of a BP, while the model 228 typically corresponds to a sequence of steps involved in an unsuccessful execution of a BP. However, given their other similarities, various approaches described in this disclosure for generating models of BPs, e.g., as discussed in Section 5—Models of BPs, may be applied to generate the model 228. Following are some of examples of embodiments in which the model 228 is implemented in different ways.

In one embodiment, the model 228 comprises a description of one or more patterns, of which at least one pattern describes a sequence of steps involved in unsuccessful executions of a BP (or steps involved in unsuccessful executions of multiple BPs). In one example, the one or more patterns each recite a sequence of steps. In another example, the one or more patterns comprise a pattern represented by a regular expression. Optionally, the one or more patterns may include a pattern that corresponds to a sequence of steps that represents a complete unsuccessful execution of a BP. Additionally or alternatively, the one or more patterns may include a pattern that corresponds to a proper prefix of a sequence of steps that represents a partial (unsuccessful) execution of a BP. For example, the pattern may not include a step that is directly indicative of an error in the execution (e.g., a step of receiving an error message).

In some embodiments, a system illustrated in FIG. I may include the positive example collector module 221, which is configured to select a positive set 224 comprising sequences corresponding to successful executions of one or more BPs. Optionally, the positive set 224 includes examples of sequences corresponding to successful executions of BPs belonging to a set of one or more BPs, and the negative set 223 includes examples of sequences corresponding to unsuccessful executions of BPs belonging to the same set of one or more BPs. Optionally, each sequence corresponding to a successful execution of a BP does not comprise a step indicative of the sequence corresponding to an unsuccessful execution of any of the BPs. Additionally or alternatively, at least some of the sequences in the positive set 224 include a step indicating a successful execution of a BP (e.g., a step involving receiving a message indicative of a successful execution). Optionally, the model trainer module 226 is further configured to generate the model 228 based on prefixes of the sequences belonging to the positive set 224 (in addition to the prefixes of the sequences belonging to the negative set 223). Optionally, occurrences of the prefixes of the sequences in the positive set 224 often correspond to successful executions of BPs. For example, at least 50% of occurrences of the prefixes in the streams 120 correspond to successful executions of at least one BP. In another example, at least 80% of occurrences of the prefixes in the streams 120 correspond to successful executions of at least one BP.

In one embodiment, there is limited overlap between sequences in the positive set 224 and the negative set 223. For example, less than 33% of the sequences of steps in the positive set 224 also belong to the negative set 223 and less than 33% of the sequences of steps in the negative set 223 belong to the positive set 224. In another example, the positive set 224 and the negative set 223 do not have sequences of steps in common.

By utilizing the positive set 224 in addition to the negative set 223, the model trainer module 226 may generate additional types of models. In one embodiment, the model 228 may describe one or more automatons, each configured to recognize a prefix of a sequence corresponding to an unsuccessful execution of one or more BPs. In another embodiment, the model 228 may include parameters used by a machine learning-based predictor configured to receive feature values determined based on a sequence of steps (or prefix of a sequence) and to calculate a value indicative of a probability that the sequence of steps represents a prefix of a sequence corresponding to an unsuccessful execution of a BP. For example, the machine learning-based predictor may utilize one or more of the following machine learning algorithms: decision trees, random forests, support vector machines, neural networks, logistic regression, and a naïve Bayes classifier.

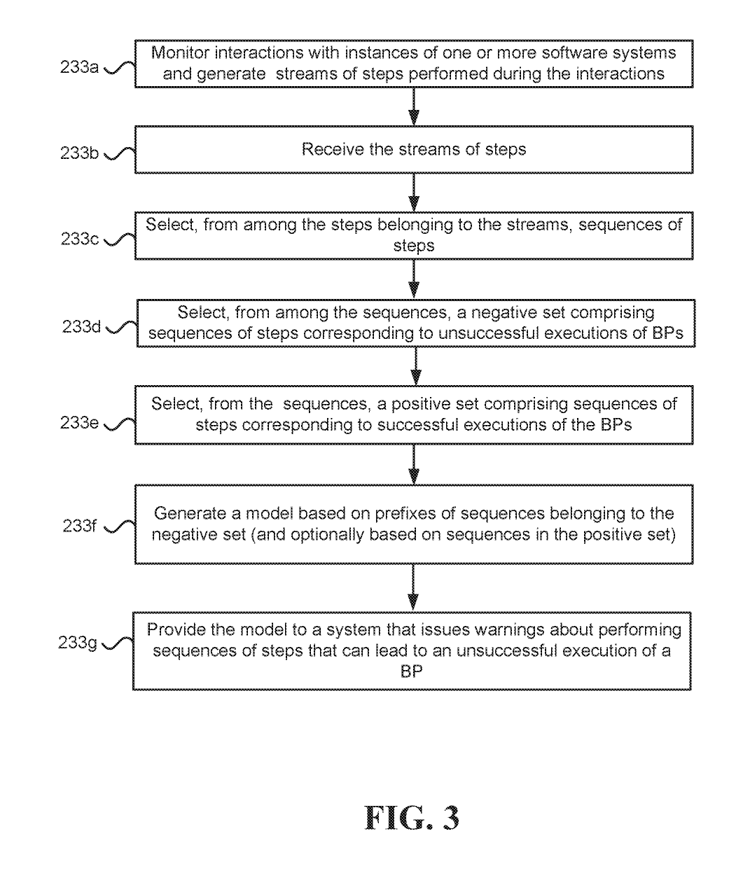

FIG. 3 illustrates steps that may be performed in one embodiment of a method for generating a model of sequences of steps leading to unsuccessful executions of one or more BPs. The steps described below may be, in some embodiments, part of the steps performed by an embodiment of a system described above, which is illustrated in FIG. 1. In some embodiments, instructions for implementing the method described below may be stored on a computer-readable medium, which may optionally be a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for generating a model of sequences of steps leading to unsuccessful executions of one or more BPs includes at least the following steps:

In Step 233b, receiving streams of steps performed during interactions with instances of one or more software systems. Optionally, the streams includes steps performed while interacting with instances of one or more software systems belonging to multiple organizations. In one example, the streams comprise at least a first stream comprising steps performed on a first instance of a software system, which belongs to a first organization, and a second stream comprising steps performed on a second instance of the software system, which belongs to a second organization that is different from the first organization.

In Step 233c, selecting, from among the streams, sequences of steps. Optionally, selecting the sequences is done utilizing the sequence parser module 122. Optionally, selecting the sequences involves identifying to which BP they correspond, and this is done utilizing the BP-Identifier module 126.

In Step 233d, selecting, from among the sequences obtained in Step 233c, a negative set comprising sequences corresponding to unsuccessful executions of BPs. Optionally, a sequence corresponding to an unsuccessful execution of a BP does not comprise a step indicative of the sequence being a successful execution of any of the BPs. Optionally, selecting sequences in this step involves identifying in a sequence a step indicative of an error in an execution of the BP (e.g., a step involving receiving an error message). Optionally, the sequences corresponding to unsuccessful executions of BPs comprise first and second sequences comprising steps performed while interacting with the first and second instances, respectively, and the first and second instances belong to the first and second organizations, respectively.

In optional Step 233e, selecting, from among the sequences obtained in Step 233c, a positive set comprising sequences corresponding to successful executions of BPs. Optionally, a sequence corresponding to a successful execution of a BP does not comprise a step indicative of the sequence being an unsuccessful execution of a BP. Optionally, selecting sequences in this step involves identifying in a sequence a step indicative of a successful execution of a BP(e.g., a step involving receiving a success message from a software system). Optionally, the sequences corresponding to successful executions of BPs comprise first and second sequences comprising steps performed while interacting with the first and second instances, respectively, and the first and second instances belong to the first and second organizations, respectively.

And in Step 233f, generating a model based on prefixes of the sequences belonging to the negative set selected in Step 233d. Optionally, if the method includes Step 233e, the model is generated based on the positive set too. Optionally, at least 50% of occurrences of the prefixes of the sequences in the negative set that appear in the streams correspond to unsuccessful executions of at least one BP from among the one or more BPs. Optionally, if the positive set is utilized, at least 50% of occurrences of the prefixes of the sequences belonging to the positive set in the streams each correspond to a successful execution of at least one BP. Optionally, at least some of the prefixes are proper prefixes of sequences selected in Step 233c (i.e., the prefixes used to train the model do not include some of the later steps in the sequences). Additionally or alternatively, at least some of the prefixes are the same as sequences selected in Step 233c (i.e., they include all of the steps in the sequences).

In one embodiment, the method optionally includes Step 233a that involves monitoring interactions with the instances of one or more software systems and generating the streams based on data collected from the monitoring. Optionally, the monitoring is performed utilizing monitoring agents such as monitoring agents from among the monitoring agents 102a to 102d illustrated in FIG. 22.

In one example, generating the model in Step 233f comprises determining one or more patterns based on the sequences belonging to training data comprising the negative set. Optionally, the one or more patterns comprise a pattern describing a sequence of steps involved in unsuccessful execution of one or more BPs. Optionally, the model in this example comprises a description of the one or more patterns.

In another example, generating the model in Step 233f comprises generating one or more automatons, each configured to recognize a prefix of a sequence corresponding to an unsuccessful execution of one or more BPs. Optionally, the model in this example comprises a description of the one or more automatons.

In yet another example, generating the model in Step 233f comprises calculating parameters used by a machine learning-based predictor configured to receive feature values determined based on a sequence of steps and to calculate a value indicative of a probability that the sequence of steps represents a prefix of a sequence corresponding to an unsuccessful execution of a BP. Optionally, the model in this example comprises a description of the parameters.

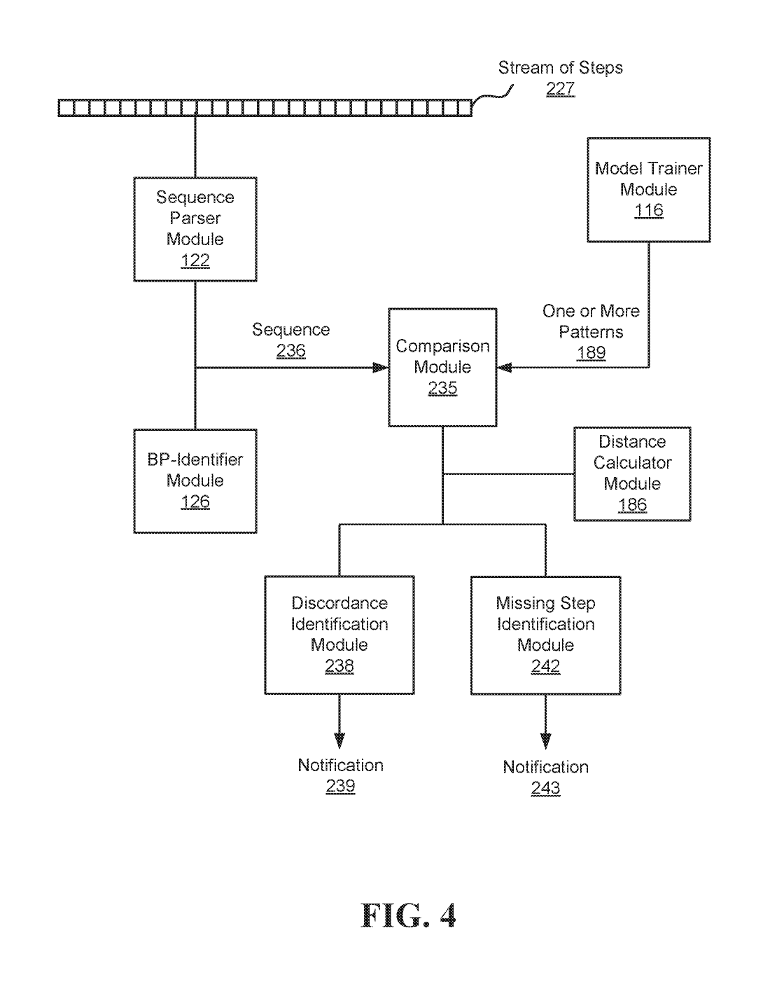

FIG. 4 illustrates one embodiment of a system configured to identify a discordance between a sequence of steps and a pattern of a BP. Optionally, the discordance involves a step in the sequence that is unaligned with the pattern or dissimilar to a step in the pattern with which it is aligned. Optionally, the discordance involves a step in the pattern that is missing in the sequence. The system includes a comparison module 235 and at least one of the following modules: a discordance identification module 238, and a missing step identification module 242. The system may optionally include additional modules such as the sequence parser module 122, a model trainer module 116, or a monitoring agent, such as the monitoring agent 102 (which is illustrated in FIG. 23).

The monitoring agent 102 is configured, in one embodiment, to monitor interactions with an instance of a software system belonging to a certain organization and to generate the stream 227 comprising steps performed as part of the interaction. A discussion about the various types of software systems that may be interacted with in embodiments described in this disclosure, as well as what it means for a software system to “belong” to an organization, is provided in Section 1—Software Systems and Organizations. Additionally, that section also includes more details regarding what constitutes an “organization”.

A monitoring agent may be categorized, in some embodiments, as being an “internal monitoring agent” and/or an “interface monitoring agent”. Generally put, an internal monitoring agent is a monitoring agent that utilizes functionality of the software system with which an interaction occurs, while the interface monitoring agent, as it names suggests, relies more on data that is provided and/or received via a user interface. The following are some examples of various monitoring agents that may be utilized. Additional discussion regarding monitoring agents and the data they examine/produce may be found in this disclosure at least in Section 2—Monitoring Activity.

In some embodiments, a step belonging to the stream 227 describes one or more of the following aspects of the interaction: a certain transaction that is executed, a certain program that is executed, a certain screen that is displayed during the interaction, a certain form that is accessed during the interaction, a certain field that is accessed during the interaction, a certain value entered in a field belonging to a form, a certain operation performed from within a form, and a certain message returned by the software system during the interaction or following the interaction. Additional information regarding steps and generation of streams of steps may be found in this disclosure at least in Section 3—Streams and Steps.

The comparison module 235 is configured, in one embodiment, to receive: one or more patterns 189 corresponding to one or more BPs, and a sequence 236 of steps, which is involved in an unsuccessful execution of a BP from among the one or more BPs. Each of the one or more patterns describes a sequence of steps involved in a (successful) execution of a BP from among the one or more BPs. Optionally, the one or more patterns 189 are generated by the model trainer module 116. The comparison module 235 is further configured to identify a certain pattern, from among the one or more patterns 189, for which a distance between the certain pattern and the sequence 236 is smaller than a threshold. Optionally, the one or more patterns 189 comprise a plurality of patterns and for most of the plurality of patterns, a distance from the sequence 236 is not smaller than the threshold (i.e., most of the plurality of patterns may be considered less similar to the sequence 236 compared to the similarity of the certain pattern to the sequence 236).

In one embodiment, the sequence 236 is selected from among the steps belonging to the stream 227. Optionally, the sequence 236 is selected from the stream 227 utilizing the sequence parser module 122. Optionally, the sequence includes a step identifying the BP to which it corresponds. Additionally or alternatively, BP-Identifier module 126 may be utilized to identify the BP to which the sequence corresponds. Herein, a sequence is considered to “correspond” to a BP if it includes steps involved in the execution of the BP. Optionally, if a sequence corresponds to an execution of a BP it includes a set of steps that when performed (e.g., in the order in which they appear in the sequence) are sufficient to complete an execution of the BP. Optionally, if performing the set of steps causes the instance of the software system to return an error message and/or cause the instance to enter an error state, the sequence may be considered to correspond to an unsuccessful execution of the BP. Additional details regarding the selection of sequences and/or the identification of BPs to which sequences correspond may be found in this disclosure at least in Section 4—Selecting Sequences from Streams and Section 5—Models of BPs.

The certain pattern and the sequence 236 may be analyzed to find a possible reason the execution to which the sequence 236 corresponds is an unsuccessful execution of a BP. Optionally, the possible reason for the execution being unsuccessful corresponds to a difference between the sequence 236 and the certain pattern, which describes steps involved in a successful execution of the BP.

In one embodiment, the discordance identification module 238 is configured to align the steps in the sequence 236 with the steps in the certain pattern, to identify a discordant step in the sequence 236, and to forward a notification 239 indicative of the discordant step. Optionally, the notification 239 is forwarded to a user interacting with the instance of the software system belonging to the certain organization (e.g., in order for the user to take action to correct the effects of the discordant step). Optionally, the certain pattern does not comprise a step that is identical to the discordant step.

In another embodiment, the missing step identification module 242 is configured to align the steps in the sequence 236 with the steps in the certain pattern, to identify a certain step in the certain pattern that is not aligned to any of the steps in the sequence 236, and to forward a notification 243 indicative of the missing step. Optionally, the notification 243 is forwarded to a user interacting with the instance of the software system belonging to the certain organization (e.g., in order for the user to perform the missing step). Optionally, the sequence 236 does not comprise a step that is identical to the certain step.

The notification 243 and/or the notification 239 may be forwarded to a user interface used by a user to execute one or more steps belonging to the certain sequence. For example, the warning 230 may be displayed as text and/or an image on a screen such as a monitor or some other display (e.g., an augmented reality display), which is used by the user.

In some embodiments, the comparison module 235, the discordance identification module 238, and/or the missing step identification module 242 may utilize a distance calculator module 186. In one example, the distance calculator module 186 is utilized to calculate distances between the sequence 236 and the one or more patterns 189. In another example, the distance calculator module 186 is utilized to generate an alignment between the sequence 236 and the certain pattern. Optionally, each pattern, from among the patterns 189, describes a certain sequence of steps involved in an execution of a BP (in this case, the pattern may be considered a “pattern of the BP”). For example, the certain sequence may specify a sequence of transactions and/or operations that may be performed in order to execute the BP. Optionally, a pattern of a BP may be described using a regular expression, and the certain sequence described by the pattern is a sequence that corresponds to the regular expression (i.e., the certain sequence is one of the “words” in the regular grammar that corresponds to the regular expression). Optionally, the one or more patterns 189 include at least first and second different patterns that describe different sequences corresponding to executions of first and second BPs, respectively.

The distance calculator module 186 is configured, in some embodiments, to calculate a distance between the sequence 236 and a pattern (from among the patterns 189) based on an alignment of the sequence 236 and the certain sequence described by the pattern.

Herein, an alignment of first and second sequences is a mapping of corresponding steps between the first and second sequences. Thus, the alignment is indicative for each step in the first sequence, which step in the second sequence (if any) corresponds to it, and vice versa, in some embodiments, an alignment is order preserving, i.e., if a sequence includes first and second steps, such that the first step precedes the second step, then typically, in the alignment, the step corresponding to the first step (in the second sequence) precedes the step corresponding to the second step (in the second sequence).

Various alignment functions may be utilized to generate an alignment between sequences of steps. In one example, a pairwise trace alignment may be used, such as described in Bose, et al, “Trace alignment in process mining: opportunities for process diagnostics”, International Conference on Business Process Management, Springer Berlin Heidelberg, 2010. In another example, a variant of one of the many sequence alignment algorithms developed for aligning biological sequences may be used for this task (e.g., a sequence alignment algorithm that utilized dynamic programming to find an optimal alignment according to a chosen distance function).

Different types of discordant steps may be identified using an alignment between the certain pattern, from among the one or more patterns 189, and the sequence 236. In one example, the discordant step is a step that appears in the sequence 236, but has no counterpart in the certain pattern (i.e., the discordant step is not aligned with any of the steps in the certain pattern). In another example, the discordant step is a step that appears, with some variations, both in the certain pattern and the sequence 236. That is, the discordant step may be considered to be aligned to a certain step in the certain pattern, but at least one of the following is true: the discordant step involves performance of a certain operation that the certain step does not involve, or the certain step involves performance of a certain operation that the discordant step does not involve. In yet another example, the discordant step is a step that appears, with some variations, both in the certain pattern and the sequence 236. However, in this example, the discordant step involves utilizing a certain value for a certain field that does not correspond to a value utilized for the certain field in the certain step.

When an alignment between the certain pattern and the sequence 236 is indicative of a certain step that is missing from the sequence 236, this may mean that the sequence 236 is lacking a certain element that is typically performed in successful executions of the BP. In one example, the certain step involves execution of a certain transaction that is not executed in any of the steps in the sequence 236. Optionally, the notification 243 is indicative of the certain transaction. In another example, the certain step involves performing a certain operation that is not performed in any of the steps in the sequence 236. Optionally, the notification 243 is indicative of the certain operation. And in yet another example, the certain step involves utilizing a certain value for a certain field a certain value is not entered to the certain field any of the steps in the sequence 236. Optionally, the notification 243 is indicative of the certain value and/or the certain field.

In one embodiment, the certain step missing from the sequence 236 involves utilizing a value of a certain Execution-Dependent Attribute (EDA). Optionally, the notification 243 is indicative of the value of the certain EDA, which is obtained from at least one of the steps belonging to the sequence 236. For example, the missing step may involve performing an operation that involves inputting the certain EDA to a certain field, and the notification 243 is indicative of the certain filed and/or the value of the certain EDA. Optionally, the certain EDA corresponds to one or more of the following types of values: a mailing address, a Universal Resource Locator (URL) address, an Internet Protocol (R) address, a phone number, an email address, a social security number, a driving license number, an address on a certain blockchain, an identifier of a digital wallet, an identifier of a client, an identifier of an employee, an identifier of a patient, an identifier of an account, and an order number.

When an alignment between the certain pattern and the sequence 236 is indicative of a certain discordance between the sequence 236 and the certain pattern, this may mean various things. In one example, the sequence 236 includes a discordant step that is not aligned with any of the steps in the certain pattern. Optionally, the notification 239 is indicative of the discordant step. In another example, the sequence 236 includes a discordant step that is aligned to a certain step in the certain pattern, and at least one of the following is true: the discordant step involves performance of a first certain operation that the certain step does not involve, or the certain step involves performance of a second certain operation that the discordant step does not involve. Optionally, the notification 239 is indicative of the first certain operation or the second certain operation. In yet another example, the sequence 236 includes a discordant step that is aligned to a certain step in the certain pattern, and the discordant step involves utilizing a certain value for a certain field that does not correspond to a value utilized for the certain field in the certain step. Optionally, the notification 239 is indicative of the certain value.

In some embodiments, one or more of the patterns 189 may come from crowd-based models of BPs, such as crowd-based model 118 (illustrated in FIG. 26) or some other crowd-based model of a BP designated in this disclosure using some other reference numeral. Optionally, at least some of the patterns 189 are generated based on sequences selected by an example collector module 127. Optionally, at least some of the patterns 189 are generated by the model trainer module 116. In one example, a certain sequence describing a pattern of a BP from among the patterns 189 is generated based on previously identified sequences of steps corresponding to executions of the BP. which comprise at least first and second sequences that correspond to executions of the BP associated with first and second organizations, respectively. Optionally, the first and second organizations in this example are different from the certain organization whose activity is described in the stream 227. Additional discussion regarding generation of crowd-based models, which include the one or more patterns 189, is given in Section 5—Models of BPs.

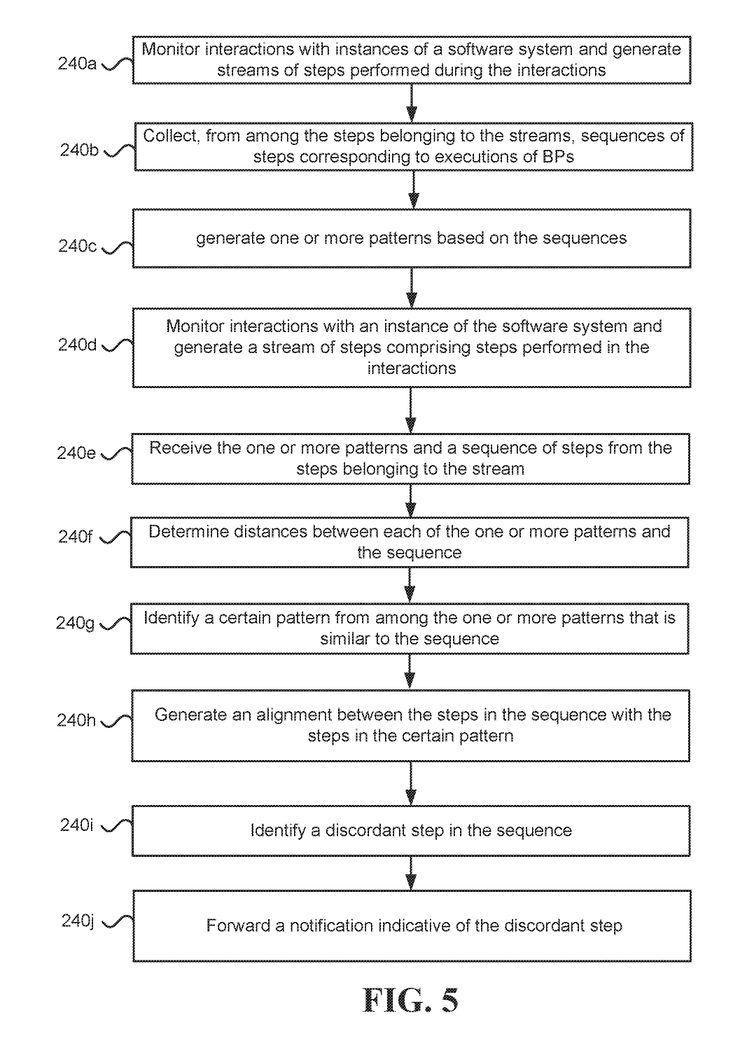

FIG. 5 illustrates steps that may be performed in one embodiment of a method for identifying a discordance between a sequence of steps and a pattern of a BP. The steps described below may be, in some embodiments, part of the steps performed by an embodiment of a system described above, which is illustrated in FIG. 4. In some embodiments, instructions for implementing the method described below may be stored on a computer-readable medium, which may optionally be a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for identifying a discordance between a sequence of steps and a pattern of a BP includes at least the following steps:

In Step 240e, receiving one or more patterns corresponding to one or more BPs and a sequence of steps involved in an unsuccessful execution of a BP. Optionally, each of the one or more patterns describes a sequence of steps involved in an execution of a BP from among the one or more BPs.

In Step 240f, determining distances between each of the one or more patterns and the sequence. Optionally, the distance is determined utilizing the distance calculator module 186.

In Step 240g, identifying, based on the distances, a certain pattern from among the one or more patterns that is similar to the sequence. Optionally, the sequence is deemed similar to the certain pattern by virtue of a distance between the certain pattern and the sequence being smaller than a threshold. Optionally, the certain pattern is generated based on training data comprising first and second sequences corresponding to executions of the BP that are associated with first and second different organizations. respectively. Optionally, the sequence comprises steps executed interacting with an instance of a software system belonging to a certain organization, which is different from the first and second organizations.

In Step 240h, generating an alignment between the steps in the sequence with the steps in the certain pattern. Optionally, the alignment is generated utilizing the discordance identification module 238.

In Step 240i, identifying, based on the alignment, a discordant step in the sequence. The certain pattern does not comprise a step that is identical to the discordant step.

And in Step 240j, forwarding a notification indicative of the discordant step. Optionally, the notification is forwarded to a user who performed the sequence of steps received in Step 240e.

There are various scenarios in which the discordant step in Step 240i may be identified. In one example, Step 240i involves determining, based on the alignment, that the discordant step is not aligned with any of the steps in the certain pattern. In another example, Step 240i involves determining, based on the alignment, that the discordant step is aligned to a certain step in the certain pattern, and at least one of the following is true: the discordant step involves performance of a certain operation that the certain step does not involve, or the certain step involves performance of a certain operation that the discordant step does not involve. And in yet another example, Step 240i involves determining, based on the alignment, that the discordant step is aligned to a certain step in the certain pattern. In this example, the discordant step involves utilizing a certain value for a certain field that does not correspond to a value utilized for the certain field in the certain step.

In one embodiment, the method may optionally include Step 240d, which involves monitoring interactions with an instance of a software system and generating a stream of steps based on data collected from the monitoring. Optionally, this step further involves selecting the sequence from among the steps belonging to the stream (e.g., using the sequence parser module 122) and/or identifying to which BP the sequence corresponds (e.g., using the BP-Identifier module 126).

In one embodiment, the method may optionally include Step 240a, which involves monitoring interactions with instances of the software system and generating streams of steps based on data collected from the monitoring. Optionally, the streams include steps performed during interactions of users belonging to various organizations, such as the first and/or second organizations mentioned above. Additionally or alternatively, the method may optionally include Step 240b which involves collecting, from among the steps belonging to the streams, sequences of steps corresponding to successful executions of BPs. Optionally, each sequence corresponding to a successful execution of a BP does not comprise a step indicative of the sequence corresponding to an unsuccessful execution of any of the BPs. Optionally, collecting the sequences is done utilizing the sequence parser module 122 (which selects sequences from streams), the BP-Identifier module 126 (which may be utilized to identify to which BPs the sequences correspond), and/or the positive examples collector module 221. Additionally or alternatively, the method may optionally include Step 240c, which involves generating the one or more patterns based on the sequences collected in Step 240b. Optionally, the one or more patterns are generated by the model trainer module 116.

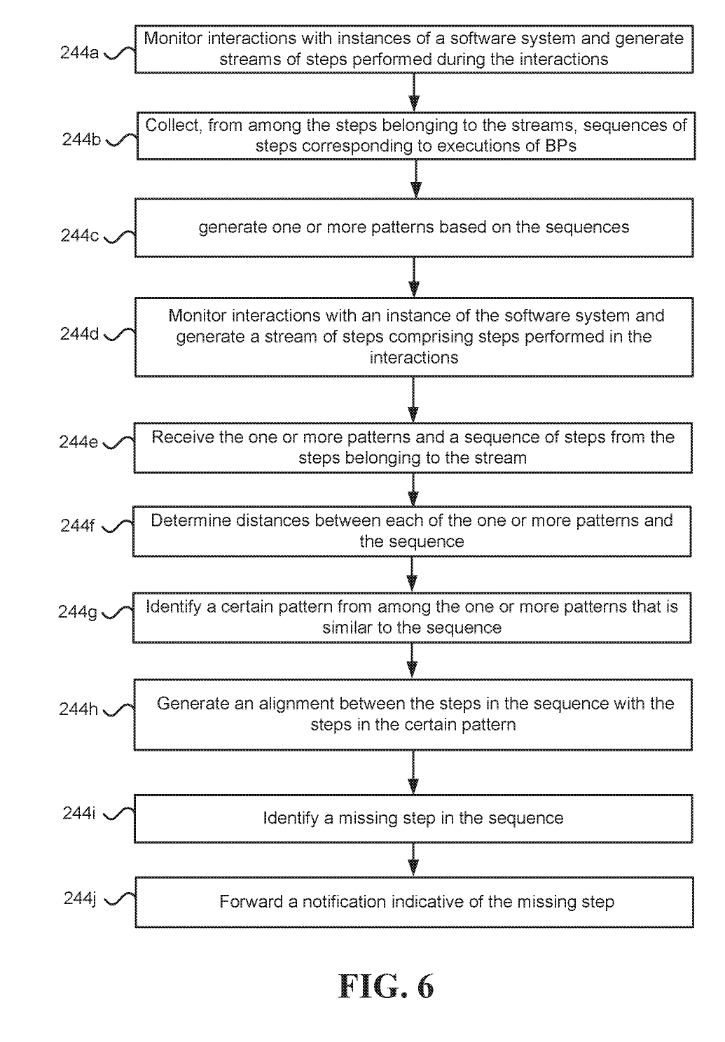

FIG. 6 illustrates steps that may be performed in one embodiment of a method for a step that is missing in an execution of BP. The steps described below may be, in some embodiments, part of the steps performed by an embodiment of a system described above, which is illustrated in FIG. 4. In some embodiments, instructions for implementing the method described below may be stored on a computer-readable medium, which may optionally be a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for a step that is missing in an execution of a BP includes at least the following steps:

In Step 244e, receiving one or more patterns corresponding to one or more BPs and a sequence of steps involved in an unsuccessful execution of a BP. Optionally, each of the one or more patterns describes a sequence of steps involved in an execution of a BP from among the one or more BPs.

In Step 244f, determining distances between each of the one or more patterns and the sequence. Optionally, the distance is determined utilizing the distance calculator module 186.

In Step 244g, identifying, based on the distances, a certain pattern from among the one or more patterns that is similar to the sequence. Optionally, the sequence is deemed similar to the certain pattern by virtue of a distance between the certain pattern and the sequence is smaller than a threshold. Optionally, the certain pattern is generated based on training data comprising first and second sequences corresponding to executions of the BP that are associated with first and second different organizations, respectively. Optionally, the sequence comprises steps executed interacting with an instance of a software system belonging to a certain organization, which is different from the first and second organizations.

In Step 244h, generating an alignment between the steps in the sequence with the steps in the certain pattern. Optionally, the alignment is generated utilizing the missing step identification module 242 and/or the distance calculator module 186.

In Step 244i, identifying, based on the alignment, a certain step in the certain pattern that is not aligned to any of the steps in the sequence. Additionally, the sequence does not comprise a step that is identical to the certain step.

And in Step 244j, forwarding a notification indicative of the missing step. Optionally, the notification is forwarded to a user who performed the sequence of steps received in Step 244e.

The certain step identified in Step 244i may represent various types of elements that are found in successful executions of the BP to which the certain pattern corresponds, but are not present in the sequence received in Steps 244e. In one example, Step 244i involves determining that the certain step involves performing a certain operation that is not performed in any of the steps in the sequence. Optionally, the notification forwarded in Step 244j is indicative of the certain operation. In another example, Step 244i involves determining that the certain step involves utilizing a certain value for a certain field a certain value is not entered to the certain field any of the steps in the sequence. Optionally, the notification forwarded in Step 244j is indicative of the certain value and/or the certain field. And in yet another example, Step 244i involves determining that the certain step involves executing a certain transaction that is not executed in any of the steps in the sequence. Optionally, the notification forwarded in Step 244j is indicative of the certain transaction.

In one embodiment, the method may optionally include Step 244d, which involves monitoring interactions with an instance of a software system and generating a stream of steps based on data collected from the monitoring. Optionally, this step further involves selecting the sequence from among the steps belonging to the stream (e.g., using the sequence parser module 122) and/or identifying to which BP the sequence corresponds (e.g., using the BP-Identifier module 126). Additionally or alternatively, this step may involve identifying the sequence corresponds to an unsuccessful execution of a BP (e.g., by identifying an error message that is indicative thereof). Optionally, the sequence corresponding to the unsuccessful execution of the BP does not comprise a step indicative of the sequence corresponding to a successful execution of any of the BPs.

In one embodiment, the method may optionally include Step 244a, which involves monitoring interactions with instances of the software system and generating streams of steps based on data collected from the monitoring. Optionally, the streams include steps performed during interactions of users belonging to various organizations, such as the first and/or second organizations mentioned above. Additionally or alternatively, the method may optionally include Step 244b which involves collecting, from among the steps belonging to the streams, sequences of steps corresponding to successful executions of BPs. Optionally, each sequence corresponding to a successful execution of a BP does not comprise a step indicative of the sequence corresponding to an unsuccessful execution of any of the BPs. Optionally, collecting the sequences is done utilizing the sequence parser module 122 (which selects sequences from streams), the BP-Identifier module 126 (which may be utilized to identify to which BPs the sequences correspond), and/or the positive examples collector module 221. Additionally or alternatively, the method may optionally include Step 244c, which involves generating the one or more patterns based on the sequences collected in Step 244b. Optionally, the one or more patterns are generated by the model trainer module 116.

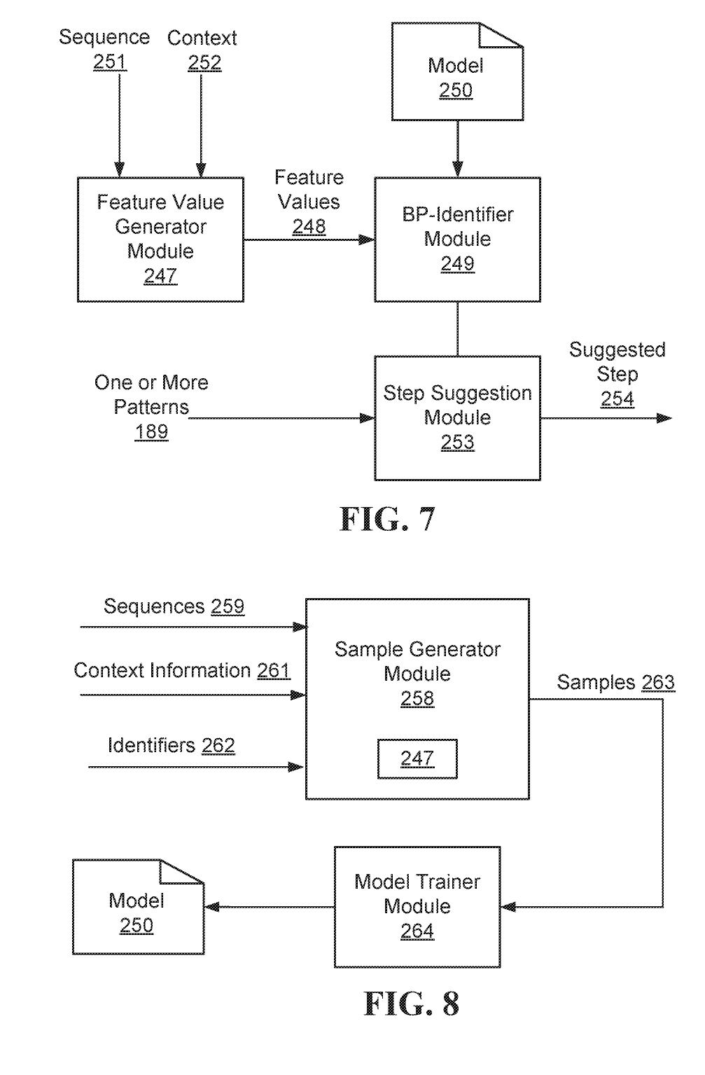

FIG. 7 illustrates one embodiment of a system configured to suggest a next step to perform. after a sequence of steps. The system includes at least the following modules: a feature value generator module 247, a BP-Identifier module 249, and a step suggestions module 253. The system may optionally include additional modules such as the sequence parser module 122 and/or a monitoring agent, such as the monitoring agent 102 (which is illustrated in FIG. 23).

The feature value generator module 247 is configured, in one embodiment, to receive: a sequence 251 of steps performed by a user interacting with an instance of a software system belonging to a certain organization, and context information 252 for the sequence 251. The feature value generator module 247 is configured to generate feature values 248 based on the sequence 251 and the context information 252. In this embodiment, the feature values 248 include at least one feature value determined. based on the sequence 251 and at least one feature value determined based on the context information 252.

It is to be noted that the sequence 251 includes steps involved in an execution of a BP, but not necessarily all the steps involved in a complete execution of the BP. Optionally, in order for the execution of the BP to be considered a successful execution, at least one additional step needs to be performed some time after the steps in the sequence 251 are performed.

In some embodiments, at least sonic of the feature values 248 include feature values that are indicative of what is performed in the steps belonging to the sequence 251. In one example, the feature values 248 comprise a feature value that represents an indicator of whether the sequence 251 comprises a certain subsequence of one or more steps. In another example, the feature values 248 comprise a feature value that is indicative of whether a certain transaction is in a step belonging to the sequence 251. And in still another example, the feature values 248 comprise a feature value that is indicative of whether a certain set of two or more transactions are executed in a certain order in steps belonging to the sequence 251.

The context information 252 may include data regarding at least one of the following: the user, the certain organization, an activity history of the user, and an activity history of the certain organization. The context information 252 may be useful, in some embodiments, for identifying the BP to which the sequence 251 corresponds (i.e., the BP on behalf of whose execution the steps in the sequence 251 are performed). For example, there may be cases in which a certain sequence steps may be part of the execution of multiple BPs. In such a case, the context information may assist in determining, for a specific instance in which the certain sequence was performed, which of the multiple BPs is being executed. The following are some examples various possibilities for the context information in different embodiments.

In one embodiment, the context information 252 is indicative of one or more of the following values: (i) a role of the user; (ii) a field of operations of the certain organization; and (iii) a value related to at least one of the following: a time of day during which at least some of the steps in the sequence were executed, and a date during which at least some of the steps in the sequence were executed. In one example, the role of the user may be a value indicative of the user's job title (e.g., development engineer, tester, HR, etc.), department, and/or type of activity the user is performing at the time (e.g., procurement, customer relations, budget reports, etc.) In one example, the field of operations of the certain organization refers to the type of sector to which the certain organization belongs (e.g., banking, insurance, advertising, chemical industries, auto industries, etc.)

In another embodiment, the context information 252 comprises a value that is based on the activity history of the user. Optionally, the activity history of the user is indicative of at least one of the following: (i) the identity of at least sonic of the transactions executed by the user before the steps in the sequence 251 were executed; (ii) the identity of at least some of the BPs executed by the user before performing steps belonging to the sequence 251. In some cases, what the user previously executed may provide information about what the steps in the sequence 251 relate to.

In another embodiment, the context information 252 comprises a value that is based on the activity history of the certain organization. Optionally, the activity history of the certain organization is indicative of at least one of the following: (i) the identity of at least some of the transactions, which were executed by users belonging to the certain organization before the steps in the sequence 251 were performed; (ii) the identity of at least some of the BPs, which were executed by users belonging to certain the organization before the steps in the sequence 251 were performed. In some cases, transaction and/or BPs previously executed in an organization may provide information about what the current steps performed by the user relate to.

The BP-Identifier module 249 is configured, in some embodiments, to utilize a model 250 to identify a BP to which the sequence 251 corresponds based on the feature values 248. Optionally, the BP-Identifier module 249 calculates a value based on the feature values 248 and the model 250, which is indicative of a BP to which the sequence 251 corresponds. Optionally, the model 250 is a model generated utilizing a machine learning-based training algorithm. In one embodiment, the model 250 may be a model of a classifier, which may be used by the BP-Identifier module 249 to select, based on the feature values 248, a class corresponding to BP to which the sequence 251 corresponds. Some examples of types of models that may be used in this embodiment include a nearest neighbors model, a k-means model, a model of a support vector machine, a model of a decision tree, and other machine learning approaches known in the art. In another embodiment, the model 250 may be a model used to calculate a value indicative of how likely the sequence 251 corresponds to an execution of a certain BP. Some examples of types of models that may be used in this embodiment include a neural network model, a logistic regression model, a support vector machine model, a naïve Bayes model, a decision tree model, and other machine learning approaches known in the art. Additional details regarding generation of the model 250 are discussed further below in the discussion related to FIG. 8.

In one embodiment, the model 250 may be considered a crowd-based model. In one example, the sequences used to generate training data used to train the model 250 comprise at least a first sequence of steps corresponding to an execution of the BP associated with a first organization and a second sequence of steps corresponding to an execution of the BP associated with a second organization, which is different from the first organization. In this example, the first and second organizations are different from the organization.

The step suggestion module 253 is configured, in some embodiments, to align the sequence 251 to a subsequence of a pattern corresponding to the BP, and to provide an indication of a step 254 that follows the subsequence in the pattern. Optionally, the pattern is selected from among the one or more patterns 189 based on an identification of the BP to which the sequence 251 corresponds, which is generated by the BP-Identifier module 249. Optionally, the indication of the step 254 is provided to a user who performs at least sonic of the steps in the sequence 251. For example, the indication may be provided to a user interface (e.g., a screen or some other form of display) used by the user.

In one embodiment, the pattern with which the sequence 251 is aligned was generated based on a set comprising sequences of steps corresponding to an execution of the BP. In one example, the set comprises a first sequence of steps corresponding to an execution of the BP associated with a first organization and a second sequence of steps corresponding to an execution of the BP associated with a second organization, which is different from the first organization. Additionally, in this example, the first and second organizations are different from the certain organization. Additional discussion regarding generation of patterns for BPs may be found in this disclosure at least in Section 5—Models of BPs.

Various alignment functions may be utilized to generate an alignment between the sequence 251 and the pattern (i.e., an alignment between the sequence 251 and a sequence of steps described by the pattern). In one example, a pairwise trace alignment may be used, such as described in Bose, et al. “Trace alignment in process mining: opportunities for process diagnostics”, International Conference on Business Process Management, Springer Berlin Heidelberg, 2010. In another example, a variant of one of the many sequence alignment algorithms developed for aligning biological sequences may be used for this task (e.g., a sequence alignment algorithm that utilized dynamic programming to find an optimal alignment according to a chosen distance function).

In one embodiment, aligning the sequence 251 and the subsequence of the pattern involves generating an alignment describing a pairing between most of the steps in the sequence 251 and steps in the subsequence, where each step from among the most of the steps in the sequence 251 is paired with a different step in the subsequence. Optionally, no two steps from the sequence 251 are aligned with the same step in the subsequence. Optionally, the alignment is order preserving, such that if first and second. steps in the sequence 251 are aligned with third and fourth steps in the subsequence, where the first step is aligned with the third step and the second step is aligned with the fourth step, then the fact that in the sequence 251, the first step precedes the second step, implies that in the subsequence, the third step precedes the fourth step. Optionally, the subsequence of the pattern does not include all the steps in the pattern, and as such does not include a set of steps whose performance corresponds to a complete execution of the BP to which the pattern corresponds. Optionally, the subsequence is a proper prefix of a certain sequence of steps described by the pattern, and the certain sequence corresponds to a successful execution of the BP to which the pattern corresponds.

In one embodiment, the sequence 251 is selected from among the steps belonging to the stream 227. Optionally, the sequence 251 is selected from the stream 227 utilizing the sequence parser module 122. Optionally, the stream 227 is generated by the monitoring agent 102, which is configured, in one embodiment, to monitor interactions with an instance of a software system belonging to a certain organization and to generate the stream 227. A discussion about the various types of software systems that may be interacted with in embodiments described in this disclosure, as well as what it means for a software system to “belong” to an organization, is provided in Section 1—Software Systems and Organizations. Additionally, that section also includes more details regarding what constitutes an “organization”.

A monitoring agent, such as the agent 102, may be categorized, in some embodiments, as being an “internal monitoring agent” and/or an “interface monitoring agent”. Generally put, an internal monitoring agent is a monitoring agent that utilizes functionality of the software system with which an interaction occurs, while the interface monitoring agent, as it names suggests, relies more on data that is provided and/or received via a user interface. The following are some examples of various monitoring agents that may he utilized. Additional discussion regarding monitoring agents and the data they examine/produce may be found in this disclosure at least in Section 2—Monitoring Activity.

FIG. 8 illustrates an embodiment of a system configured to generate the model 250. The system includes at least the following modules: a sample generator module 258, and a model trainer module 264.

The sample generator module 258 is configured to generate the samples 263 based on data comprising: sequences 259 corresponding to executions of BPs, context information 261 for the sequences 259, and identifiers 262 for the sequences 259 indicating to which BPs they correspond. Optionally, each of the sequences 259 corresponds to an execution of a BP, and comprises steps performed during interactions of a user with one or more software systems. In one embodiment, each of the samples 263 corresponds to a sequence from among the sequences 259 and comprises feature values and a label indicative of the BP to which the sequence corresponds. Optionally, the feature values for each of the samples 263 are generated utilizing the feature values generator module 247.

In one embodiment, the sequences 259 correspond to complete executions of BPs. Optionally, the executions are successful executions of the BPs. For example, the executions do not result in an error message and/or the executions result in a success message. Optionally, in this embodiment, for each of the samples 263, the generated feature values comprise: a feature value determined based on a proper prefix of a sequence from among the sequences 259, and a feature value determined based on the context information for the sequence (where the context information for the sequence comes from the context information 261).

In another embodiment, each of the sequences 259 does not correspond to a complete execution of the BP. That is, performing a complete execution of the BP corresponding to a sequence from among the sequences 259 typically involves performing one or more steps besides the steps included in the sequence. Optionally, in this embodiment, for each of the samples 263, the generated feature values comprise: a feature value determined based on a sequence from among the sequences 259, and a feature value determined based on the context information for the sequence (where the context information for the sequence comes from the context information 261).

The model 250 may be considered, in some embodiments, a crowd-based model. For example, the sequences 259 may correspond to executions of BPs associated with various organizations. In particular, in some examples, the sequences 259 comprise at least a first sequence of steps performed during an interaction with an instance of a software system belonging to a first organization and a second sequence of steps performed during an interaction with an instance of the software system which belongs to a second organization, which is different from the first organization. Optionally, the first and second organizations are different from the certain organization described above (to which the sequence 251 corresponds).

In one embodiment, the context information 261 includes for each sequence from among the sequences 259, data that is indicative of one or more of the following values: (i) a role of a user, who performed at least some steps belonging to the sequence, in an organization to which the user belongs; (ii) an area of business of the organization: and (iii) a value related to at least one of the following: a time of day during which at least some of the steps in the sequence were executed, and a date during which at least some of the steps in the sequence were executed.

In another embodiment, the context information 261 is derived from at least one of the following activity histories: an activity history of a user who performed at least some of the steps belonging to the sequence, and an activity history of an organization to which the user belongs. In one example, the activity history of the user is indicative of at least one of the following: the identity of at least some of the transactions executed by the user before the steps in the sequence were executed; (ii) the identity of at least some of the BPs executed by the user before performing steps belonging to the sequence. In another example, the activity history of the certain organization is indicative of at least one of the following: (i) the identity of at least some of the transactions, which were executed by users belonging to the organization, before the steps in the sequence were performed; (ii) the identity of at least some of the BPs, which were executed by users belonging to the organization, before the steps in the sequence were executed. Optionally, the activity histories used to provide context for a sequence comprise values derived from recent activity that took place up to one week before the steps in the sequence were executed. Optionally, at least some of the data used to generate activity histories is obtained by monitoring interactions of users with instances of one or more software systems.

In some embodiments, a certain sequence of steps may be common to executions of multiple BPs. However, the context information may be used to identify to which of the multiple BPs the certain sequence of steps corresponds (e.g., when the certain sequence is observed in data collected while monitoring interactions with an instance of a software system). In one example, the sequences 259 comprise first and second sequences corresponding to executions of first and second BPs. A certain sequence of steps is a proper prefix of both the first and second sequences. However, the samples comprise first and second samples generated for the first and second sequences, respectively. In the first and second samples, the one or more feature values determined based the proper prefix are the same, while the one or more feature values determined based on the context information are different.

The model trainer module 264 is configured, in one embodiment, to generate the model 250 based on the samples 263 and to provide the model 250 for use by a system that identifies a BP from a provided sequence of steps and context information related to the provided sequence (e.g., an embodiment of the system illustrated in FIG. 7). Optionally, generating the model 250 involves utilizing one or more machine learning-based training algorithms. In one embodiment, the model 250 may be a classification algorithm used to classify samples that include feature values (e.g., feature values generated by the feature value generator module 247) to classes, where each class corresponds to one or more BPs. Some examples of types of models the model 250 may be, in this embodiment, include a nearest neighbors model, a k-means model, a model of a support vector machine, a model of a decision tree, and other machine learning approaches known in the art. In another embodiment, the model 250 may be a model used to calculate a value indicative of how likely the sequence 251 corresponds to an execution of a certain BP. Some examples of types of models that may be used in this embodiment include a neural network model, a logistic regression model, a support vector machine model, a naïve Bayes model, a decision tree model, and other machine learning approaches known in the art.

In some embodiments, the system illustrated in FIG. 8 may optionally include a plurality of monitoring agents (e.g., from among the monitoring agents 102a to 102d illustrated in FIG. 22), which are configured to generate streams of steps from among which the sequences 259 are selected (e.g., utilizing the sequence parser module 122). Optionally, each monitoring agent generates a stream comprising steps performed as part of an interaction with an instance of a software system from among the one or more software systems. Additional information regarding the monitoring agents and the generation of the streams may be found in this disclosure at least in the sections 2—Monitoring Activity and 3—Streams and Steps.

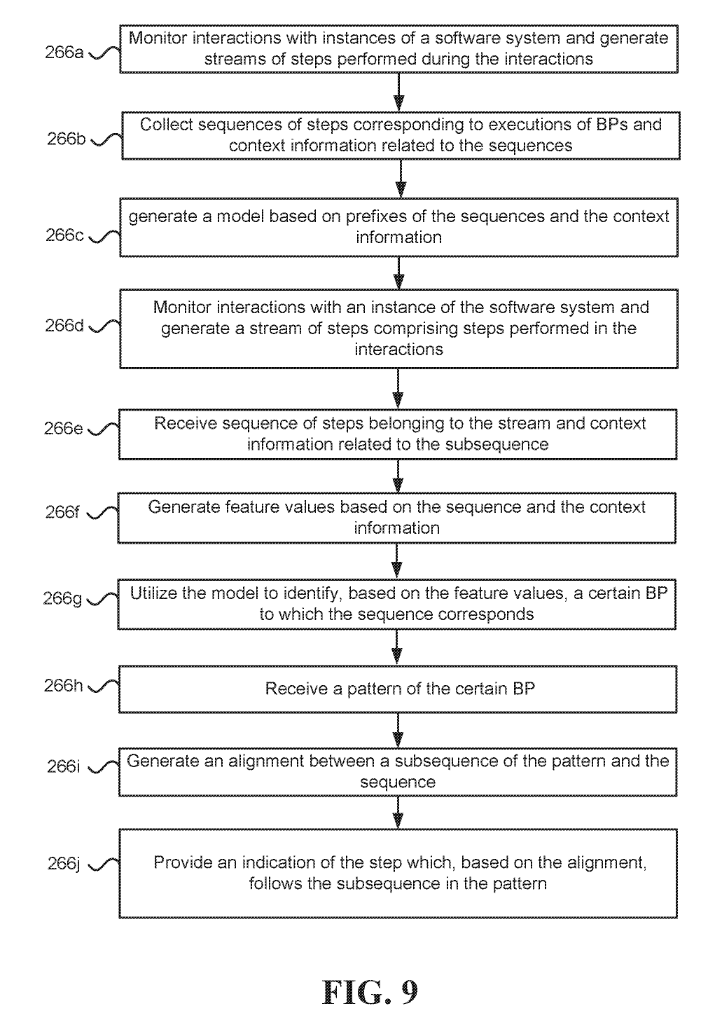

FIG. 9 illustrates steps that may be performed in one embodiment of a method for suggesting a next step to perform after a sequence of steps. The steps described below may be, in some embodiments, part of the steps performed by an embodiment of a system described above, which is illustrated in FIG. 7. In some embodiments, instructions for implementing the method described below may be stored on a computer-readable medium, which may optionally he a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for suggesting a next step to perform after a sequence of steps includes at least the following steps:

In Step 266e, receiving, by a system comprising a processor and memory, a sequence of steps performed by a user interacting with an instance of a software system belonging to a certain organization and context information for the sequence. The context information corresponds to at least one of the following: the user, the certain organization, an activity history of the user, and an activity history of the certain organization.

In Step 266f, generating feature values based on data received in Step 266e. The feature values comprising: a feature value determined based on the sequence, and a feature value determined based on the context information for the sequence. Optionally, the feature values are generated utilizing the feature value generator module 247.

In Step 266g, utilizing a model to identify, based on the feature values, a BP to which the sequence of steps corresponds. Optionally, the model is the model 250. Optionally, the model is generated by performing 266a to 266c, which are described further below.

In Step 266h, receiving a pattern corresponding to the BP. Optionally, the pattern is generated based on a set comprising sequences of steps corresponding to an execution of the BP. Optionally, the set comprises a first sequence of steps corresponding to an execution of the BP associated with a first organization and a second sequence of steps corresponding to an execution of the BP associated with a second organization, which is different from the first organization.

In Step 266i, generating an alignment of the sequence to a subsequence of the pattern. Optionally, the alignment is indicative of a pairing of most of the steps in the sequence to steps in the subsequence, where each step from among the most of the steps in the sequence is aligned with a different step in the subsequence. Optionally, no two steps from the sequence are aligned with the same step in the subsequence.

And in Step 266j, providing an indication of a certain step which, based on the alignment, follows the subsequence in the pattern. Optionally, the certain step is not the last step in the sequence. Optionally, the certain step does not appear in the sequence.

In one embodiment, the method may optionally include Step 266d, which involves monitoring interactions of the user with the instance of the software system belonging to the certain organization and generating a stream comprising steps performed as part of the interaction. The sequence received in Step 266e comprises one or more steps belonging to the stream. Optionally, monitoring the interactions is done utilizing a monitoring agent such as the monitoring agent 102 illustrated in FIG. 23.

The method described above may include, in some embodiments, steps related to the generation of the context information received in Step 266e. In one example, the method may include a step of generating context information for the sequence, which is indicative of one or more of the following values: (i) a role of the user; (ii) a field of operations of the certain organization; and (iii) a value related to at least one of the following: a time of day during which at least some of the steps in the sequence were executed, and a date during which at least some of the steps in the sequence were executed: In another example, the method may include a step of generating context information for the sequence, from at least one of the following activity histories: an activity history the user, and an activity history of the certain organization.

In one embodiment, the method may optionally include Step 266c, which involves generating the model utilizing samples generated based on data comprising: sequences corresponding to executions of BPs, context information for each of the sequences, and identifiers for the sequences indicating to which BPs they correspond. Each sequence corresponding to an execution of a BP comprises steps performed during interactions of a user with one or more software systems. Additionally, each of the samples corresponds to a sequence from among the sequences and comprises feature values and a label indicative of the BP to which the sequence corresponds. Optionally, the feature values are generated utilizing the feature value generator module 247. Optionally, the feature values in each sample corresponding to a sequence include at least: a feature value determined based on a proper prefix of the sequence, a feature value determined based on the context information for the sequence.

In one embodiment, the method may optionally include Step 266a, which involves monitoring interactions with instances of a software system and generating streams of steps based on data collected from the monitoring. Optionally, the streams include steps performed during interactions of users belonging to the first and/or second organizations mentioned above. Additionally or alternatively, the method may optionally include Step 266b which involves collecting, from among the steps belonging to the streams, sequences of steps corresponding to executions of BPs. Optionally, the sequences correspond to successful executions of the BPs. Optionally, collecting the sequences is done utilizing the sequence parser module 122 (which selects sequences from streams) and/or the BP-Identifier module 126 (which may be utilized to identify to which BPs the sequences correspond).

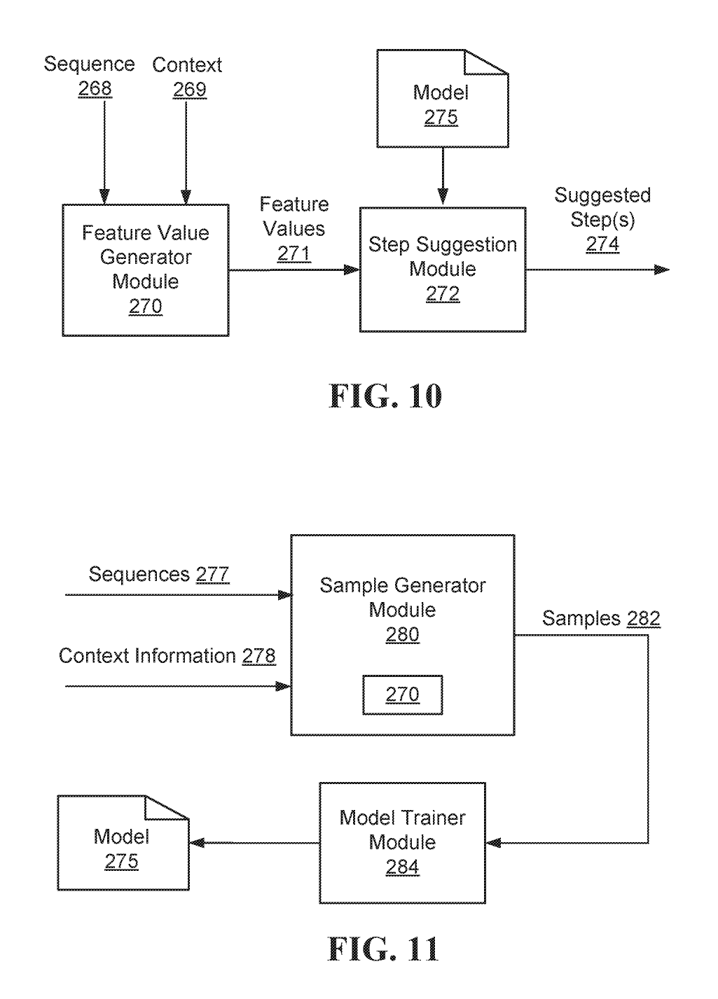

FIG. 10 illustrates one embodiment of a system configured to suggest a next step to perform after a sequence of steps was performed. The system includes at least the following modules: a feature value generator module 270, and a step suggestions module 272. The system may optionally include additional modules such as the sequence parser module 122 and/or a monitoring agent, such as the monitoring agent 102 (which is illustrated in FIG. 23).

The feature value generator module 270 is configured, in one embodiment, to receive a sequence 268 of steps comprising steps performed by a user interacting with an instance of a software system belonging to a first organization and context information 269 for the sequence. The feature value generator module 270 is further configured to generate feature values 271 based on the sequence 268 and the context information 269. In this embodiment, the feature values 271 include at least one feature value determined based on the sequence 268 and at least one feature value determined based on the context information.

In some embodiments, at least some of the feature values 271 include feature values that are indicative of what is performed in the steps belonging to the sequence 268. In one example, the feature values 271 comprise a feature value that represents an indicator of whether the sequence 268 comprises a certain subsequence of one or more steps. In another example, the feature values 271 comprise a feature value that is indicative of whether a certain transaction is in a step belonging to the sequence 268. And in still another example, the feature values 271 comprise a feature value that is indicative of whether a certain set of two or more transactions are executed in a certain order in steps belonging to the sequence 268.

In one embodiment, the context information 269 includes data regarding at least one of the following: the user, the first organization, an activity history of the user, and an activity history of the first organization. Optionally, the context information 269 is indicative of one or more of the following values: (i) a role of the user; (ii) an area of business of the first organization; and (iii) a value related to at least one of the following: a time of day during which at least some of the steps in the sequence were performed, and a date during which at least some of the steps in the sequence were performed.

In another embodiment, the context information 269 comprises a value that is based on the activity history of the user. Optionally, the activity history of the user is indicative of at least one of the following: (i) the identity of at least some of the transactions executed by the user before the steps in the sequence 268 were performed; (ii) the identity of at least some of the BPs executed by the user before performing steps belonging to the sequence 268. In sonic cases, what the user previously executed may provide information about what the steps in the sequence 268 relate to.

In another embodiment, the context information 269 comprises a value that is based on the activity history of the first organization. Optionally, the activity history of the first organization is indicative of at least one of the following: (i) the identity of at least some of the transactions, which were executed by users belonging to the first organization, before the steps in the sequence 268 were performed; (ii) the identity of at least some of the BPs, which were executed by users belonging to certain the organization, before the steps in the sequence 268 were performed. In some cases, transaction and/or BPs previously executed in an organization may provide information about what the steps in the sequence 268 relate to.

The step suggestion module 272 is configured, in some embodiments, to utilize a model 275 to suggest, based on the feature values 271, one or more steps 274 to perform following performance of the steps belonging to the sequence 268. Optionally, the model 275 is used to calculate, based on a the feature values 271, a plurality of values, each of which is indicative of a probability that a certain one or more steps are to be performed after the steps belonging to the sequence 268. In one embodiment, the model 275 is a model of a classifier that selects one or more classes of likely next steps, based on the feature values 271. In another embodiment, the model 275 is a model generated using a machine learning-based training algorithm. For example, the model 275 may be a model comprising parameters of one or more of the following: a support vector machine, a neural network, a decision tree, or some other machine learning-based model known in the art.

In one embodiment, the model 275 is generated based on data comprising sequences of steps and context information for the sequences. Optionally, at least some of the sequences comprise steps performed during interactions with instances of a software system belonging to a second organization, which is different from the first organization. Additionally, at least some of the sequences may comprise steps performed during interactions with instances of a software system belonging to a third organization, which is different from the first and second organizations. Additional details regarding the generation of the model 275 is given further below in the discussion regarding FIG. 11.

In one embodiment, the one or more steps 274 are a single step that is suggested to the user. Optionally, the single step is a step, from among a plurality of candidate steps, which is found to be most suitable and/or likely to be performed after the steps belonging to the sequence 268. For example, the single step may be the step for which a score calculated based on the feature values 271 and the model 275, is highest from among scores calculated for the plurality of steps. In another embodiment, the one or more steps 274 comprise a certain number of steps (greater than one) that scored the highest from among the scores calculated for the plurality of steps. In still another embodiment, the one or more steps 274 comprise steps, from among the plurality of steps, for which a score calculated based on the feature values 271 and the model 275 reaches a threshold.

In one embodiment, the step suggestion module 272 is further configured to suggest performing the one or more steps 274 by providing a description of the one or more steps 274 to a user. Optionally, the description comprises at least one of the following: a text description, an audio description, an image, and video. Optionally, the description is presented to the user on a user interface utilized by the user to perform the steps in the sequence 268 (e.g., the user interface may include a screen and/or some other form of display such as an augmented reality display).

In some embodiments, the step suggestion module 272 may calculate and/or evaluate confidence values in of two or more candidate steps (that may be suggested to the user). For example, a confidence value for a candidate step may be indicative of a probability that in successful executions of a BP, the candidate step was in fact performed by a user following the steps in the sequence 268. Optionally, responsive to a determination that a confidence value corresponding to a certain step, from among the two or more candidate steps, reaches a threshold, the step suggestion module 272 suggests performing the certain step to the user. Optionally, the confidence value of at least one of the two or more candidate steps does not reach the threshold. In one example, the step suggestion module 272 is further configured to suggest performing the certain step by describing the two or more candidate steps and their corresponding confidence values.

The context information is utilized, in some embodiments, to determine what steps to suggest in ambiguous cases. For example, the same sequence of steps me be a prefix of sequences corresponding to different BPs and/or to different variants of BPs. In this example, context information can assist the step suggestion module 272 to determine which steps from among various possibilities (corresponding to the different BPs and/or the different variants) to suggest. In one example, given first feature values generated based on a certain sequence and first context information, the step suggestion module 272 suggests a first step to perform after the certain sequence. However, in this example, given second feature values generated based on the certain sequence and second context information (different from the first context information), the step suggestion module 272 suggests a second step to perform after the certain sequence, which is different from the first step.

In one embodiment, the sequence 268 is selected from among the steps belonging to the stream 227. Optionally, the sequence 268 is selected from the stream 227 utilizing the sequence parser module 122. Optionally, the stream 227 is generated by the monitoring agent 102, which is configured, in one embodiment, to monitor interactions with an instance of a software system belonging to the first organization and to generate the stream 227. A discussion about the various types of software systems that may be interacted with in embodiments described in this disclosure, as well as what it means for a software system to “belong” to an organization, is provided in Section 1—Software Systems and Organizations. Additionally, that section also includes more details regarding what constitutes an “organization”.

A monitoring agent, such as the aunt 102, may be categorized, in some embodiments, as being an “internal monitoring agent” and/or an “interface monitoring agent”. Generally put, an internal monitoring agent is a monitoring agent that utilizes functionality of the software system with which an interaction occurs, while the interface monitoring agent, as it names suggests, relies more on data that is provided and/or received via a user interface. The following are some examples of various monitoring agents that may be utilized. Additional discussion regarding monitoring agents and the data they examine/produce may be found in this disclosure at least in Section 2—Monitoring Activity.

FIG. 11 illustrates an embodiment of a system configured to generate the model 275. The system includes at least the following modules: a sample generator module 280, and a model trainer module 284.

The sample generator module 280 is configured to generate the samples 282 based on data comprising: sequences 277 corresponding to executions of BPs, and context information 278 for the sequences 277. Optionally, each of the sequences 277 corresponds to an execution of a BP, and comprises steps performed during interactions of a user with one or more software systems. In one embodiment, each of the samples 282 corresponds to a sequence from among the sequences 277 and comprises feature values corresponding to a prefix of the sequence 277 and a label indicative of one or more steps from the sequence, which were performed after the steps in the prefix. Optionally, the feature values for each of the samples 282 are generated utilizing the feature values generator module 270.

In one embodiment, the sequences 277 correspond to complete executions of BPs. Optionally, the executions are successful executions of the BPs. For example, the executions do not result in an error message and/or the executions result in a success message. Optionally, in this embodiment, for each of the samples 282, the generated feature values comprise: a feature value determined based on a proper prefix of a sequence from among the sequences 277, and a feature value determined based on the context information for the sequence.

In another embodiment, at least some of the sequences 277 dos not correspond to a complete execution of the BP. That is, performing a complete execution of the BP corresponding to a sequence from among the at least some sequences typically involves performing one or more steps besides the steps included in the sequence. Optionally, in this embodiment, for at least some of the samples 282, the generated feature values comprise: a feature value determined based on a sequence from among the sequences 277, and a feature value determined based on the context information for the sequence.

The model 275 may be considered, in some embodiments, a crowd-based model. For example, the sequences 277 may correspond to executions of BPs associated with various organizations. In particular, in some examples, the sequences 277 comprise at least a first sequence of steps performed during an interaction with an instance of a software system belonging to a certain first organization and a second sequence of steps performed during an interaction with an instance of the software system which belongs to a certain second organization, which is different from the certain first organization.

In one embodiment, the context information 278 includes for each sequence from among the sequences 277, data that is indicative of one or more of the following values: (i) a role of a user, who performed at least some steps belonging to the sequence, in an organization to which the user belongs; (ii) an area of business of the organization; and (iii) a value related to at least one of the following: a time of day during which at least some of the steps in the sequence were performed, and a date during which at least some of the steps in the sequence were performed.

In another embodiment, the context information 278 is derived from at least one of the following activity histories: an activity history of a user who performed at least sonic of the steps belonging to the sequence, and an activity history of an organization to which the user belongs. In one example, the activity history of the user is indicative of at least one of the following: the identity of at least some of the transactions executed by the user before the steps in the sequence were executed; (ii) the identity of at least sonic of the BPs executed by the user before performing steps belonging to the sequence. In another example, the activity history of the first organization is indicative of at least one of the following: (i) the identity of at least some of the transactions, which were executed by users belonging to the organization, before the steps in the sequence were performed; (ii) the identity of at least some of the BPs, which were executed by users belonging to the organization, before the steps in the sequence were performed. Optionally, the activity histories used to provide context for a sequence comprise values derived from recent activity that took place up to one week before the steps in the sequence were performed. Optionally, at least some of the data used to generate activity histories is obtained by monitoring interactions of users with instances of one or more software systems.

In some embodiments, a certain sequence of steps may be common to multiple BPs and/or to different variants of a BP. Thus, the certain sequence of steps may be followed, in different executions, by different steps. However, the context information may be used to identify which steps are likely to follow the certain sequence in a given execution. In one example, the sequences 277 comprise first and second sequences corresponding to executions of first and second BPs. A certain sequence of steps is a proper prefix of both the first and second sequences. However, the samples 282 comprise first and second samples generated for the first and second sequences, respectively. In the first and second samples, the one or more feature values determined based the proper prefix are the same, while the one or more feature values determined based on the context information are different.

The model trainer module 284 is configured, in one embodiment, to generate the model 275 based on the samples 282 and to provide the model 275 for use by a system that suggest steps to perform after a sequence of steps were performed (e.g., an embodiment of the system illustrated in FIG. 10). Optionally, generating the model 275 involves utilizing one or more machine learning-based training algorithms. In one embodiment, the model 275 may be a classification algorithm used to classify samples that include feature values (e.g., feature values generated by the feature value generator module 270) to classes, where each class corresponds a certain one or more steps and/or a set each comprising one or more steps. Some examples of types of models the model 275 may be, in this embodiment, include a nearest neighbors model, a k-means model, a model of a support vector machine, a model of a decision tree, and other machine learning approaches known in the art. In another embodiment, the model 275 may be a model used to calculate a value indicative of how likely a sequence is to be followed by a certain one or more steps. Some examples of types of models that may be used in this embodiment include a neural network model, a logistic regression model, a support vector machine model, a naïve Bayes model, a decision tree model, and other machine learning approaches known in the art.

In some embodiments, the system illustrated in FIG. 11 may optionally include a plurality of monitoring agents (e.g., from among the monitoring agents 102a to 102d illustrated in FIG. 22), which are configured to generate streams of steps from among which the sequences 277 are selected (e.g., utilizing the sequence parser module 122). Optionally, each monitoring agent generates a stream comprising steps performed as part of an interaction with an instance of a software system from among the one or more software systems. Additional information regarding the monitoring agents and the generation of the streams may be found in this disclosure at least in the sections 2—Monitoring Activity and 3—Streams and Steps.

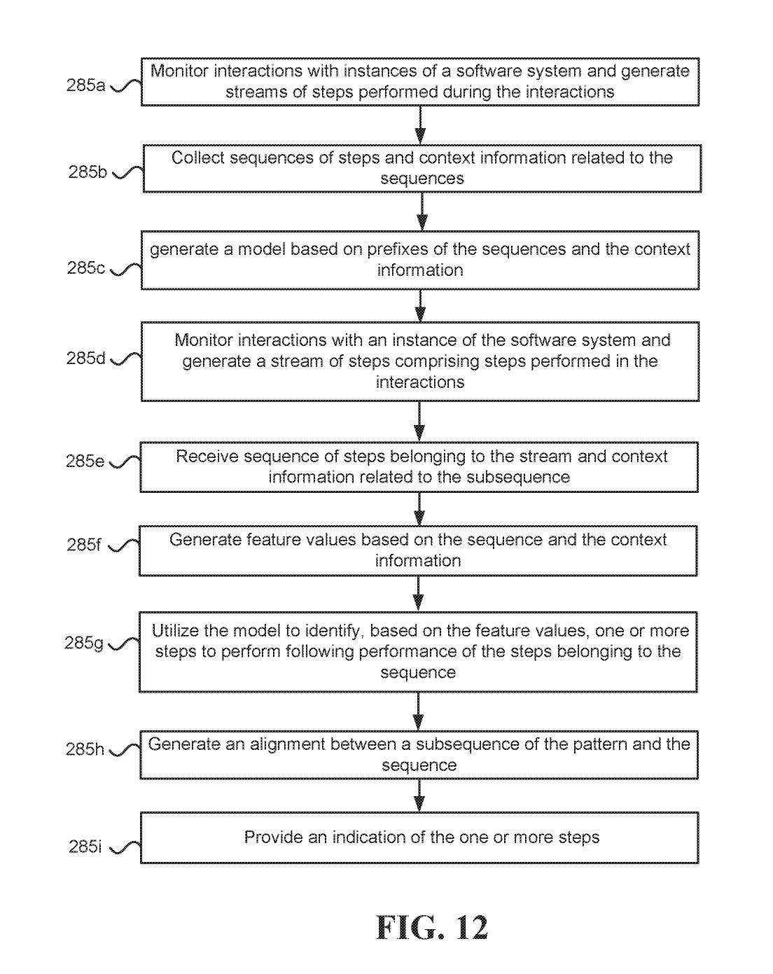

FIG. 12 illustrates steps that may be performed in one embodiment of a method for suggesting a next step to perform after a sequence of steps. The steps described below may he, in some embodiments, part of the steps performed by an embodiment of a system described above, which is illustrated in FIG. 10. In some embodiments, instructions for implementing the method described below may be stored on a computer-readable medium, which may optionally he a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for suggesting a next step to perform after a sequence of steps includes at least the following steps:

In Step 285e, receiving a sequence of steps performed by a user interacting with an instance of a software system belonging to a first organization and context information for the sequence. Optionally, the context information corresponds to at least one of the following: the user, the first organization, an activity history of the user, and an activity history of the first organization.

In Step 285f, generating feature values based on data received in Step 285e. The feature values comprising: a feature value determined based on the sequence, and a feature value determined based on the context information for the sequence. Optionally, the feature values are generated utilizing the feature value generator module 270.

In Step 285g, utilizing a model to determine, based on the feature values generated in Step 285f, one or more steps to perform following performance of the steps belonging to the sequence received in Step 285e. Optionally, the model is generated based on data comprising sequences of steps and context information for the sequences. Optionally, at least some of the sequences comprise steps performed. during interactions with instances of a software system belonging to a second organization, which is different form the first organization. Optionally, the model is the model 275. Optionally, the model is generated by performing 285a to 285c, which are described further below.

And in Step 285h, providing an indication of the one or more steps to the user.

In one embodiment, the method may optionally include Step 285d, which involves monitoring interactions of the user with the instance of the software system belonging to the first organization and generating a stream comprising steps performed as part of the interaction. The sequence received in Step 285e comprises one or more steps belonging to the stream. Optionally, monitoring the interactions is done utilizing a monitoring agent such as the monitoring agent 102 illustrated in FIG. 23.

The method described above may include, in some embodiments, steps related to the generation of the context information received in Step 285e. In one example, the method may include a step of generating context information for the sequence, which is indicative of one or more of the following values: (i) a role of the user; (ii) a field of operations of the first organization; and (iii) a value related to at least one of the following: a time of day during which at least some of the steps in the sequence were performed, and a date during which at least some of the steps in the sequence were performed. In another example, the method may include a step of generating, context information for the sequence from at least one of the following activity histories: an activity history the user, and an activity history of the first organization.

In one embodiment, the method may optionally include Step 285c, which involves generating the model utilizing samples generated based on data comprising: sequences of steps, and context information for each of the sequences. Each sequence comprises steps performed during interactions of a user with one or more software systems. Additionally, each of the samples corresponds to a sequence from among the sequences and comprises feature values and a label indicative of one or more steps performed after the sequence. Optionally, the feature values are generated utilizing the feature value generator module 270. Optionally, the feature values in each sample corresponding to a sequence include at least: a feature value determined based on the sequence, a feature value determined based on the context information for the sequence.

In one embodiment, the method may optionally include Step 285a, which involves monitoring interactions with instances of one or more software systems and generating streams of steps based on data. collected from the monitoring. Optionally, the streams include steps performed during interactions of users belonging to the first and/or second organizations mentioned above. Additionally or alternatively, the method may optionally include Step 285b which involves collecting, from among the steps belonging to the streams, sequences of steps. Optionally, the sequences correspond to successful executions of BPs. Optionally, collecting the sequences is done utilizing the sequence parser module 122 (which selects sequences from streams).

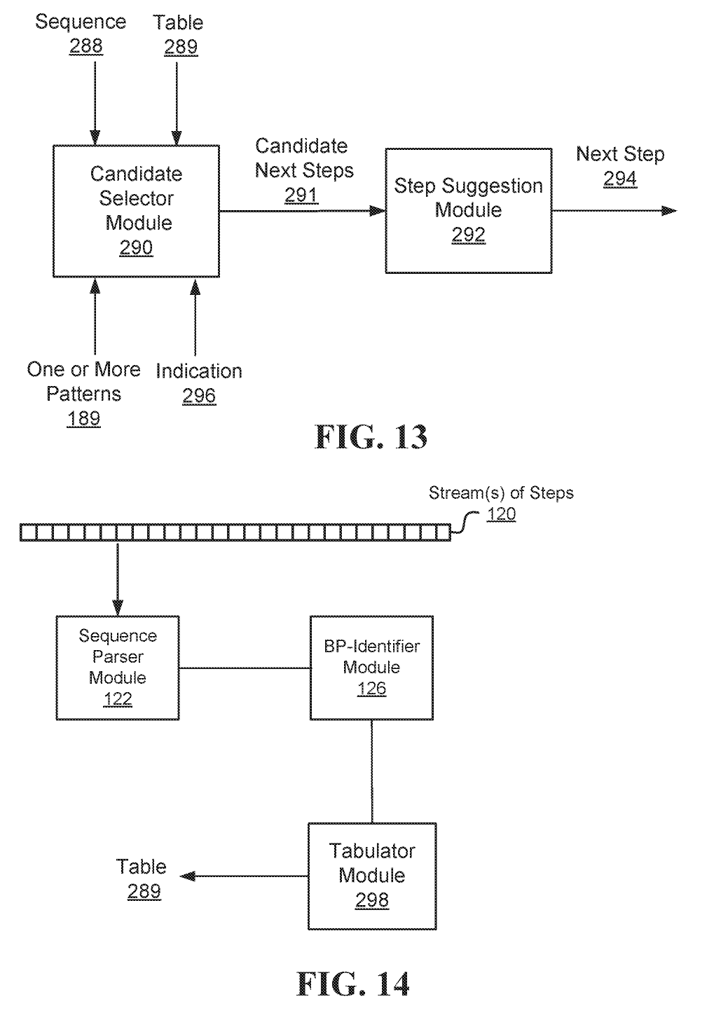

FIG. 13 illustrates one embodiment of a system configured to suggest a frequently performed next step in an execution of a BP. The system includes at least the following modules: a candidate selector module 290, and a step suggestions module 292. The system may optionally include additional modules such as the sequence parser module 122 and/or a monitoring agent, such as the monitoring agent 102 (which is illustrated in FIG. 23).

The candidate selector module 290 is configured, in some embodiments, to receive a sequence 288 of steps involved in an interaction with an instance of a software system. The sequence 288 corresponds to a first execution of a BP, which is associated with a first organization. Optionally, the sequence 288 is associated with information identifying to which BP it corresponds (e.g., a user selects to run a BP from a menu and the instance of the software system generates an indication of the BP that was selected). Additionally or alternatively, the BP to which the sequence 288 corresponds may be identified utilizing the BP-Identifier module 126, as discussed below. Optionally, a step belonging to the sequence 288 describes one or more of the following aspects of the interaction: a certain transaction that is executed, a certain program that is executed, a certain screen that is displayed during the interaction, a certain form that is accessed during the interaction, a certain field that is accessed during the interaction, a certain value entered in a field belonging to a form, a certain operation performed from within a form, and a certain message returned by a software system during the interaction or following the interaction. Additional information regarding steps and generation of streams of steps may be found in this disclosure at least in Section 3—Streams and Steps.

Herein, an execution of a BP is considered to be associated with an organization if at least one of the following statements is true: (i) at least some of the steps involved in the execution of the BP are performed by a user belonging to the organization, and (ii) at least some of the steps involved in the execution of the BP are performed on a certain instance of a software system belonging to the organization. Additional information regarding organizations is provided in this disclosure at least in Section 1—Software Systems and Organizations. That section also includes a discussion about the various types of software systems that may be interacted with in embodiments described in this disclosure.

The candidate selector module 290 is further configured, in one embodiment, to utilize a table 289 to evaluate two or more candidate next steps to be performed after the steps in the sequence 288. In one embodiment, the table 289 describes frequencies at which various next steps were performed following the steps in the sequence 288, when those steps were performed in previous executions of the BP. Optionally, the previous executions of the BP comprise second and third executions of the BP that are associated with second and third organizations, respectively. Optionally, the second and third organizations are different from the first organization (and from each other).

It is to be noted that the user of the term “table” is not intended to allude to a use of a certain type of data structure and/or implementation in embodiments described herein. Rather, the term “table” represents an implementation that has a behavior of a table, which can he used to list sequences of steps alone with candidate next steps that may be performed following the steps in the sequences (along with values indicative of frequencies at which the next steps were performed). In different embodiments, implementing the table 289 may be done using various data structures; some examples include flat files, relational databases, hash tables, tries, decision trees, and other data structures and/or computational constructs known in the art. Additionally, the use of the singular term “table” is not intended to mean that the table 289 includes a single data structure. In some embodiments, the table 289 may involve various computational systems and/or distributed storage.

There are various ways in which the two or more candidate next steps may be selected for evaluation, in embodiments described herein. In one embodiment, the two or more candidate next steps are selected from among next steps for the sequence 288 that are described in the table 289. For example, the table 289 may include entries describing sequences of steps in one or more BPs and steps that may be performed after the sequences. In this example, the candidate selector module 290 may evaluate the entries and select candidate next steps from among the ones described in the entries.

In another embodiment, the two or more candidate next steps are determined by aligning the sequence 288 with two or more patterns describing certain sequences of steps corresponding to executions of the BP. Optionally, the two or more patterns are selected from among the one or more patterns 189. In this embodiment, the candidate selector module 290 may select steps in the certain sequences that appear after portions of the certain sequences that are aligned with the sequence 288, as the two or more candidate next steps.

In still another embodiment, the candidate selector module 290 is configured to receive an indication 296 identifying at least some of the two or more candidate next steps. Optionally, the indication 296 is received from at least one of the following: a user who performed the steps in the sequence 288, the instance of the software system, and an external software system that does not have access to all information in the table 289.

It is to be noted that in some embodiments, a candidate next step from among the two or more candidate next steps may not be indicated in the table 289 as having been performed following the sequence 288 in at least some of the previous executions of the BP. Optionally, such a candidate next step is attributed a frequency that is lower than frequencies attributed to other candidate next steps, which are indicated in the table 289 as having been perforated following the sequence 288 in at least some of the previous executions of the BP.

The step suggestion module 292 is configured, in some embodiments, to suggest to perform a certain next step 294, from among the two or more candidate next steps, for which, based on the table 289, the frequency at which it was performed after the perforating the steps in the sequence 288 is not lower than any of the frequencies at which other candidate next steps, from among the two or more candidate next steps, were performed following the sequence 288 in the previous executions of the BP. Optionally, when suggesting to perform the certain next step 294, the step suggestion module 292 provides an indication of the frequencies associated with at least some of the two or more candidate next steps.

In one embodiment, the step suggestion module 292 is further configured to suggest to perform the certain next step 294 by providing a description of the certain next step to a user. Optionally, the description comprises at least one of the following: a text description, an audio description, an image, and video. Optionally, the description is provided via a user interface utilized by the user, such as a screen of a computer terminal and/or a display of an augmented reality system or a display of a virtual reality system.

In some embodiments, the system described above includes the BP-Identifier module 126, which is configured to utilize a model of the BP (e.g., the crowd-based model 118 illustrated in FIG. 26) to identify the BP to which the sequence 288 corresponds. Optionally, the model of the BP is generated. based on additional executions of the BP comprising at least fourth and fifth executions of the BP, which are associated with fourth and fifth organizations, respectively.

The identification of the BP to which the sequence 288 corresponds may be utilized in various ways. In one embodiment, an identification of the BP to which the sequence 288 corresponds is utilized by the candidate selector module 290 to select certain candidate steps from among candidate steps described in the table 289, which are known to have been previously performed after the steps in the sequence 288 when executing the BP to which the sequence 288 corresponds. In another embodiment, an identification of the BP to which the sequence 288 corresponds is utilized to select the two or more patterns from among the one or more patterns 189. Optionally, the two or more patterns are patterns of the BP (e.g., they were generated based on previous executions of the BP).

The sequence 288 is selected, in one embodiment, from among the steps belonging to the stream 227. Optionally, the sequence 288 is selected utilizing the sequence parser module 122. Optionally, the stream 227 is generated by the monitoring agent 102, which is configured, in this embodiment, to monitor interactions with an instance of a software system belonging to the first organization and to generate the stream 227.

A monitoring agent, such as the agent 102, may be categorized, in some embodiments, as being an “internal monitoring agent” and/or an “interface monitoring agent”. Generally put, an internal monitoring agent is a monitoring agent that utilizes functionality of the software system with which an interaction occurs, while the interface monitoring agent, as it names suggests, relies more on data that is provided and/or received via a user interface. The following arc some examples of various monitoring agents that may be utilized. Additional discussion regarding monitoring agents and the data they examine/produce may he found in this disclosure at least in Section 2—Monitoring Activity.

FIG. 14 illustrates an embodiment of a system configured to generate the table 289. The system includes at least the following modules: the sequence parser module 122, the BP-Identifier module 126, and a tabulator module 298.

The sequence parser module 122 is configured, in one embodiment, to receive streams 120 of steps performed during interactions with instances of one or more software systems and to select, from among the streams 120, candidate sequences of steps. The BP-Identifier module 126 is configured, in one embodiment, to utilize one or more models of BPs (such as the crowd-based model 118) to identify, among the candidate sequences, sequences of steps that correspond to executions of at least some of the BPs. In this embodiment, the identified sequences comprise first and second sequences corresponding to executions of a BP, which are associated with first and second organizations, respectively. In another embodiment, the one or more models of the BPs are generated based on previous executions of the BPs. In this embodiment, the previous executions comprise at least first and second executions of a certain BP, which are associated with third and fourth organizations, respectively. Additional details regarding the sequence parser module 122 and the BP-Identifier module 126 may be found in the discussion related to embodiments illustrated in FIG. 26.

The tabulator module 298 is configured, in one embodiment, to determine, for at least some subsequences of the identified sequences, frequencies at which various next steps follow the subsequences in the identified sequences. Optionally, this information is organized in the table 289. Optionally, the tabulator module 298 is configured to provide the table 289 to a system that suggests next steps to perform, such as a system illustrated in FIG. 13.

In one embodiment, the frequencies of next steps, which are indicated in the table 289, depend on the BPs to which the subsequences correspond. In one example, the table 289 includes at least first and second entries in which a certain next step is a candidate to follow a certain subsequence of steps. When the certain subsequence is performed as part of a first BP, the certain next step has a first frequency indicated in the table 289. And when the certain subsequence is performed as part of a second BP, the certain next step has a second frequency indicated in the table 289, which is different from the first frequency.

In. one embodiment, at least some of the identified sequences used to generate the table 289 are sequences that include nonconsecutively performed steps. Optionally, a sequence includes nonconsecutively performed steps if: (i) the sequence includes steps from different streams (e.g., different streams describing interactions with instances of different software systems and/or interactions by different users), and/or (ii) the sequence includes first and second steps involved in an execution of a certain BP and the sequence also includes a third step, which is performed after the first step and before the second step, but the third step is not involved in the execution of the certain BP. In one example, the table 289 is indicative of a larger than zero frequency for a certain next step being nonconsecutively performed after a certain sequence of steps. In this example, the next step is performed on an instance of a different software system than an instance of a software system on which at least some of the steps belonging to the certain sequence were performed.

In some embodiments, the system illustrated in FIG. 14 may optionally include a plurality of monitoring agents (e.g., from among the monitoring agents 102a to 102d illustrated in FIG. 22), which are configured to generate the one or more streams 120 of steps from among which the identified sequences that are provided to the tabulator module 298 are selected (e.g., utilizing the sequence parser module 122). Optionally, each monitoring agent generates a stream comprising steps performed as part of an interaction with an instance of a software system from among the one or more software systems. Additional information regarding the monitoring agents and the generation of the streams may be found in this disclosure at least in the sections 2—Monitoring Activity and 3—Streams and Steps.

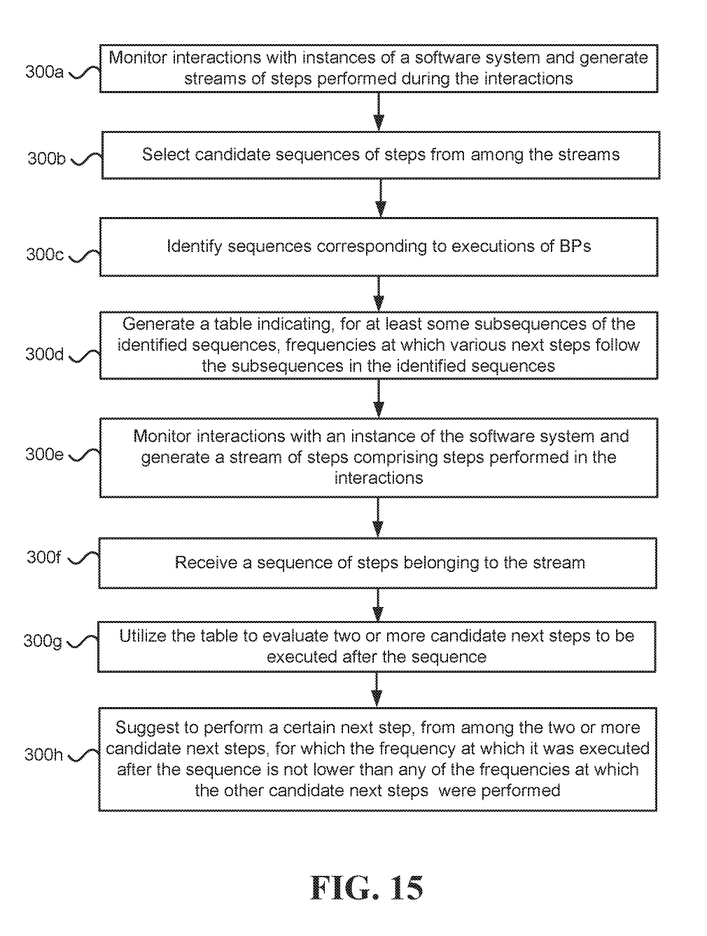

FIG. 15 illustrates steps that may be performed in one embodiment of a method for suggesting a frequently performed next step. The steps described below may be, in some embodiments, part of the steps performed by an embodiment of a system described above, which is illustrated in FIG. 13. In some embodiments, instructions for implementing the method described below may be stored on a computer-readable medium, which may optionally be a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for suggesting a frequently performed next step an execution of a BP) includes at least the following method steps:

In Step 300f, receiving a sequence of steps involved in an interaction with an instance of a software system. The sequence corresponds to a first execution of a BP, which is associated with a first organization.

In Step 300g, utilizing a table to evaluate two or more candidate next steps to be performed after the steps in the sequence received in Step 300f The table describes frequencies at which various next steps were performed following the sequence in previous executions of the BP. Optionally, the previous executions of the BP comprise second and third executions of the BP that are associated with second and third organizations, respectively. Optionally, the table is the table 289. Optionally, the table is generated by performing the steps 300a to 300d, which are described in further detail below.

And in Step 300h, suggesting to perform a certain next step from among the two or more candidate next steps. The certain next step is one for which the frequency at which it was performed after the sequence is not lower than any of the frequencies at which other candidate next steps, from among the two or more candidate next steps, were performed following the sequence in the previous executions of the BP.

In one embodiment, the method may optionally include Step 300e, which involves monitoring interactions of the user with the instance of the software system belonging to the first organization and generating a stream comprising steps performed as part of the interaction. The sequence received in Step 300f comprises one or more steps belonging to the stream. Optionally, monitoring the interactions is done utilizing a monitoring agent such as the monitoring agent 102 illustrated in FIG. 23.

In one embodiment, the method optionally includes a step involving utilizing a model of the BP to identify the BP to which the sequence received in Step 300f corresponds. Optionally, the model of the BP is generated based on additional executions of the BP comprising at least fourth and fifth executions of the BP, which are associated with fourth and fifth organizations, respectively. Optionally, the identification of the BP is done utilizing the BP-Identifier module 126.

There are various ways in which the table may be utilized in the Step 300g. In one embodiment, Step 300g involves selecting the two or more candidate next steps from among next steps for the sequence that are described in the table. In another embodiment, Step 300g involves selecting the two or more candidate next steps by aligning the sequence with two or more patterns describing certain sequences of steps corresponding to executions of the BP, and selecting steps in the certain sequences that appear after portions of the certain sequences that are aligned with the sequence. And in still another embodiment, Step 300g involves receiving an indication of at least some of the two or more candidate next steps from at least one of the following: a user who performed the sequence of steps, the instance of the software system, and an external software system that does not have access to all information in the table.

The following is a description of one embodiment of a method for generating a table of frequencies of steps, such as the table utilized in Step 300g described above.

In one embodiment, the method for generating the table includes at least the following steps:

In Step 300b, receiving streams of steps performed during interactions with instances of one or more software systems and selecting, from among the streams, candidate sequences of steps. Optionally, at least some of the identified sequences are sequences of nonconsecutively performed steps.

In Step 300c, utilizing one or more models of BPs to identify, among the candidate sequences, sequences of steps that correspond to executions of at least some of the BPs. The identified sequences comprise first and second sequences corresponding to executions of a BP, which are associated with first and second organizations, respectively. Optionally, identifying the sequences is done utilizing the BP-Identifier module 126.

And in Step 300d, generating a table indicating, for at least some subsequences of the identified. sequences, frequencies at which various next steps follow the subsequences in the identified sequences. Optionally, this step also involves providing the table indicative of the frequencies for use by a system that suggests next steps to perform (e.g., a system illustrated in FIG. 13).

In one embodiment, the method may optionally include Step 300a which involves monitoring the interactions with instances of one or more software systems and generating the streams of steps based on data collected during the monitoring.

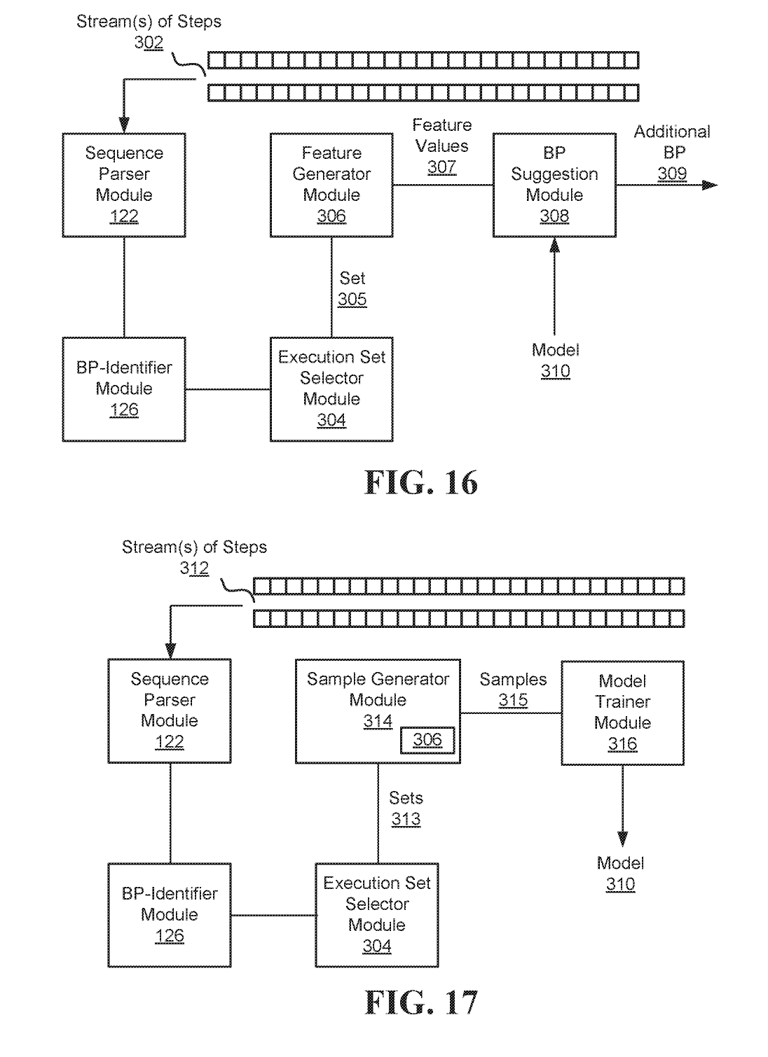

FIG. 16 illustrates one embodiment of a system configured to suggest a BP to execute after one or more BPs have been executed. The system includes at least the following modules: the sequence parser module 122, the BP-Identifier module 126, an execution set selector module 304, a feature value generator module 306, and BP suggestion module 308. The system may optionally include additional modules such as a monitoring agent, e.g., the monitoring agent 102 (which is illustrated in FIG. 23).

The sequence parser module 122 is configured, in one embodiment, to receive one or more streams 302 of steps and to select from among the one or more streams 302, candidate sequences of steps. The streams 302 include steps performed during interactions with instances of one or more software systems, which belong to a certain organization. Additional discussion regarding selecting sequences by the sequence parser module 122 is given in this disclosure at least in Section 4—Selecting Sequences from Streams. A discussion about the various types of software systems that may be interacted with in embodiments described in this disclosure, as well as what it means for a software system to “belong” to an organization, is provided in Section 1—Software Systems and Organizations. Additionally, that section also includes more details regarding what constitutes an “organization”.

The BP-Identifier module 126 is configured, in one embodiment, to utilize one or more models of BPs (each of which may be the crowd-based model 118) to identify, from among the candidate sequences selected by the sequence parser module 122, sequences of steps that correspond to executions of BPs. Additional details regarding identification of sequences corresponding to executions of BPs with the BP-Identifier module 126 may be found in the discussion regarding FIG. 26.

The execution set selector module 304 is configured, in one embodiment, to select a set 305 comprising executions of one or more of the BPs, which were identified by the BP-Identifier module 126. Optionally, the set 305 includes executions of BPs that occurred during a certain time frame (e.g., during a certain day and/or within the preceding hour, etc.) Optionally, the set 305 includes executions of BPs by a certain user and/or users belonging to a certain group such as users belonging to a certain department and/or user with a certain job description.

In one embodiment, the execution set selector module 304 is further configured to receive indications of which of the executions of the BPs to include in the set. For example, the indications may describe which types of BPs to include in the set 305 (if they were executed), executions of which users to include in the set 305, and/or which types of Execution-Dependent Attribute (EDAs) and/or what values of EDAs are to be utilized when selecting which executions to include in the set 305.

In one embodiment, the execution set selector module 304 is configured to select the set 305 based on values of a certain EDA. In this embodiment, the sequences corresponding to the executions of the one or more of the BPs in the set 305 each include a step that is associated with the same value of the certain EDA. Optionally, the certain EDA corresponds to one or more of the following types of values: a mailing address, a Universal Resource Locator (URL) address, an Internet Protocol (IP) address, a phone number, an email address, a social security number, a driving license number, an address on a certain blockchain, an identifier of a digital wallet, an identifier of a client, an identifier of an employee, an identifier of a patient, an identifier of an account, and an order number.

In some embodiments, selecting sets based on the certain EDA can enable creation of sets that are likely to belong to the same flow of BPs that are executed in order to handle a complex event. For example, hiring a new employee may involve execution of several BPs within a certain time frame (e.g., a week) that all involve an EDA that is the employee ID. In another example, producing a quarterly auditing report may involve an execution of multiple BPs that involve an FDA that identify a certain department and/or range of dates.

The set 305 may include different types of data, in different embodiments. In one embodiment, the set 305 includes data identifying types (e.g., names and/or codes) of BPs that were executed. Optionally, the set may include data identifying times and/or an order in which BPs were executed. Optionally, the set 305 may include additional data identifying who executed at least some of the executions in the set 305. Optionally, the set 305 may include additional information about the executions such as values of EDAs and/or sequences of steps corresponding to the executions.

The feature value generator module 306 is configured, in one embodiment, to generate feature values 307 based on the executions of one or more BPs belonging to the set 305. Optionally, the feature values 307 may be represented as a vector of numerical and/or categorial values.

In one embodiment, the feature values 307 comprise one or more of the following feature values: (i) a feature value indicative of an execution of at least one of the one or more BPs (whose executions are in the set 305), (ii) a feature value indicative of an order of execution of two BPs, from among the executions of the one or more BPs (whose executions belong in the set 305), (iii) a feature value indicative of a time that has elapsed since an execution of a certain BP from among the executions of the one or more BPs, and (iv) a feature value indicative of a lack of an execution of at least one BP that is not among the one or more BPs whose executions belong to the set.

In another embodiment, the feature values 307 comprise one or more of the following feature values: (i) a feature value indicative of execution of a certain transaction as part of the executions of one or more BPs belonging to the set 305, (ii) a feature value indicative of running of a certain program as part of the executions of one or more BPs, (iii) a feature value indicative of performing of a certain operation as part of the executions of one or more BPs belonging to the set 305, and (iv) a feature value indicative of entering a value in a certain field of a certain screen as part of the executions of one or more BPs belonging to the set 305.

In yet another embodiment, at least some of the feature values 307 are generated based on context information that is indicative of one or more of the following values: (i) a role of a user who executed an execution belonging to the set 305; (ii) a field of operations of the certain organization; and (iii) a value related to at least one of the following: a time of day during which at least some of the executions in the set 305 occurred, and a date during which at least some of the executions in the set 305 occurred. In one example, the role of the user may be a value indicative of the user's job title development engineer, tester, HR, etc.), department, and/or type of activity the user is performing at the time (e.g., procurement, customer relations, budget reports, etc.) In one example, the field of operations of the certain organization refers to the type of sector to which the certain organization belongs (e.g., banking, insurance, advertising, chemical industries, auto industries, etc.)

The BP suggestion module 308 is configured, in one embodiment, to utilize a model 310 to suggest, based on the feature values 307, an additional BP 309 to perform after the executions of the one or more BPs, which belong to the set 305. Optionally, the model 310 is a model generated using a machine learning-based training algorithm. For example, the model 310 may comprise parameters of a support vector machine, a neural network, a decision tree, a regression model, and or parameters of other machine learning-based models known in the art. Optionally, the BP suggestion module 308 is, and/or utilizes, a predictor that selects, based on a calculation involving the model 310 and the feature values 307, the additional BP 309. For example, based on the calculation, the additional BP 309 is a BP, from among a plurality of BPs, which is most likely to he performed following the executions belonging to the set 305. Additional details regarding the model 310 are given below in the discussion regarding FIG. 17.

In one embodiment, suggesting the additional BP 309 involves sending a message to a user (e.g., a popup window on a terminal) indicating that the additional BP 309 should be executed. In another embodiment, suggesting the additional BP 309 involves initiating execution of the additional BP 309 (e.g., by executing a transaction involved in the additional BP 309). Optionally, suggesting the additional BP 309 involves automatically filling in values observed in the executions belonging to the set 305 into fields in screens involved in the execution of the additional BP 309 (e.g., values of certain EDAs observed in executions in the set 305).

There may be various relationships between the set 305 and the additional BP 309. In one example, the set 305 comprises executions of one or more BPs by a certain user, and the additional BP 309 is suggested to the same certain user to perform. In another example, the set 305 comprises executions of one or more BPs by a first user, and the additional BP 309 is suggested to a second user to perform (who is different from the first user). In still another example, the set 305 comprises executions of one or more BPs associated with a first organization, and the additional BP 309 is suggested to a user from a second organization (which is different from the first organization).

In some embodiments, the streams 302 may be generated by one or more monitoring agents. Optionally, each monitoring agent generates a stream comprising steps performed as part of an interaction with an instance of a software system from among one or more software systems.

A monitoring agent may be categorized, in some embodiments, as being an “internal monitoring agent” and/or an “interface monitoring agent”. Generally put, an internal monitoring agent is a monitoring agent that utilizes functionality of the software system with which an interaction occurs, while the interface monitoring agent, as it names suggests, relies more on data that is provided and/or received via a user interface. The following are some examples of various monitoring agents that may he utilized. Additional discussion regarding monitoring agents and the data they examine/produce may be found in this disclosure at least in Section 2—Monitoring Activity.

In some embodiments, a step belonging to a stream from among the streams 302 describes one or more of the following aspects of the interaction: a certain transaction that is executed, a certain program that is executed, a certain screen that is displayed during the interaction, a certain form that is accessed during the interaction, a certain field that is accessed during the interaction, a certain value entered in a field belonging to a form, a certain operation performed from within a form, and a certain message returned by a software system during the interaction or following the interaction. Additional information regarding steps and generation of streams of steps may be found in this disclosure at least in Section 3—Streams and Steps.

FIG. 17 illustrates an embodiment of a system configured to generate the model 310. The system includes at least the following modules: the sequence parser module 122, the BP-Identifier module 126, the execution set selector module 304, a sample generator module 314, and a model trainer module 316.

In one embodiment, the sequence parser module 122 is configured to receive one or more streams 312 of steps and to select from among the one or more streams 312, candidate sequences of steps. Optionally, the streams 312 include steps performed during interactions with instances of one or more software systems, which belong different organizations. The BP-Identifier module 126 is configured, in this embodiment, to utilize one or more models of BPs (for example, each of the models may be the crowd-based model 118) to identify, from among the candidate sequences selected by the sequence parser module 122, sequences of steps that correspond to executions of BPs, which may be referred to herein as “previously observed” executions. In one embodiment, the streams 312 are generated utilizing a plurality of monitoring agents. Optionally, each monitoring agent generates a stream comprising steps performed as part of an interaction with an instance of a software system from among the one or more software systems.

The execution set selector module 304 is configured, in one embodiment, to select sets 313 from among the previously observed executions. Each set, from among the sets 313, comprises executions of one or more of the BPs that precede an execution of an additional BP. Optionally, the sets 313 comprise a first set comprising executions at least some of the BPs which are associated with a first organization and a second set comprising executions at least some of the BPs which are associated with a second organization, which is different from the first organization. Herein, an execution of a BP is associated with an organization if at least one of the following statements is true: (i) at least some steps involved in the execution of the BP are performed by a user belonging to the organization, and (ii) at least some steps involved in the execution of the BP are performed on a certain instance of a software system belonging to the organization. Optionally, the first and second organizations are different from the certain organization, with which the executions in the set 305 are associated.

There are various possibilities for compositions of the sets 313. In one example, the sets 313 comprise at least one set in which the executions of one or more BPs and the execution of the additional BP of the set are performed by the same user. In another example, the sets 313 comprise at least one set in which the executions of one or more BPs comprise executions performed by a first user and the execution of the additional BP is performed by a second user. In still another example, the sets 313 comprise at least one set in which the executions of one or more BPs comprise executions associated with a first organization and the execution of the additional BP is associated with a second organization, which is different from the first organization.

The sample generator module 314 is configured, in one embodiment, to generate samples 315 corresponding to the sets 313. Each sample corresponding to a set comprises a label indicative of the additional BP of the set and feature values determined based on the executions of one or more BPs that precede the execution of the additional BP of the set. Optionally, the feature values are generated utilizing the feature value generator module 306 (as described above with reference to the feature values 307).

The samples 315 are provided to the model trainer module 316, which in one embodiment, is configured to generate the model 310 based on the samples 315. Optionally, the model trainer module 316 provides the model 310 to be utilized by BP suggestion module 308. Optionally, the model 310 is generated with the samples 315 using a machine learning-based training algorithm. For example, the model 310 may comprise parameters of a support vector machine, a neural network, a decision tree, a regression model, and or parameters of other machine learning-based models known in the an. Thus, given the model 310 and feature values that correspond to a set of executions that may not be included in the sets 313 (e.g., the feature values 307 generated based on the set 305), a predictor may calculate a value using the model 310 and the feature values, which is indicative of: whether a certain BP is likely to be executed following the executions in the set, and/or which BP, from among a plurality of BPs, is likely to be executed following the executions in the set. In one example, this calculation involves using the feature values to traverse along a path in a decision tree in which suggested BPs are at the leaves. In another example, this calculation involves assigning the feature values to a class from among a plurality of classes, which each class corresponding to a certain BP from among a plurality of BPs.

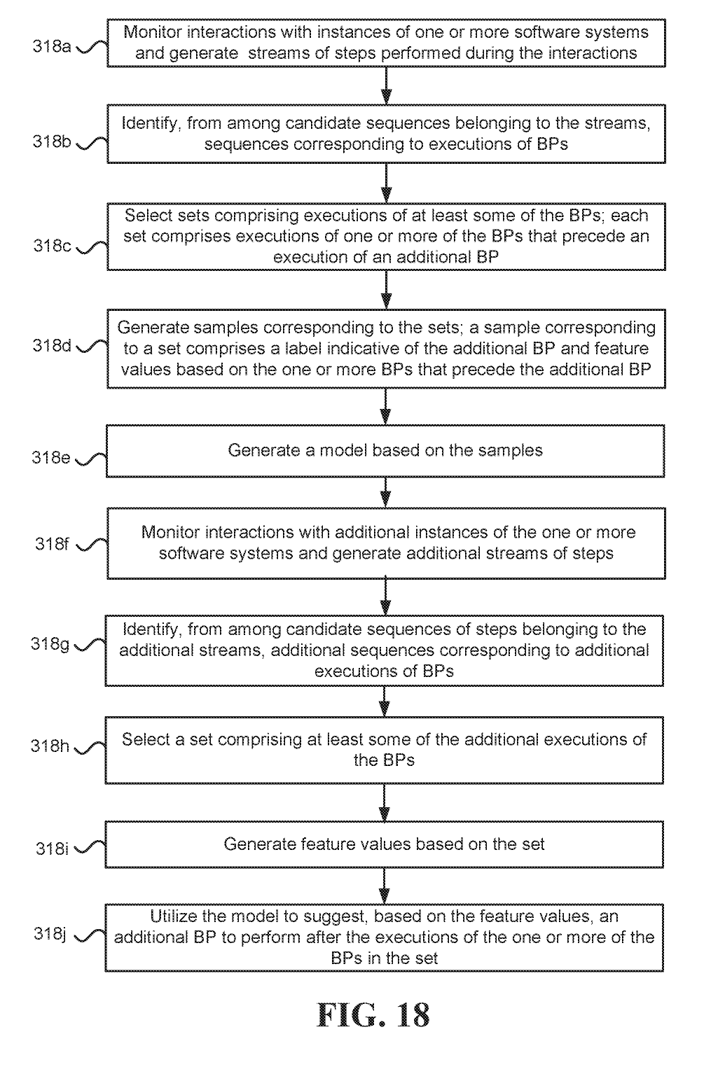

FIG. 18 illustrates steps that may be performed in one embodiment of a method for suggesting a BP to execute after one or more BPs have been executed. The steps described below may be, in some embodiments, part of the steps performed by an embodiment of a system described above, which is illustrated in FIG. 16. In some embodiments, instructions for implementing the method described below may be stored on a computer-readable medium, which may optionally be a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least sonic of the steps may be performed utilizing different systems comprising a processor and memory. Optionally, at least some of the steps may be performed using the same system comprising a processor and memory.

In one embodiment, a method for suggesting a BP to execute after one or more BPs have been executed includes at least the following steps:

In Step 318g, identifying one or more sequences that correspond to executions of one or more of the BPs. Optionally, this step involves receiving one or more streams of steps performed during interactions with one or more instances of one or more software systems, and selecting, from among the one or more streams, candidate sequences of steps. Optionally, the one or more sequences are identified from among the candidate sequences utilizing one or more models of BPs.

In Step 318h, selecting a set comprising executions of one or more of the BPs, from among the executions corresponding to the sequences identified in Step 318g, The set comprises at least one execution associated with a first organization. Optionally, the set is selected utilizing the execution set selector module 304.

In Step 318i, generating feature values based on the executions of one or more BPs belonging to the set selected in Step 318h. Optionally, the feature values are generated by the feature value generator module 306.

In Step 318j, utilizing a certain model to suggest, based on the feature values generated in Step 318i, an additional BP to perform after the executions of the one or more of the BPs in the set selected in Step 318h. Optionally this step involves providing an indication of the additional BP to a user. Optionally, the certain model is generated based on previously observed examples of sets, each set comprising executions of one or more BPs that precede an execution of an additional BP. Optionally, at least some of the sets comprise executions associated with a second organization, which is different from the first organization. Optionally, the certain model is generated using steps from among Step 318a to Step 318e, which are described below.

In one embodiment, the method may optionally include Step 318f, which involves monitoring interactions of a user with the one or more instances of the one or more software systems and generating the one or more streams comprising steps performed as part of the interactions (which are received in Step 318g). Optionally, monitoring the interactions is done utilizing monitoring agents such as the monitoring agent 102 illustrated in FIG. 23.

In one embodiment, selecting the set in Step 318h involves receiving an indication of executions of which of the BPs to include in the set, and selecting executions of those BPs from among the executions corresponding to the sequences identified in Step 318g. In another embodiment, selecting the set in Step 318h is done based on values of a certain Execution-Dependent Attribute (EDA). Optionally, the sequences corresponding to the executions of the one or more of the BPs each include a step that is associated with the same value of the certain EDA. Optionally, the certain EDA corresponds to one or more of the following types of values: a mailing address, a Universal Resource Locator (URL) address, an Internet Protocol (IP) address, a phone number, an email address, a social security number, a driving license number, an address on a certain blockchain, an identifier of a digital wallet, an identifier of a client, an identifier of an employee, an identifier of a patient, an identifier of an account, and an order number.

Generating the feature values in Step 318i may involve generation of different types of values in different embodiments. In one embodiment, Step 318i involves generating, based on the executions of one or more BPs, one or more of the following feature values: (i) a feature value indicative of an execution of at least one of the one or more BPs, (ii) a feature value indicative of an order of execution of two BPs, from among the executions of the one or more BPs whose executions belong to the set, (iii) a feature value indicative of a time that has elapsed since an execution of a certain BP from among the executions of the one or more BPs and the execution of the additional BP, and (iv) a feature value indicative of a lack of an execution of at least one BP that is not among the one or more BPs whose executions belong to the set. In another embodiment, Step 318i involves generating, based on the executions of one or more BPs, one or more of the following feature values: (i) a feature value indicative of execution of a certain transaction as part of the executions of one or more BPs, (ii) a feature value indicative of running of a certain program as part of the executions of one or more BPs, (iii) a feature value indicative of performing of a certain operation as part of the executions of one or more BPs, and (iv) a feature value indicative of entering a value in a certain field of a certain screen as part of the executions of one or more BPs.

The following is a description of one embodiment of a method for generating a model used to suggest an additional BP to perform, such as the certain model utilized in Step 318j described above.

In one embodiment, a method for generating a model for suggesting a BP to execute includes at least the following steps:

In Step 318b, utilizing one or more models of BPs to identify sequences that corresponds to executions of the BPs. Optionally, the identification involves determining for the sequences to which BP each sequence corresponds (e.g., utilizing the BP-Identifier module 126). Optionally, this step involves receiving streams of steps performed during interactions with instances of one or more software systems and selecting (e.g., utilizing the sequence parser module 122), from among the streams, candidate sequences of steps from among which the sequences are identified.

In Step 318c, selecting sets comprising executions of at least some of the BPs. Each set comprises executions of one or more of the BPs that precede an execution of an additional BP. Optionally, the sets are selected by the execution set selector module 304. Optionally, selecting the sets comprises selecting a first set comprising executions of at least some of the BPs which are associated with a first organization and selecting a second set comprising executions of at least some of the BPs which are associated with a second organization, which is different from the first organization.

In Step 318d, generating samples corresponding to the sets. Each sample corresponding to a set comprises a label indicative of the additional BP of the set and feature values determined based on the executions of one or more BPs that precede the execution of the additional BP of the set. Optionally, the feature values are generated by the feature value generator module 306.

And in Step 318e, generating a model based on the samples (e.g., utilizing the model trainer module 316). Optionally, this step involves providing the model for use by a system that suggests a BP to execute based on previously executed of BPs (e.g., a system illustrated in FIG. 16).

In one embodiment, the method may optionally include Step 318a that involves monitoring the interactions with the instances of the one or more software systems and generating the streams of steps (which are received in Step 318b) based on data collected from the monitoring. Optionally, each stream comprises steps performed as part of an interaction of a user with an instance of a software system.

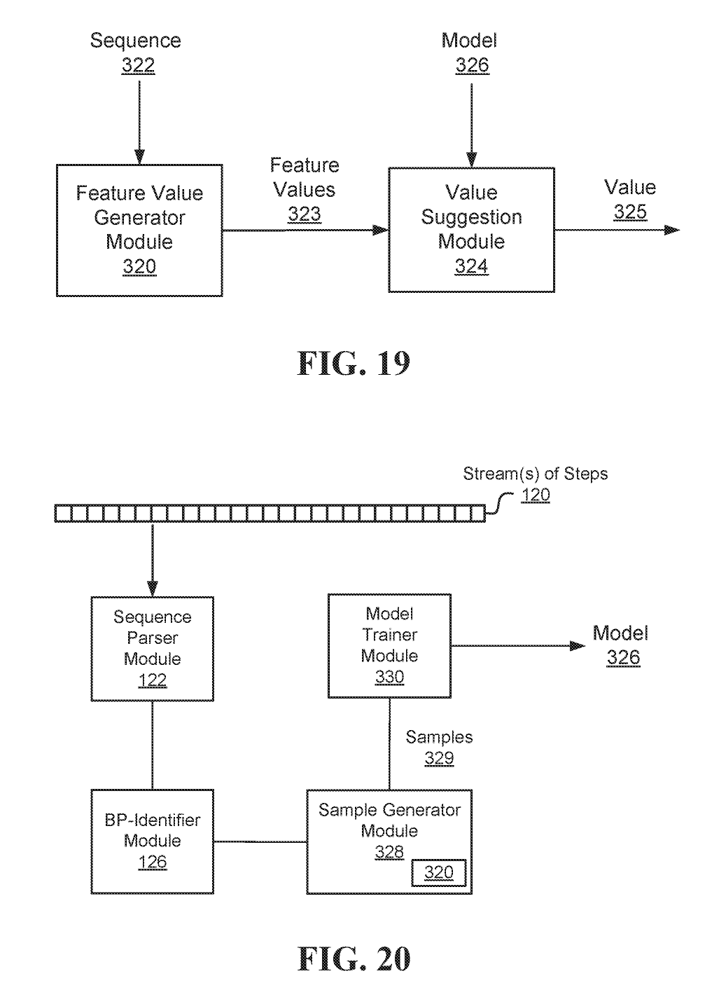

FIG. 19 illustrates one embodiment of a system configured to suggest a value for a certain field in an execution of a BP. The system includes at least the following modules: a feature value generator module 320, and a value suggestion module 324. The system may optionally include additional modules such as the sequence parser module 122, the BP-Identifier module 126, and/or a monitoring agent, e.g., the monitoring agent 102 (which is illustrated in FIG. 23).

The feature value generator module 320 is configured, in one embodiment, to receive a sequence 322 comprising one or more steps performed during an interaction with an instance of a software system as part of an execution of a BP. Optionally, the execution is associated with a first organization, and the one or more steps precede an additional step that involves setting a value of a certain field (e.g., in a screen accessed by a user executing the BP). Optionally, the one or more steps comprise at least two steps. A discussion about the various types of software systems that may be interacted with in embodiments described in this disclosure is provided in Section 1—Software Systems and Organizations. Additionally, that section also includes more details regarding what constitutes an “organization”.

The feature value generator module 320 is further configured to generate feature values 323 based on the one or more steps. Optionally, the feature values 323 generated based on the sequence 322 are not based on a value given to the certain field in a step belonging to the sequence 322 (i.e., the value has yet to be provided to the certain field during performance of the one or more steps belonging to the sequence 322). The feature values 323 may include various types of values, in different embodiments.

In one embodiment, the feature values 323 comprise a feature value determined based on a value entered in a field on a screen as part of performing a step from among the one or more steps that precede the additional step of the sequence 322.

In another embodiment, the feature values 323 comprise a feature value determined based on a value entered in a field on a screen as part of performing a step, in a previous execution of a BP. Optionally, a step in the previous execution and a step among the steps of the sequence 322 both include the same value for an EDA.

In yet another embodiment, the sequence 322 may include at least some steps that are performed by a user belonging to the first organization and the feature values 323 comprise a feature value determined based on contextual information corresponding to the sequence 322. In one example, the contextual information is indicative of one or more of the following things: (i) a role of the user the first organization; (ii) an area of business of the first organization; (iii) a configuration value in a configuration file used to configure the instance of the software system, (iv) a time of day during which at least some of the steps in the sequence were executed, and (v) a date during which at least some of the steps in the sequence were executed.

In still another embodiment, the feature values 323 comprise a feature value determined based on an activity history of a user (who performed steps belonging to the sequence 322) and/or an activity history of the first organization. In one example, the activity history of the user is indicative of at least one of the following: (i) the identity of at least some of the transactions executed by the user before the steps in the sequence 322 were performed; (ii) the identity of at least some of the BPs executed by the user before performing steps belonging to the sequence 322. In another example, the activity history of the first organization is indicative of at least one of the following: (i) the identity of at least some of the transactions, which were executed by users belonging to the first organization before the steps in the sequence 322 were performed; (ii) the identity of at least some of the BPs, which were executed by users belonging to first the organization before the steps in the sequence 322 were performed.

The value suggestion module 324 is configured, in one embodiment, to utilize a model 326 to suggest, based on the feature values 323, a value 325 for the certain field. Optionally, the value suggestion module 324 is configured to present the value 325 for the certain field on a user interface utilized by a user to execute the BP. For example, the value 325 may be presented on a display used by the user (e.g., a screen of a terminal or an augmented reality display). In one embodiment, the model 326 is generated based on sequences of steps performed during previous executions of the BP, and at least some of the sequences correspond to executions of the BP that are associated with a second organization. In one example, the model 326 describes a decision tree for determining a value of the certain field based on at least some of the feature values 323. Additional details regarding the model 326 are provided further below in the discussion regarding FIG. 20.

In some embodiments, the system described above includes the BP-Identifier module 126, which is configured to utilize a model of the BP (e.g., the crowd-based model 118 illustrated in FIG. 26) to identify the BP to which the sequence 322 corresponds. Optionally, the model of the BP is generated based on additional executions of the BP comprising executions of the BP, which are associated with third and fourth organizations, respectively (which are different from the first organization). In one embodiment, an identification of the BP to which the sequence 322 corresponds is utilized by the feature value generator module 320 to generate a certain feature value from among the feature values 323. Optionally, the value of the certain feature value is indicative of the sequence 322 corresponding to an execution of the BP.

In one embodiment, the sequence 322 is selected from among the steps belonging to the stream 227. Optionally, the sequence 322 is selected from the stream 227 utilizing the sequence parser module 122. Optionally, the stream 227 is generated by the monitoring agent 102, which is configured, in one embodiment, to monitor interactions with an instance of a software system belonging to the first organization and to generate the stream 227. Additional discussion regarding selecting sequences by the sequence parser module 122 is given in this disclosure at least in Section 4—Selecting Sequences from Streams.

FIG. 20 illustrates an embodiment of a system configured to generate a model of values for a certain field in executions of a BP. The system includes at least the following modules: a sample generator module 328, and a model trainer module 330.

The sample generator module 328 is configured, in one embodiment, to receive sequences of steps corresponding to executions of a BP. Each of the sequences comprises one or more steps performed during interactions with instances of one or more software systems, which precede an additional step that involves setting a value of a certain field. The sample generator module 328 is further configured to generate samples 329 based on the sequences. Optionally, each sample generated based on a sequence comprises feature values determined based on the one or more steps of the sequence that precede the additional step, and a label indicative of the value given to the certain field in the additional step of the sequence. Optionally, the feature values are generated using the feature value generator module 320, as described above.

The model trainer module 330 is configured, in one embodiment, to generate the model 326 based on the samples 329 and to provide the model 326 for use by a system that suggests a value for the certain field a system illustrated in FIG. 19). Optionally, the model 326 is generated with the samples 329 using a machine learning-based training algorithm. For example, the model 326 may comprise parameters of a support vector machine, a neural network, a decision tree, a regression model, and or parameters of other machine learning-based models known in the art. Thus, given the model 326 and feature values that a sequence of step that might not be included in the sequences used to train the model 326 (e.g., the feature values 323 generated based on the sequence 322), a predictor may calculate a value using the model 326 and the feature values, which is indicative of a value to assign to the certain filed. In one example, this calculation involves using the feature values to traverse along a path in a decision tree in which suggested values for the certain field are at the leaves. In another example, this calculation involves assigning the feature values to a class from among a plurality of classes, which each corresponding to a certain value from among a plurality of values that may be provided to the certain field. In yet another example, this calculation involves calculating a dot product between a vector of regression coefficients and a vector representing the feature values, with the value suggested for the certain field being generated based on the result of the calculation.

In one embodiment, the sequences used to generate the samples 329 comprise a first sequence of steps corresponding to an execution of the BP which is associated with the second organization and a second sequence of steps corresponding to an execution of the BP which is associated with a third organization, which is different from the second organization (and from the first organization mentioned above).

In one embodiment, the system illustrated in FIG. 20 may optionally include the sequence parser module 122, which is configured to receive streams of steps performed during interactions with instances of one or more software systems and to select, from among the streams, candidate sequences of steps. Optionally, the BP-Identifier module 126 is configured to utilize one or more models of BPs to identify, among the candidate sequences, sequences that correspond to executions of a certain BP. Optionally, an identification of the certain BP to which some of the sequences correspond is utilized by the feature value generator module 320 to generate a certain feature value from among the feature values of at least some of the samples 329. In one embodiment, the streams of steps are generated utilizing a plurality of monitoring agents. Optionally, each monitoring agent generates a stream comprising steps performed as part of an interaction with an instance software system from among the one or more software systems. Additional discussion regarding monitoring agents and the data they examine/produce may be found in this disclosure at least in Section 2—Monitoring Activity.

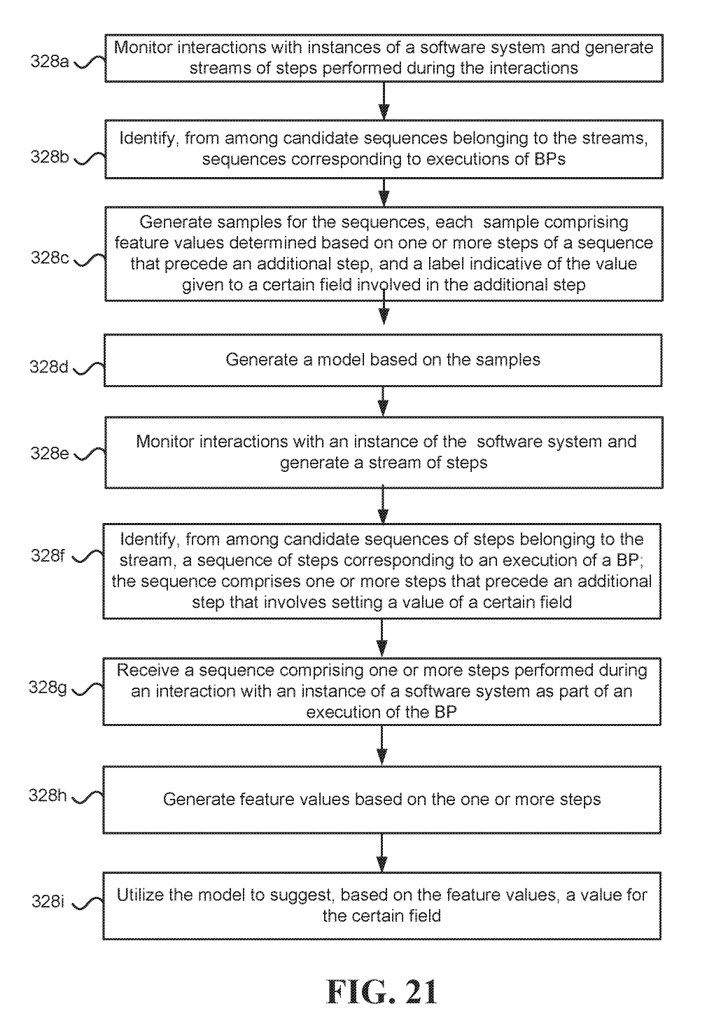

FIG. 21 illustrates steps that may be performed in one embodiment of a method for suggesting a value for a certain field in an execution of a BP. The steps described below may be, in some embodiments, part of the steps performed by an embodiment of a system described above, which is illustrated in FIG. 19. In some embodiments, instructions for implementing the method described below may be stored on a computer-readable medium, which may optionally be a non-transitory computer-readable medium. In response to execution by a system including a processor and memory, the instructions cause the system to perform operations that are part of the method. Optionally, embodiments of the method described below may be executed by a system comprising a processor and memory, such as the computer illustrated in FIG. 27. Optionally, at least some of the steps may be performed utilizing different systems comprising a processor and memory. Optionally, at least some of the steps may be performed using the same system comprising a processor and memory.

In one embodiment, a method for suggesting a value for a certain field in an execution of a BP includes at least the following steps:

In Step 328g, receiving a sequence comprising one or more steps performed during an interaction with an instance of a software system as part of an execution of the BP. Optionally, the execution is associated with a first organization, and the one or more steps precede an additional step that involves setting a value of a certain field.

In Step 328h, generating feature values based on the one or more steps of the sequence received in Step 328g. Optionally, the feature values are generated utilizing the feature value generator module 320. Optionally, this step involves generating a feature value based on a value entered in a field on a screen as part of performing a step from among the one or more steps that precede the additional step of the sequence.

And in Step 328i, utilizing a model to determine, based on the feature values, a value for the certain field. Optionally, the model is generated based on sequences of steps performed during previous executions of the BP. At least some of the sequences used to generate the model correspond to executions of the BP that are associated with a second organization. Optionally, this step also involves providing an indication of the value for the certain field. Optionally, the model is generated by performing steps from among the Steps 328a to 328d, which are described further below.

In one embodiment, the method optionally includes Step 328f, which involves: receiving a stream of steps performed during interactions with the instance of the software system, selecting candidate sequences of steps that comprise steps from the stream, and utilizing a model of the BP to identify, among the candidate sequences, the sequence that is received in Step 328g. Optionally, the method also includes Step 328e, which involves utilizing a monitoring agent to generate the stream of steps.

In one embodiment, the sequence received in Step 328g comprises at least some steps that are performed by a user belonging to the first organization. Optionally, in this embodiment, Step 328h involves generating a feature value based on contextual information corresponding to the sequence. Optionally, the contextual information is indicative of one or more of the following things: (i) a role of the user the first organization; (ii) an area of business of the first organization; (iii) a configuration value in a configuration file used to configure the instance of the software system, (iv) a time of day during which at least some of the steps in the sequence were executed, and (v) a date during which at least some of the steps in the sequence were executed.

The following is a description of one embodiment of a method for generating a model used for suggesting a value for a certain field in an execution of a BP, such as the model utilized in Step 328i described above.

In one embodiment, the method for generating the model includes at least the following steps:

In Step 328c, receiving sequences of steps corresponding to executions of the BP; each of the sequences comprises one or more steps performed during interactions with instances of one or more software systems, which precede an additional step that involves setting a value of a certain field. This step also involves generating samples for the sequences; each sample generated for a sequence comprises feature values determined based on the one or more steps of the sequence that precede the additional step, and a label indicative of the value given to the certain field in the additional step of the sequence. Optionally, the samples are generated utilizing the sample generator module 328.

And in Step 328d, generating the model based on the samples. Optionally, this step involves providing the model for use by a system that suggests a value for the certain field (e.g., a system illustrated in FIG. 19).

In one embodiment, the method may optionally include Step 328b, which involves: receiving streams of steps performed during interactions with the instances of one or more software systems, selecting, from among the streams, candidate sequences of steps, and utilizing a model of the BP to identify, among the candidate sequences, the sequences of steps corresponding to executions of the BP Optionally, the method includes Step 328a, which involves monitoring the interactions with the instances of the one or more software systems and generating the streams of steps based on data collected from the monitoring. Optionally, each stream comprises steps performed as part of an interaction of a user with an instance of a software system.

In one embodiment, the sequences received in Step 328c include a first sequence of steps corresponding to an execution of the BP, which is associated with a second organization, and a second sequence of steps corresponding to an execution of the BP, which is associated with a third organization, which is different from the second organization. Optionally, the second and third organizations are both different from the first organization mentioned above in Step 328g.

1—Software Systems and Organizations

A “software system”, as used in this disclosure, may refer to one or more of various types of prepackaged business applications, such as enterprise resource planning (ERP), supply chain management (SCM), supplier relationship management (SRM), product lifecycle management (PLM), and customer relationship management (CRM), to name a few. These packaged applications may be supplied by a variety of vendors such as SAP, ORACLE, and IBM, to name a few. The aforementioned software systems may be also be referred to as “enterprise systems”. Enterprise systems are typically back-end systems that support an organization's back office. The “back office” is generally considered to be the technology, services, and/or human resources required to manage a company itself. In some embodiments, an enterprise system can process data related to manufacturing, supply chain management, financials, projects, human resources, etc. Optionally, the data may be maintained in a common database through which different business units can store and retrieve information. A software system may also be referred to as an “information system”.

Having an enterprise system can be advantageous for a number of reasons, including standardization, lower maintenance, providing a common interface for accessing data, greater and more efficient reporting capabilities, sales and marketing purposes, and so forth. In one example, an ERP system, which is a type of an enterprise system, integrates many (and sometimes even all) data and processes of an organization into a unified system. A typical ERP system may use multiple components, each involving one or more software modules and/or hardware element, to achieve the integration.

Additionally, as used herein, a “software system”, may refer to a computer system with which a user and/or a computer program (e.g., a software agent) may communicate in order to receive and/or provide information, and/or in order to provide and/or receive a service. In some embodiments, a software system may operate a website that is accessed via a network such as the Internet (e.g., the software system may comprise an email client, a website in which orders may be placed to a supplier, etc.) In some embodiments, a software system may be used to provide applications to users and/or computer programs via a Software as a Service (SaaS) approach in which applications are driveled over the Internet—as a service. Thus, in some embodiments, a software system that is utilized by an organization is not installed on hardware that belongs to the organization.

Essentially the same software system may be installed multiple times (e.g., for multiple organizations). Each installation of a software system may be considered herein an “instance” of the software system. For example, a software system, such as an operating system (e.g., Microsoft's Windows), may have many millions of instances installed worldwide. Similarly, various installations of packaged applications at different organizations may be considered different instances of a certain software system (e.g., a SAP ERP software system). It is to be noted that at times, herein, the term “instance” may be omitted without alluding to a different meaning. Thus, for example, a phrase such as “interacting with a software system” has the same meaning in this disclosure as the phrase “interacting with an instance of a software system”.

Running an instance of a software system may involve one or more hardware components (e.g., one or more servers and/or terminals). In some embodiments, these hardware components may be located at various geographical sites and/or utilize various communication networks (e.g., the Internet) in order to operate. In one example, servers are located at multiple sites and are accessed via a large number of terminals. Herein, a terminal may be realized utilizing various forms of hardware, such as personal computers and/or mobile computing platforms.

What is a considered an “instance of a software system” may vary between different embodiments described in this disclosure. Following are various criteria and/or architectural possibilities that may exemplify what may be considered, in various embodiments described herein, same or different instances of a software system.

In some embodiments, when a software system is run on different hardware at different locations (e.g., the software system is run on servers at different sites), then the processes running at the different locations are considered to belong to different instances of the software system. In one example, packages installed on hardware at one site belonging to an organization (e.g., installed on hardware located in a first country) may be considered a different instance of a certain software system than (the same) packages installed on hardware at another site belonging to the organization (e.g., installed on hardware located in a second country).

In some embodiments, the same hardware servers) and/or software may be used to run different instances of a certain software system. Optionally, interactions with the certain software system, which involve utilizing different accounts and/or different configuration files, may be considered interactions with different instances of the certain software system. Optionally, each instance may have different default settings and/or different selected behavioral options, which are suitable for a certain user, a certain department, and/or a certain organization.

In one example, a software system, which is a cloud-based service, provides services to users (e.g., a SaaS application). A first interaction of a user from a first organization (having a first account) with the software system may be considered to involve a different instance of the software system than an instance of the software system involved in a second interaction of a user from a second organization (having a second account). In this example, the interactions may be considered to involve different instances of the software system even if the users receive essentially the same service and/or even if both users interact with the same computer servers and/or with the same program processes.

While in some embodiments, different instances of a software system may exhibit the same behavior, in other embodiments, different instances of a software system may exhibit a different behavior. For example, different instances of the same software system belonging to different organizations may allow execution of different Business Processes (BPs), execution of different transactions, display different screens, etc. Adjusting an instance's behavior may be done in various ways in different embodiments. Optionally, an instance's behavior may be adjusted using custom code. Additionally or alternatively, an instance's behavior may be adjusted using configuration options.

In some embodiments, the behavior of a software system that includes a packaged application may be changed utilizing custom code. For example, various modules belonging to the packaged application may include “standard” code, such as code that is created and released by a vendor. In this example, the standard code may enable an instance of a software system to exhibit a typical (“Vanilla”) behavior. Custom code, in this example, may be code that is developed in order to exhibit certain atypical behavior, which may be more suited for a certain organization's goals or needs. In one embodiment, custom code is additional code that is added to a packaged application that is part of an instance of a software system belonging to an organization. For example, the additional code may be code describing additional BPS, transactions, functions, screens, and/or operations that are not part of a typical release of the packed application. In another embodiment, the custom code may replace portions of the standard. code that is used to implement a module of a packaged application. In this embodiment, the custom code can change the (standard) behavior of certain BPs, transactions, and/or operations, and/or alter the way certain screens may look (e.g., a screen layout and/or a selection of fields that appear on a screen).

In other embodiments, a software system, such as an ERP or another type of software system, may be designed and/or developed to include many options to choose that allow for various aspects of a software system to he adjusted. Having multiple behavior options that may be adjusted may be useful by providing an organization with the flexibility to personalize an instance of a software system to the organization's specific needs. In one example, such adjustments may be done as part of customization of a SAP ERP system. In another example, such adjustments may be done as part of the setup of an E-Business Suite of Oracle (EB-Suite/EBS).

Herein, any adjustments of the behavior of an instance of a software system that do not involve utilization of custom code may be considered adjustments of the software system's configuration. The term “configuration file” is used herein to denote data that may be used to configure an instance of a software system that may cause it to operate in a certain way. The data may comprise various menu options, entries in files, registry values, etc. Use of the term “configuration file” is not intended to imply that the data needs to reside in a single memory location and/or be stored in a single file, rather, that the data may be collected from various locations and/or storage media (and the collected data may possibly be stored in a file). Additionally, having a different configuration file does not imply that different instances may necessarily behave differently in similar interactions (e.g., when provided similar input by a user). A “configuration file” may also be referred to herein in short as simply a “configuration”.

In one embodiment, a configuration of an instance of a software system may include meta-data. tables that are used to store configuration data in SAP ERP software systems. In this embodiment, at least some portions of the meta-data tables may be used to define which transactions to execute as part of a BP, which screens to display in a certain transactions, and/or what fields to display on those screens. In another embodiment, during the setup stage of an Oracle EBS software system, various organization-specific parameters may be set. For example, the setup may be used to set parameters such as a tax rate applicable for a certain country and/or addresses to send invoices.

The disclosure includes various references involving phrases such as “an instance of a software system belonging to an organization” (and variations thereof). This phrase is intended to mean that the instance belongs to the organization and not necessarily that the software system belongs to the organization (though that may be the case in some embodiments). When an instance belongs to an organization, it means that interactions with the instance are done on behalf of the organization, e.g., in order to execute business processes for the organization. In some embodiments, using a phrase such as “an instance of a software system belonging to an organization” implies that the organization (and/or an entity operating on behalf of the organization) has a license and/or permission to utilize the software system. In other embodiments, the phrase implies that the instance is customized to operate with users belonging to the organization. In some embodiments, an instance of a software system belonging to an organization operates utilizing hardware that belongs to the organization (e.g., servers installed in a facility that is paid for by the organization) and/or it operates utilizing other computational resources paid for by the organization and/or which the organization is permitted to use (e.g., the organization pays for cloud-based computational resources utilized by the instance).

Various embodiments described herein involve interactions with instances of one or more software systems. In some embodiments, an interaction with an instance of a software system may involve a user performing certain operations that cause the instance of the software system to act in a certain way (e.g., run a program) and/or cause the instance to provide information (e.g., via a user interface). Additionally or alternatively, instead of (or in addition to) the user performing operations and/or receiving information, an interaction with the instance of the software system may involve a computer program (e.g., a software agent and/or an instance of another software system), which interacts with the instance of the software system in order to perform operations and/or receive information.

In some embodiments, interaction with an instance of a software system may include performing operations involved in execution of a Business Process (BP). Additionally or alternatively, an interaction with an instance of a software system may include performing operations involved in testing the software system. For example, interaction with an instance of a software system may involve running scripted tests by a human and/or a software program, and/or execution of various suites of tests (e.g., regression testing).

A Business Process (BP), which may also be referred to as a “business method”, is a set of related and possibly ordered, structured activities and/or tasks involving finning certain programs) that produce a specific service and/or product to serve a particular goal for one or more customers. Optionally, the set of activities may be ordered (e.g., represented as a sequence of activities) and/or partially ordered (e.g., allowing for at least some of the activities to be done in parallel or in an arbitrary order). Each of the one or more customers may be an internal customer, e.g., a person or entity belonging to an organization with which an execution of the BP is associated, or an external customer, e.g., an entity that does not belong to the organization.

Execution of a BP in this disclosure typically involves execution of one or more transactions. A “transaction”, as used herein, involves running one or more computer programs. In some embodiments, running a computer program produces one or more “screens” through which information may be entered and/or received. Each screen may include various components via which data may be entered (e.g., fields, tabs, tables, and checkboxes, to name a few). Additionally, various operations may be performed via screens, which may involve one or more of the following: sending information (e.g., sending data to a server), performing calculations, receiving information (e.g., receiving a response from the server), clicking buttons, pressing function keys, selecting options from a drop-down menu, to name a few. In one example, an operation may involve sending to a server information entered via a screen, and receiving a response from the server indicating an outcome of the operation (e.g., whether there was an error or whether the data entered was successfully processed by the software system).

In some embodiments, a transaction may be performed utilizing various forms of user interfaces. For example, a transaction may involve access and/or manipulation of data presented to a user via an augmented reality system, a virtual reality system, and/or a mixed-reality system. Thus, a “screen” as used in this disclosure may refer to any interface through which data may be presented and/or entered as part of executing a transaction. For example, a screen may be an area in a virtual space in which data is presented to a user. In another example, a screen may be a layer of data overlaid on a view of the real world (e.g., an augmented reality data layer). Thus, the use of a “screen” is not intended to limit the scope of the embodiments described herein to traditional systems in which data is viewed via a 2D computer monitor.

Herein, the term “organization” is used to describe any business, company, enterprise, governmental agency, and/or group comprising multiple members in pursuit of a common goal (e.g., a non-governmental organization). In sonic embodiments, different organizations are businesses, companies, and/or enterprises that have different ownership structures. For example, a first organization is different from a second organization if the first organization is owned by a different combination of shareholders than the second organization. In other embodiments, different organizations may be different companies that are characterized by one or more of the following attributes being different between the companies: the company name, the company's corporate address, the combination of stockholders, and the symbol representing each of the companies in a stock exchange. For example, different organizations may be represented by different symbols (tickers) in one or more of the following US stock exchanges: NYSE, AMEX, and NASDAQ. In still other embodiments, different organizations may have different members belonging to them. For example, a first organization that has a first set of members that belong to it is considered different from a second organization that has a second set of members that belong to it, if the first set does not belong to the second organization and the second set does not belong to the first organization. Optionally, the first and second organizations are considered different organizations of the first set includes at least one member that does not belong to the second set, and the second set includes at least one member that does not belong to the first set.

Herein, a user belonging to an organization is a person that is an employee of the organization and/or is a member of a group of people that belong to the organization. Optionally, a user belonging to an organization operates with permission of the organization and/or on behalf of the organization.

Each time a BP is run (executed) this may be considered an execution of the BP. Herein, an execution of a BP is associated with an organization if at least one of the following statements regarding the execution are true: (i) the execution of the BP involves at least some steps that are performed by a user belonging to the organization (e.g., the at least some steps are performed by an employee of the organization), and (ii) the execution of the BP involves at least some steps that are performed on an instance of a software system belonging to the organization.

2—Monitoring Activity

Various embodiments described in this disclosure involve collecting and/or utilizing data obtained by monitoring activity involving interactions with instances of one or more software systems. In different embodiments, the data collected from monitoring may have various formats. Additionally, in different embodiments, the data may be obtained from various sources and/or may be collected utilizing various procedures.

In some embodiments, data obtained by monitoring may include at least one or more of the following types of data: data describing interactions with user interfaces, data provided by a user (e.g., as input in fields in screens), data provided by a software system (e.g., messages returned as a response to operations), data exchanged between a user interface and a server used to run an instance of a software system (e.g., network traffic between the two), logs generated by an operating system (e.g., on a client used by a user or a server used by an instance of a software system), and logs generated by the instance of the software system (e.g., “event logs” generated by the software system).

Typical numbers dozens of users, if not hundreds, thousands, or tens of thousands of users or more. In some embodiments, each user executes, on average, at least 5, at least 10, at least 25, or at least 100 daily transactions. Optionally, each transaction involves, on average, entering data in at least three screens and/or entering data in at least three fields (some transactions may involve entering data in to a larger number of fields such as dozens of fields or more). In one example, monitoring a user's daily interactions with one or more software systems involves generating data that includes at least one of the following volumes of data: 1 KB, 10 KB, 100 KB, 1 MB, and 1 GB.

Herein, modules that are used to collect data obtained by monitoring activity involving interactions with instances of software systems are generally referred to as “monitoring agents”. A monitoring agent is typically realized by a software component (e.g., running one or more programs), but may also optionally include, in some embodiments, a hardware component that is used to obtain at least some of the data. In one example, the hardware component may involve a device that intercepts and/or analyzes network traffic. It is to be noted that realizing a monitoring agent may be done utilizing a processor, which may optionally be one of the processors utilized for interaction of with the instance of the software system. For example, the processor may belong to at least one of the following machines: a client that provides a user with a user interface via which the user interacts with the instance of the software system, and a server on which the instance of the software system runs.

A monitoring agent may collect, process, and/or store data describing interactions with an instance of a software system. Optionally, the data is represented as a stream of steps. Optionally, a step describes an action performed as part of an interaction with the instance of the software system. For example, a step may describe an execution of a transaction and/or performing of a certain operation. Optionally, a step may describe information received from the instance (e.g., a status message following an operation performed by a user). In some embodiments, a step may describe various aspects of the interaction with a software system. For example, a step may describe a record from a log, a packet sent via a network, and/or a snapshot of a system resource such as a database. Thus, in some embodiments, a “step” may be considered similar to an “event” as the term is used in the literature, but a “step” is not necessarily extracted from an event log; it may come from the various sources data that may be monitored, as described in this disclosure. In some embodiments, due to the large volume of “raw” monitoring data that may be obtained (e.g., extensive logs generated by servers), abstracting the activity as a series (stream) of steps can ease the tasks of storage and/or analysis of the monitoring data.

In some embodiments, monitoring activity involving the interactions with instances of software systems does not interfere and/or alter the interactions. For example, the fact that a monitoring agent operates does not alter input provided by a user and/or responses generated by an instance of the software system with which the user interacts at the time. In another example, disabling the monitoring does not interfere with the activity (e.g., it does not impede executions of BPs). Additionally, in some embodiments, a user may not be provided an indication of when and/or if a monitoring agent is monitoring activity that involves interactions of the user with an instance of a software system.

A monitoring agent may be categorized, in some embodiments, as being an “internal monitoring agent” and/or an “interface monitoring agent”. Generally put, an internal monitoring agent is a monitoring agent that utilizes functionality of the software system with which an interaction occurs, while the interface monitoring agent, as it names suggests, relies more on data that is provided and/or received via a user interface. Thus, in some embodiments, an internal monitoring agent may be considered to involve the “back-end”, while the interface monitoring agent is more concentrated on the “front-end”. It is to be noted that in some embodiments, a monitoring agent may be considered to be both an internal monitoring agent and an interface monitoring agent. For example, a monitoring agent may have some capabilities and/or characteristics typically associated with an internal monitoring agent and some capabilities and/or characteristics typically associated with an interface monitoring agent.

When a monitoring agent collects data describing interactions with an instance of a software system, the interaction may involve a user interacting with the instance. In some embodiments, a server provides, as part of the interaction, information to the user via a user interface (UI) that runs on a client machine that is not the server. Optionally, in sonic of these embodiments, an internal monitoring agent is realized, at least in part, via a program executing on a processor belonging to the server, and an interface monitoring agent may be realized, at least in part, via a program executing on the client. Optionally, operating the internal monitoring agent does not involve running a process on the client machine in order to collect data describing the interaction. Optionally, operating the interface monitoring agent does not involve running a process on the server in order to collect data describing the interaction.

In some embodiments, an internal monitoring agent monitoring interactions with an instance of a software system may be configured to utilize an Application Program Interface (API) of the software system. Issuing instructions via the API may cause the instance of the software system to execute a certain procedure that provides the internal monitoring agent with data indicative of at least some steps performed as part of the interactions.

When used to monitor an instance of a software system that includes one or more packaged applications, in sonic embodiments, an internal monitoring agent may be configured to perform at least one for the following operations: (i) initiate an execution, on the instance of the software system, of a function of a packaged application, (ii) retrieve, via a query sent to the instance of the software system, a record from a database, and (iii) access a log file created by the instance of the software system. Optionally, the database may be maintained by a packaged application. Optionally, the log file may be an event log created by a packaged application, and it may include a description of the state of the application and/or describe data provided to, and/or received from, the instance of the software system when running the packaged application. In one example, the event log may be in one of the following formats: XML, XES (eXtensible Event Stream) and MXML (Mining eXtensible Markup Language).

An internal monitoring agent may have access to information that is not presented to a user interacting with a software system (e.g., information received using an API or information from a log file, as described above). Thus, the internal monitoring agent may, in some embodiments, collect data related to a transaction performed by a user, and at least some of the data related to the transaction is not be presented to the user via a user interface (UI) utilized by the user to perform the transaction.

An interface monitoring agent may, in some embodiments, be configured to extract information from data presented on a user interface (UI) used by a user while interacting with an instance of a software system (e.g., while the user executes BPs). Optionally, the interface monitoring agent may be configured to perform image analysis (e.g., optical character recognition to images on a display), semantic analysis to text presented to the user, and/or speech recognition applied verbal output presented to the user. Additionally or alternatively, the interface monitoring agent may be configured to analyze input provided by a user via a user interface (UI). Optionally, the input may be provided using at least one of the following devices: a keyboard, a mouse, a gesture-based interface device, a gaze-based interface device, and a brainwave-based interface device. Additionally or alternatively, the interface monitoring agent may be configured to analyze network traffic exchanged during an interaction with an instance of a software system between a terminal used by a user and a server belonging to the instance.

FIG. 22 illustrates some of the different monitoring agents that may be utilized in sonic of the embodiments described in this disclosure. A user 101 utilizes a terminal 103 to interact with a server 105 running an instance of a software system. Optionally, interacting with the instance may involve communication such as network traffic 104. Interactions with the instance may be monitored by different types of monitoring agents. In one example, monitoring agent 102a is an interface monitoring agent that collects information by analyzing the terminal 103. For example, the monitoring agent 102a may perform image analysis of images presented to the user 101 on a screen of the terminal 103 and/or extract information from key strokes of the user 101 on a keyboard connected to the terminal 103. In another example, monitoring agent 102h is an interface monitoring agent that collects information by analyzing the network traffic 104 between the terminal 103 and the server 105. In vet another example, monitoring agent 102c is an internal monitoring agent that is configured to collect data by observing the operations of the instance of the software system and/or interacting with it (e.g., by making calls to an API of the software system in order to get certain information). And in still another example, monitoring agent 102d may be an internal monitoring agent that collects information from logs, such as event logs generated by the server 105.

In some embodiments, a monitoring agent (e.g., an internal monitoring agent or an interface monitoring agent) may have knowledge of the type of operations involved in performing certain BPs (e.g., it may derive information from models described below). In one example, such knowledge may be utilized by an internal monitoring agent to perform certain types of operations (e.g., certain calls to an API). In another example, an interface monitoring agent may process data it collects in a certain way based on the knowledge about which steps the certain BPs involve.

Interactions with instances of software systems often involve exchange of data that may be considered private and/or proprietary. For example, the data may include details regarding the organization's operations and/or information regarding entities with which the organization has various relationships (e.g., the entities may be employees, customers, etc.) Therefore, in some embodiments, various measures may be employed in the operation of monitoring agents in order to limit what data is collected in order to achieve certain privacy-related goals. In one embodiment, a monitoring agent may operate using inclusion lists (“whitelists”) specifying what data it can collect. For example, an inclusion list may specify which objects may be reported in the monitoring data (where examples of objects may include BPs, transactions, screens, fields, and/or operations). Additionally, the inclusion lists may specify what type of information may be reported for each of the objects mentioned above (e.g., what associated data may be reported). In another embodiment, a monitoring agent may operate using exclusion lists (“blacklists”) specifying what data it should not collect. For example, an exclusion list may specify which BPs, transactions, screens, fields, and/or operations should not be reported in monitoring data. Additionally, the exclusion lists may specify what type of information should not be reported for each of the objects mentioned above. For example, an exclusion list may specific that personal data such as names, addresses, email accounts, phone numbers, and bank accounts are not to be recorded by a monitoring agent.

3—Streams and Steps

Data collected by monitoring agents may, in some embodiments, be represented as one or more streams of steps. Optionally, each monitoring agent generates a stream of steps that describes at least some aspects of interaction(s) with an instance of a software system. Typically, in a stream of steps, a first step that appears before a second step in the stream represents a first aspect of the interaction that occurred before a second aspect represented by the second step. Optionally, each step represents one or more of the following aspects: a certain transaction executed in the step, a certain screen accessed as part of performing the step, a certain field that was updated as part of the step, a certain operation performed as part of the step, and a certain message received from the instance of the certain software system as part of the step. For example, steps can be generated by trapping of message exchanges (e.g., SOAP messages) and recording read and write actions.

Aspects of interactions with an instance of a software system may be represented in different embodiments as steps that contain different types of data. Optionally, steps may correspond to different resolutions at which the interactions may be considered. In one embodiment, a step may identify a transaction executed as part of the interactions. For example, each step in a stream may describe an identifier a code or name) of a transaction that is executed. In another embodiment, a step may identify a program executed as part of the interactions. Optionally, such a step may also include a description of how the program was invoked (e.g., a command line and/or a description arguments passed to the program) and/or an output representing a status of the termination of the program.

Often interacting with instances of software systems (e.g., enterprise systems) may involve entering and/or receiving data via screens that have fields, menus, tabs, etc. through which data may be provided to the software system and/or received from it. Data regarding screens and/or fields may also he represented in steps. In one embodiment, a step may include a description of a screen accessed by a user (e.g., as part of executing a transaction). For example, a step may include a screen name, URL, and/or other form of identifier for a screen. In another embodiment, a step may include a description of a field accessed on a screen (e.g., a name and/or number identifying the field and/or the screen on which the field is located). In still another embodiment, a step may include a description of a value entered to a field on a screen.

Interacting with instances of software systems may involve performing various operations. Some examples of operation include selecting a menu option, pushing a certain button, issuing a verbal command, issuing a command via a gesture, and issuing a command via thought (which may be detected by measuring brainwave activity). In some embodiments, a step may describe a certain operation performed as part of an interaction with a software system. Optionally, a step may include a description of a response by the instance of the software system to the operation (e.g., a response indicating success or failure of the operation).

In some embodiments, a step describing an aspect of an interaction with an instance of a software system may include a description of a message generated by the instance (e.g., as response to executing a certain transaction, performing an operation, etc.). Additionally, the step may include one or more other system-generated messages, such as status messages generated by an operating system and/or a network device.

A step belonging to a stream comprising steps performed as part of an interaction with an instance of a software system may be associated with one or more values that are related to the interaction. Optionally, storing the step and/or a stream to which the step belongs involves storage of the one or more values associated with the step. In one embodiment, a step may be associated with at least one of the following values: a time the step was performed a timestamp), an identifier of a user who performed the step, an identifier of the organization to which the user belongs, an identifier of the instance of the software system, and an identifier of the software system. It is to be noted that the timestamp may refer to various times in different embodiments, such as the time the step began and/or the time the step ended. In another embodiment, a step may be associated with an identifier (a BP ID) of the BP of whose execution the step is a part. Optionally, the BP ID may include a name, a code, and/or number, which identify the BP and/or variant of the BP. In one example, the identifier of the BP is provided by the system (e.g., a user may execute the BP by pushing a button or selecting it from a menu). In another example, a user may label certain steps, and/or steps performed during a certain time, as belonging to an execution of the BP.

It is to be noted that in some embodiments, the term “step” may be considered similar to the term “event” which is often used in the literature. In particular, a step that appears in a log file may be considered similar to an event in an “event log”. Additionally, execution of a BP may be considered similar to a “business process instance”, a “process instance”, or simply “case” as the terms are often used in the literature. Therefore, in some embodiments, steps may be associated with an identifier of the case (“case ID”) to which they belong (i.e., an identifier of the execution of which they are a part). In other embodiments, some steps may be unlabeled, which means there may be no indication of which case they belong to (i.e., they may have no associated case ID).

Interactions with modem software systems may, in many cases, involve generation and/or communication of very large quantities of data. This data may undergo various forms of processing and/or filtering in order to make its analysis more efficient, or even tractable. Those skilled in the art will recognize that various techniques may be utilized to convert “raw” monitoring data to streams of steps. This process is sometimes referred to in data science using the phrase “Extract, Transform, and Load” (ETL) is used to describe the process that involves: extracting data from outside sources, transforming it to fit operational needs (e.g., dealing with syntactical and semantical issues while ensuring predefined quality levels), and loading it into the target system, e.g., by providing it to other modules (e.g., as the streams of steps mentioned herein) and/or storing it, e.g., in a data warehouse or relational database. In one example, logs may be examined to identify executions of certain transactions and/or programs (which may then be represented as steps). In another example, machine learning-based algorithms may be generated and utilized to identify certain steps based on patterns in data obtained by monitoring (e.g., certain patterns in network traffic and/or in messages generated by a program run by a packaged application or an operating system); optionally, some steps may be indicative of the presence of such patterns.

In some embodiments, data collected by monitoring may be processed in order to remove data that may be considered private (e.g., proprietary data of an organization and/or clients). In one example, certain values in the data may be removed (e.g., social security numbers, bank account numbers, etc.) In another example, certain values in the data may be replaced by “dummy” values (e.g., fictitious records) and/or hash values of the data, which may assist in determining when two fields have the same certain value without the need to know what the certain value is.

In sonic embodiments, generating streams of steps may involve merging various sources of data (e.g., data from various monitoring agents). The different sources may have different levels of abstractions and/or use different formats. Merging such data may require changing the format and/or level of abstraction of data from some of the sources. The reference Raichelson, et al. “Merging Event Logs with Many to Many Relationships.” International Conference on Business Process Management, Springer International Publishing, 2014, describes some approaches that may be applies for merging monitoring data from multiple sources. Additionally, approaches for generating different levels of abstraction for data obtained from monitoring are discussed in Baler et al. “Bridging abstraction layers in process mining: Event to activity mapping.” Enterprise, Business-Process and Information Systems Modeling. Springer Berlin Heidelberg, 2013. 109-123. Approaches for bringing different sources to a common format are discussed in U.S. Pat. No. 6,347,374 filed Jun. 5, 1998, and titled “Event Detection”.

It is to be noted that the use of the term “stream” is not intended to imply a certain scope and/or medium of storage of steps derived from monitoring interactions with one or more instances of one or more software systems (each instance being of a certain software system from among the one or more software systems). Rather, the term stream may be interpreted as having steps accessible in a way that allows evaluation of aspects of the monitored interactions. Thus, in different embodiments, a stream of steps may represent different types of data and/or may be stored in different ways, as described in the following examples.

In one embodiment, a stream of steps may include steps derived from monitoring of interactions of a certain entity a user or a program) with an instance of a certain software system (e.g., an ERP).

In another embodiment, a stream of steps may include steps derived from monitoring of interactions of a certain entity (e.g., a user or a program) with multiple instances of software systems. For example, the stream may include steps performed on an instance of an ERP system and some other steps performed on a separate CRM system. Optionally, when a stream includes steps performed on various instances, at least sonic of the instances may belong to different organizations.

In yet another embodiment, a stream of steps may include steps derived from monitoring of interactions of various entities (e.g., users or programs) with instances of a software system. For example, the stream may include steps performed by various users in an organization with an instance of a certain software system (e.g., an SCM system). In another example, the stream may include steps performed by various users (possibly belonging to different organizations) with an instance of a software system via a certain website that is accessed by the various users.

And in still another embodiment, a stream of steps may include steps derived from monitoring of interactions of various entities (e.g., users or programs) with multiple instances of a software system. For example, the stream may include steps performed in an organization, which involves multiple users interacting with multiple instances of software systems. In another example, the steam may include cross-organizational interactions, which include steps performed by various users from various organizations on different instances of software systems.

In some embodiments, a stream of steps is stored in computer readable memory (e.g., on a hard-drive, flash memory, or RAM). Optionally, a stream is stored in a contiguous region of memory. However, use of the term “stream” herein is not meant to imply that the data comprised in a stream (steps) are stored in a single file or location. In some embodiments, a stream may be stored distributedly, in multiple files, databases, and/or storage sites (e.g., a stream may be stored in cloud storage or stored distributedly utilizing a blockchain).

In some embodiments, a stream of steps is not stored as a logical unit, but rather is generated on the fly when it is requested. For example, monitoring data may be stored in one or more databases, and a request for a stream is translated into a query that retrieves the required data from the one or more databases and presents it as a stream of steps. Optionally, the required data may be “raw” data obtained from monitoring, and a representation as steps is created by processing the data following the query.

In other embodiments, a stream of steps me be received and processed essentially as it is generated. For example, steps in the stream are analyzed within minutes of the occurrence of the events to which they correspond. Optionally, this enables at least some of the data generated from monitoring to be discarded without requiring its long-term storage.

A stream of steps may be stored, in some embodiments, in a way that enables it to be viewed at different resolutions. For example, when used for a certain application, such as identifying which BPs were run, the stream may be represented with less details (e.g., the stream may identify describe transactions were executed on an instance of a software system). However, when used for another application, such as when the stream is evaluated to discover a cause of an error and offer an alternative set of operations to perform, the stream may be viewed at a higher resolution and contain more details. Optionally, when viewed in such a higher resolution, the stream may contain more steps (with multiple “little” steps corresponding to a single “lower resolution” step, which may be a transaction).

Data. collected through monitoring of interactions with an instance of a software system may be stored in different streams, in some embodiments. This may be done to separate data collected at different times. For example, in one embodiment, steps performed during interactions with the instance of the software system during a certain day may be stored in one stream, while steps performed during interactions with the instance of the software system on another day are stored in another stream.

To efficiently store and/or analyze steps, in some embodiments, each step belonging to a stream is represented by a symbol belonging to a set of symbols. Typically, certain symbols may represent multiple steps in the stream (i.e., steps performed at different times), thus the number of symbols in the set of symbols is smaller than the number of steps in the stream. In one example, most of the symbols in the set of symbols are used to represent at least two different steps that appear in a stream of steps. Utilizing a symbol representation for steps may enable, in some embodiments, efficient searching of streams (e.g., to identify patterns) and/or efficient, less space consuming storage.

4—Selecting Sequences from Streams

Some of the embodiments described in this disclosure involve extracting (also referred to as “selecting” or “parsing”) sequences of steps from one or more streams. When steps in streams include an identifier indicative of what BP they belong to (e.g., a “BP ID”, and/or to which execution of a BP they belong to (e.g., “a case ID”), selecting sequences from the streams may be relatively straightforward and involve collection of steps that have a certain value for the identifier (e.g., steps corresponding to events with the same case ID). This typically happens with Process Aware Information Systems (PAIS) in which the system executes BPs according to known models. However, in some embodiments, steps in streams may not have such an identifier that enables a straightforward identification of the execution to which they correspond. For example, data collected by an interface monitoring agent may not be complete and may lack certain pieces of information that would be known to the user but not to a 3rd party observer who examines the user's screen. In another example, a user may be performing a certain set of operations that do not correspond to a known BP. In this example, the set of operations may correspond to a new BP or new variant of a known BP.

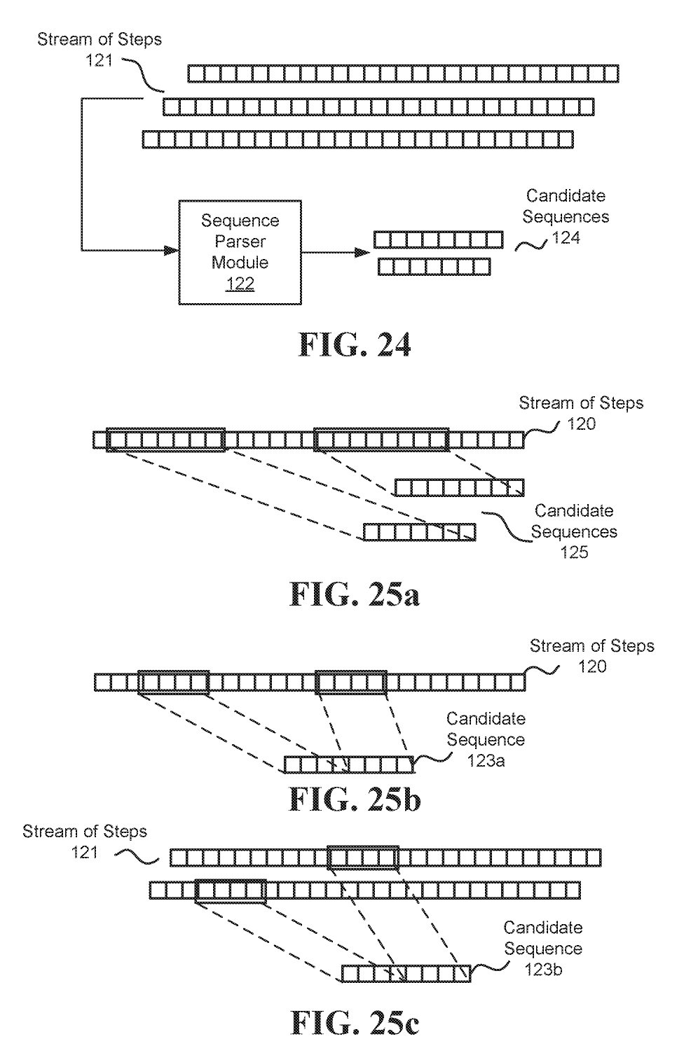

Given one or more streams of steps generated via monitoring (e.g., by a plurality of internal monitoring agents and/or interface monitoring agents), in some embodiments, sequences are selected from the one or more streams. Optionally, this is done utilizing a module referred to herein as a “sequence parser module”, which is configured to receive the streams of steps and to select, from among the streams, a plurality of sequences of steps. Selected sequences of steps may he forwarded for further analysis, such as using models of BPs to identify for each sequence whether there is a BP to which the sequence corresponds. FIG. 23 illustrates an example of how this selection may be performed in some embodiments. The user 101 interacts with the server 105 that runs an instance of a software system. Monitoring agent 102, which may be for example any of the monitoring agents 102a to 102d, generates one or more streams 120 that includes steps performed during an interaction of the user 101 with the instance of the software system. The one or more streams 120 are forwarded to sequence parser module 122 that selects, from among the steps belonging to the one or more streams, candidate sequences 124. It is to be noted that in some embodiments, the sequence parser module 122 may receive multiple streams of steps from among which the candidate sequences may be selected. This is illustrated in FIG. 24, where streams of steps 121 are provided to the sequence parser module 122, and from which the candidate sequence 124 are selected.

In some embodiments, candidate sequences selected by the sequence parser module 122, such as the candidate sequences 124, are forwarded and utilized by other modules. For example, the candidate sequences may be forwarded to the BP-Identifier module 126 (illustrated in FIG. 26) for the purpose of identifying to executions of which BPs the candidate sequences correspond. It is to be noted that a sequence of steps that is provided for identification of which BP it corresponds to (if any) may be referred to herein as a “candidate sequence”. This term is used purely for convenience in order to allude to a certain purpose of selected sequences; however, it is not merit to imply that identification of corresponding BPs is the only use for candidate sequences.

Depending on how the sequences are selected, the sequences of steps may have various properties. In particular, in some embodiments, at least some sequences of steps selected from one or more streams may be consecutive sequences of steps, which arc sequences in which all the steps are consecutive steps. Herein, consecutive steps are steps that are performed directly one after the other they are consecutively performed). In one example, if a sequence comprising consecutive steps includes first and second steps such that, in the sequence, the second step appears directly following the first step, then the first and second steps also appear that way in a certain stream from which they were taken. That is, in the certain stream, the second step comes directly after the first step, and there is no third step in between the two. FIG. 25a is a schematic illustration of selection of consecutively performed sequences of steps. The figure illustrates how sequences from among candidate sequences 125 appear as consecutive sequences of steps within a stream of steps from among the one or more streams 120.

In some embodiments, at least some sequences of steps selected from one or more streams may not be consecutive sequences of steps (also referred to as “nonconsecutive sequences of steps”). Such sequences include first and second steps, such that the second step appears in the sequence directly after the first step, but the first and second step are not consecutively performed.

In one embodiment, the first and second steps may belong to a certain stream, but in the certain stream, there is at least a third step, which is performed after the first step is performed, but before the second step is performed (and the third step does not belong to the sequence). Parsing this type of sequence is illustrated in FIG. 25b in which candidate sequence 123a appears to comprise to subsequences from a stream of steps from among the one or more streams 120, where between the two subsequences there are steps that do not belong to the candidate sequence 123a.

In another embodiment, the first step comes from a first stream and the second step comes from a second stream. This is illustrated in FIG. 25c in which candidate sequence 123b comprises two subsequences that conic from two different streams of steps from among the streams of steps 121. There may be various options when steps from different streams are combined into a sequence of steps. In one example, a sequence of steps, from among the selected sequences, comprises a first step performed on a first instance of a first software system from among a plurality of software systems, and a second step performed on a second instance of a second software system from among the plurality of software systems, which is different from the first software system. Optionally, the first and second steps involve executing different transactions. In another example, a sequence of steps, from among the selected sequences, comprises a first step performed by a first user and a second step performed by a second user, who is different from the first user. Optionally, the first and second steps involve executing different transactions. And in yet another example, a sequence of steps, from among the selected sequences, comprises: (i) a first step generated by a first monitoring agent that is used to monitor a first instance of a first software system from among the one or more software systems, and (ii) a second step generated by a second monitoring agent that is used to monitor a second instance of a second software system from among the one or more software systems. In this example, the first monitoring agent is an internal monitoring agent, the second monitoring agent is an interface monitoring agent, and the first software system is different from the second software system.

Since it may not be known to which BP or execution of a BP each step corresponds, it is possible that in some embodiments, a sequence of steps selected from one or more streams may include steps belonging to different executions of the same BP and/or steps belonging to different executions of different BPs. It is to be noted that in some embodiments, a sequence of steps may be considered to correspond to an execution of a certain BP even if the sequence includes some steps that are not involved in the execution of the certain BP (in this case the execution may be considered a nonconsecutive execution). Optionally, a sequence of steps may be considered to correspond to an execution of a certain BP if it includes most of the steps involved in an execution of the certain BP. Optionally, a sequence of steps may be considered to correspond to an execution of a certain BP if it includes all of the steps involved in an execution of the certain BP.

Selecting sequences of steps from among one or more streams of steps may be done utilizing various approaches, as described in the discussion below.

In some embodiments in which steps are associated with identifiers of the executions to which they belong (e.g., case IDs), the sequence parser module 122 may involve a straightforward implementation in which steps from one or more streams are aggregated and sequences are generated by grouping together steps having the same execution identifier and optionally ordering the steps in each sequence (e.g., according to time stamps associated with the steps). In other embodiments, selecting sequences by the sequence parser module 122 may be done in other ways, as described below.

In other embodiments, selecting sequences may be done based on values of an Execution-Dependent Attribute (EDA). For example, the sequence parser module 122 may be configured to identify a value of the EDA, and at least some of the steps comprised in each selected sequence are associated with the same value of the EDA. Optionally, for at least some executions of a BP, steps belonging to the different executions are associated with different values of the same EDA. Some examples of the types of values to which the FDA may correspond include the following types of values: a mailing address, a Universal Resource Locator (URL) address, an Internet Protocol (IP) address, a phone number, an email address, a social security number, a driving license number, an address on a certain blockchain, an identifier of a digital wallet, an identifier of a client, an identifier of an employee, an identifier of a patient, an identifier of an account, and an order number.

In yet other embodiments, the sequence parser module 122 is configured to utilize a model to select, from among the streams, a plurality of sequences of steps. The model is generated based on a plurality of sequences corresponding to executions of a plurality of BPs. Thus, by receiving examples of sequences of steps corresponding to executions of various BPs, the model may be trained to identify properties of sequences that represent a complete execution of a “generic” BP. Optionally, the plurality of sequences used to generate the model comprise at least a first sequence corresponding to an execution of a first BP, which was executed on an instance of a certain software system belonging to a first organization, and a second sequence corresponding to an execution of a second BP, which was executed on an instance of the certain software system belonging to a second organization.

In still other embodiment, the sequence parser module 122 is configured to utilize links between pairs of steps belonging to the streams, and to utilize the links to select the sequences. Optionally, for each pair of consecutive steps in a sequence at least one of the following is true: the pair is a pair of consecutive steps in a stream from among the streams, and the pair is linked by at least one of the links.

And in still other embodiments, the sequence parser module 122 is configured to identify occurrences of sequence seeds in the streams and to select the sequences by extending the sequence seeds. Optionally, a sequence seed comprises one or more consecutively performed steps from a certain stream. In one example, at least some of the sequence seeds are prefixes of sequences that may correspond to executions of one or more BPs. In this example, the sequence parser extends the seeds by adding additional steps, from the streams, to appear in the sequences after the prefixes. In another example, at least some of the sequence seeds are suffixes of sequences that correspond to executions of one or more BPs. In this example, the sequence parser extends the seeds by adding additional steps, from the streams, to appear in the sequences before the suffixes. In yet another example, at least some of the sequence seeds are prefixes of sequences that correspond to executions of one or more BPs and at least some of the sequence seeds are suffixes of sequences that correspond to executions of one or more BPs. In this example, the sequence parser module 122 may extend the seeds by adding, from the streams, additional steps to appear in the sequences between a prefix and a suffix.

5—Models of BPs

Much of an organization's activity may involve execution of various Business Processes (BPs) Each execution of a BP may involve a sequence of related, structured activities and/or tasks, which may be represented as a sequence of steps, which produce a specific service and/or product to serve a particular goal of the organization. A BP may be described by one or more models of the BP.

Herein, a model of a BP may be used, in some embodiments, for at least one of the following purposes: (i) the model may serve as a template according to which the BP may be run (executed), and (ii) the model may be used to identify an execution of the BP (e.g., identify an execution of the BP in a sequence of steps obtained from monitoring). It is to be noted that while a model of a BP that is utilized as a template for running the BP can typically also be utilized to identify an execution of the BP (since it recites steps to he performed when running the BP), the converse is not necessarily true; some models described herein may be used to identify an execution of a BP, but cannot be easily utilized as a template for executing the BP.

There are various ways in which a model of a BP may be generated in embodiments described herein. In some embodiments, a model of a BP may be manually generated, e.g., users and/or experts may describe one or more sequences of steps that may be involved in the execution of the BP (e.g., the may describe one or more patterns mentioned below). Various modeling tools are known in the art, which may be utilized to generate a model for the BP utilizing on or more of various forms of notation. In some examples, a model of a BP may be specified using Business Process Modeling Notation (BPMN), which is a standardized graphical notation for drawing business processes in a workflow. BPMN was developed by the Business Process Management Initiative (BPMI), and is intended to serve as common language to bridge the communication gap that frequently occurs between business process design and implementation. In another example, a BP model may be described using the Web Services Business Process Execution Language OASIS Standard WS-BPEL 2.0, WS-BPEL (or “BPEL” for short), which is a language for specifying business process behavior, e.g., based on web services. Processes in BPEL can export and import functionality by using web service interfaces. In still another example, a model of a BP may be described via extensible markup language (XML). And in yet another example, a model of a BP may be described via a graphical representation (graph) such as a Petri net or a depiction of a BPMN model.

In other embodiments, a model of a BP may be automatically generated from documentation (e.g., utilizing various tool for process mapping and/or process discovery). Optionally, automated tool may be utilized to convert the documentation and/or model specified using an industry-standard notation or language (e.g., BPMN, BPEL, or XML, mentioned above) into a sequence of steps describing a sequence of operations to be executed by a user and/or a computer.

In addition to the approaches described above, or instead of them, in some embodiments, a model of a certain BP may be generated based on monitoring data. Generating the model of the certain BP based on monitoring data involves utilizing sequences of steps corresponding to executions of the BP, which are obtained from the monitoring data. In some embodiments, additional sequences of steps, which do not represent executions of the certain BP, can also be utilized to generate the model of the certain BP. Optionally, these sequences may serve as negative examples required for some of the learning procedures utilized for generating the model of the certain BP. In one example, the additional sequences may be sequences of steps corresponding to executions of other BPs (which are not the certain BP). In another example, the additional sequences may be sequences of steps that are unidentified. And in still another example, the additional sequences may include randomly selected steps from streams, randomly generated steps, and/or shuffled sequences of steps. Thus, the additional sequences may include steps utilized in executions of other BPs and even possibly steps included in executions of the certain BP, but not in the correct order.

There are many approaches known in the art for generating models from monitoring data. These approaches typically are based on mining event logs generated from interactions with instances of software systems. In recent years, several vendors released dedicated process mining tools (e.g., Celonis. Disco, EDS, Fujitsu, Minit, myInvenio, Perceptive, PPM, QPR, Rialto, and SNP). A comprehensive overview of some of the approaches that may be utilized for this task are given in Chapter 7 in van der Aalst, Wil. Process Mining: Data Science in Action. Springer, 2016.

FIG. 26 illustrates one embodiment of a system configured to identify executions of a BP utilizing a crowd-based model of the BP. The system includes at least the following modules: the sequence parser module 122, the model trainer module 116, and BP-Identifier module 126. The embodiment illustrated in FIG. 26, as other systems described in this disclosure, may be realized utilizing a computer, such as the computer 400, which includes at least a memory 402 and a processor 401. The memory 402 stores code of computer executable modules, such as the modules described above, and the processor 401 executes the code of the computer executable modules stored in the memory 402.

The model trainer module 116 is configured, in one embodiment, to receive sequences 114 of steps selected from among streams of steps performed during interactions with instances of one or more software systems, with each sequence corresponding to an execution of the BP.

In one embodiment, the sequences 114 include sequences corresponding to executions of the BP, which are associated with a plurality of organizations. For example, the sequences include first and second sequences corresponding to executions of the BP, which are associated with first and second organizations, respectively. Herein, an execution of a BP is considered to be associated with an organization if at least one of the following statements is true: (i) at least some of the steps involved in the execution of the BP are performed by a user belonging to the organization, and (ii) at least some of the steps involved in the execution of the BP are performed on a certain instance of a software system belonging to the organization.

In some embodiments, a step belonging to a stream comprising steps performed as part of an interaction with an instance of a software system describes one or more of the following aspects of the interaction: a certain transaction that is executed, a certain program that is executed, a certain screen that is displayed during the interaction, a certain form that is accessed during the interaction, a certain field that is accessed during the interaction, a certain value entered in a field belonging to a form, a certain operation performed from within a form, and a certain message returned by the software system during the interaction or following the interaction.

The model trainer module 116 is further configured, in one embodiment, to generate crowd-based model 118 of the BP based on the sequences 114. Optionally, the crowd-based model 118 comprises a pattern describing a sequence of steps involved in the execution of the BP. Additionally or alternatively, the crowd-based model 118 may include a graphical representation (graph) such as a Petri net or a depiction of a Business Process Modeling Notation (BPMN) model. The sequences 114 may be provided, in some embodiments, by example collector module 127, which receives information that can help determine which portions of a stream include steps involved in an execution of the BP. Collection of sequences by the example selector collector 127 may also be referred to herein as “selection” of the sequences by the example collector module 127.

In some embodiments, the model trainer module 116 may be further configured to receive additional sequences of steps, which do not correspond to executions of the BP, and to generate the crowd-based model 118 based on the additional sequences. These additional sequences may be useful for generation of various types of models.

In one example, the model trainer module 116 may be further configured to generate, based on the sequences 114 and the additional sequences, an automaton configured to recognize an execution of the BP based on a sequence of steps. In this example, the crowd-based model 118 may include parameters that define the behavior of the automaton.

In another example, the model trainer module 116 may be further configured to utilize a machine learning training algorithm to generate the crowd-based model 118 of the BP based on the sequences 114 and the additional sequences. In this example, the crowd-based model 118 may include parameters used by a machine learning-based predictor configured to receive feature values determined based on a sequence of steps and to calculate a value indicative of a probability that the sequence of steps represents an execution of the BP. Optionally, the machine learning-based predictor may implement one or more of the following machine learning algorithms: decision trees, random forests, support vector machines, neural networks, logistic regression, and a naïve Bayes classifier.

Following is a more detailed discussion some of the various types of models that may be used for a model of a BP. These types of models include: (i) patterns of sequences. (ii) graphical representation, (iii) automata, and (iv) machine learning-based models. Following is an explanation of some of the features of the different types of models.

(I) Patterns. A model of a BP may include a pattern describing a sequence of steps involved in the execution of the BP. Optionally, the pattern is represented by a regular expression that corresponds to the plurality of sequences (i.e., there are a plurality of different sequences that match the regular expression). Optionally, each of the steps in the sequence describes one or more operations that are to be performed as part of an interaction with an instance of a certain software system. For example, at least some of the steps may identify a transaction and/or operation to perform.

In one embodiment, a model of a BP comprising a pattern corresponding to the BP is generated based on sequences selected from among streams of steps performed during interactions with instances of one or more software systems. Each of these sequences comprises steps, from one or more of the streams, which are involved in an execution of the BP.

There may be different criteria that characterize, in embodiments described herein, the relationship between a pattern of a BP and the sequences upon which is was based. In one embodiment, each step belonging to the sequence described by the pattern is included in at least 50% of the sequences upon which the patterns is based. In another embodiment, each step belonging to the sequence described by the pattern is included in all of the sequences upon which the patterns is based. In yet another embodiment, an average of a distance between the sequence of steps described by the pattern and each of the sequences upon which the patterns is based is below a threshold.

In one example, the distance is based on a similarity between pairs of steps. Optionally, similarity between a pair of steps is determined based on one or more of the following values: identifiers of transactions executed in each step of the pair, identifiers of screens presented in each step of the pair, identifiers of fields accessed in each steps of the pair, identifiers of operations performed in each step of the pair, values entered in a certain field in each step of the pair, and values associated with returned system messages in each step of the pair.

In another example, the distance is computed utilizing a machine learning-based algorithm that is generated based on data comprising examples of similar sequences and examples of dissimilar sequences.

A pattern describing a BP may be utilized to identify executions of the BP in data obtained by monitoring interactions with instances of one or more software systems. In some embodiments, one or more candidate sequences of steps selected from among one or more streams of steps may be compared to the pattern in order to determine which (if any) of the candidate sequences corresponds to an execution of the BP. In one embodiment, a candidate sequence is considered an execution of the BP if it matches a sequence of steps described by the pattern. In other embodiments, an imperfect match between a candidate sequence and a sequence described by the pattern may suffice to identify a candidate sequence as corresponding to an execution of the BP. For example, if a distance between a candidate sequence and a sequence described by the patterns is below a threshold, the candidate sequence is identified as corresponding to an execution of the BP. Optionally, calculating the distance is done utilizing an alignment function.

It is to be noted that as typically presumed herein, when sequences of steps are compared, e.g., in order to calculate a distance between a pattern and a candidate sequence, the comparison typically involves comparison of a primary attribute of each step (which is typically the same in all performances of the step) and does not involve comparison of associated data (which is often different in different performances of the step). For example, a first sequence of steps includes steps that each describe a transaction that is executed (so together they describe a series of transaction). If a second sequence includes a similar number of steps describing the same series of transactions (i.e., the same order), then the first sequence may be considered to be similar to the second sequence (possibly there may be a distance of zero between the two). In some embodiments, these two sequences may even be considered to include the same steps. This being despite the fact that the steps in the first sequence may have different associated data than the steps belonging to the second sequence. For example, the steps in the first sequence may have different timestamps than the steps in the second sequence, or a step in the first sequence may have a first value for a certain FDA (e.g., a certain customer number), while the equivalent step in the second sequence may have a second value for the EDA (e.g., a different customer number). However, for the purpose of comparison, e.g., for determining whether both sequences are similar and/or whether both sequences correspond to executions of the same BP, the answer may be positive, despite the difference in the two sequences steps' associated data.

(II) Graphical representation. A model of a BP may be described via a graphical representation (graph) such as a Petri net or a depiction of a BPMN model. For example, Petri nets have a strong theoretical basis and can capture concurrency well. Thus, for example, a Petri net may describe situations in which some steps may be performed concurrently, so when written as a single sequence, may have an arbitrary order. An extension of Petri nets that may be used in some embodiments are Colored Petri nets (CPNs), which are the most widely used Petri-net based formalism that can deal with data-related and time-related aspects. Graphical representations of a model often offer a succinct overview of a BP for a human observer, who can grasp from the model the various execution paths and/or activities that may be involved in an execution of the BP.

In some embodiments, such a model may describe one or more paths of execution that correspond to executions of the BP. Optionally, each of the one or more paths may correspond to an execution of the BP that involves a possibly different sequence of steps. Optionally, each of the one or more paths may correspond to an execution of a different variant of the BP.

(III) Automata. A model of a BP may include parameters of an automaton that is configured to accept sequences of steps corresponding to executions of the BP. In one example, the automaton may be configured to identify sequences in which all the steps are involved in an execution of the BP. In another embodiment, the automaton may be configured to identify sequences of steps that include the steps involved in an execution of the BP, and possibly other steps too (e.g., steps involved in execution of another BP). In one example, the parameters of the automaton may include parameters describing the following elements: a finite set of states (Q), a finite set of symbols (the alphabet of the automaton Σ), a transition function (δ: Q×Σ→Q), a start state (q0), and a set of accepting states (F). Optionally, the parameters of the automaton describe a Deterministic Finite Automaton (DFA). Optionally, the parameters of the automaton describe a Nondeterministic Finite Automaton (NFA).

In one embodiment, parameters describing an automaton that accepts sequences corresponding to executions of a BP are generated based on a positive set of sequences and a negative set of sequences. Optionally, the positive and negative sets of sequences of steps comprise sequences selected from among streams of steps performed during interactions with instances of one or more software systems; most of the sequences in the positive set comprise executions of the BP and most of the sequences in the negative set do not comprise executions of the BP. Optionally, a sequence comprises an execution of a BP if it comprises all of the steps involved in the execution of the BP. The reference Cook, Jonathan E., and. Alexander L. Wolf. “Discovering models of software processes from event-based data.” ACM Transactions on Software Engineering and Methodology (TOSEM) 7.3 (1998): 215-249, mentions some approaches for generating an automaton based on such positive and negative sets.

In one embodiment, a model of a BP comprising parameters of an automaton is utilized to identify executions of the BP. In one example, an execution of the automaton is simulated, when it is provided a candidate sequence as input. If the execution of the automaton reaches an accepting state, then the steps between the first step of the sequence and the step at which the accepting state is reached may be considered to include steps comprised in an execution of the BP. Depending on the implementation, the automaton may be fed individual candidate sequences or a stream of steps which may include many candidate sequences.

(IV) Machine Learning-based models. A model of a BP may include parameters of a machine learning-based model that may be utilized to identify executions of the BP. In these embodiments, a sequence of steps is converted to feature values (e.g., a vector of feature values) which represent properties of the sequence. Optionally, each feature represents a certain property of the sequence. In one example, the feature values representing a sequence of steps are indicative of one or more of the following: a certain transaction executed in one or more of the steps, a certain order of transactions executed in the steps, a certain screen presented in one or more of the steps, a certain order of screens presented in the steps, a certain field accessed in at least one of the steps, a certain order of accessing fields in one or more of the steps, a certain value entered in a field in at least one of the steps, a certain message received from a system as part of at least one of the steps. In another example, the feature values representing a sequence of steps are indicative of one or more of the following: the number of steps in the sequence, the duration it took to perform the steps in the sequence, an identity of a user who performed a step from among the steps, an identity of a system on which one of the steps was performed, an identity of an organization to which belongs a user who performed one of the steps, and an identity of an organization to which belongs a system on which one of the steps was performed.

In one embodiment, parameters machine learning-based model that may be utilized to identify executions of the BP are generated based on a training set generated based on a positive set of sequences and a negative set of sequences, utilizing one or more training algorithms. The positive set includes sequences of steps corresponding to executions of the BP and the negative set includes sequences of steps that do not correspond to executions of the BP (e.g., sequences of steps corresponding to executions of other BPs). Examples of training algorithms may include algorithms for learning parameters of: regression models, neural networks, support vector machines, decision trees, and other forms of classifiers. In another embodiment, multiple sets of sequences, each corresponding to executions of a certain BP from among multiple BPs, may be utilized to train a classifier. In this embodiment, the classifier may be used to classify a given sequence of steps to one or more classes, each class corresponding to executions of a BP from among the multiple BPs.

In one embodiment, a model of a BP comprising parameters of a machine learning-based model may be utilized to identify executions of the BP. In one example, a candidate sequence is converted to features values and provided to a module that utilizes the model to determine whether the candidate sequence corresponds to an execution of the BP or to which (if any) of multiple BPs the candidate sequence corresponds (e.g., in a case in which the machine learning-based model was for a classifier).

In some embodiments, a BP may be considered to be a compound BP, which is a BP that involves a plurality of subprocesses. Each subprocess involves performing one or more steps. In some embodiments, each subprocess may be considered a BP in its own right and be described by a model such as the models mentioned above (e.g., a pattern, an automaton, or a machine learning-based model). Thus, in some embodiments, a model of a compound BP may include a plurality of models of BPs corresponding to the subprocesses that may be part of the compound BP. Optionally, the model of the compound BP includes data describing an order of execution of at least some of the subprocesses. Optionally, the model of the compound BP describes a graph; paths in the graph represent different combinations (and orders) of executing subprocesses that make up the compound BP. Optionally, the graph may indicate that an order of execution of some subprocess may be arbitrary and/or that some of the subprocesses may be executed concurrently. The reference Conforti, et al. “BPMN Miner: Automated discovery of BPMN process models with hierarchical structure.” Information Systems 56 (2016): 284.-303, describes some approaches that may be utilized to discover models of compound BPs from monitoring data.

Is some embodiments, a BP may be considered to have different variants, each corresponding to a slightly different sequence of steps. Optionally, each variant of the BP may be described by a model of the variant, which may be any one of the models of a BP described above. Typically, the difference between sequences corresponding to executions of different variants of a BP is smaller than the difference between sequences corresponding to different BPs. In one example, the difference between a first and second variant of a BP may amount to one or more steps that are performed as part of executions of the first variant, and are not performed as part of executions of the second variant. Optionally, when using a distance function (e.g., an alignment based distance function), the average distance between pairs sequences of steps corresponding to executions of the same variant of a BP is smaller than the average distance between pairs of sequences of steps corresponding to executions of different variants of the BP.

Identifying different variants of a BP may be done using clustering of sequences of steps corresponding to executions of the BP, with each of the clusters comprising sequences corresponding to executions of a certain variant of the BP. Optionally, the number of clusters (variants) may be pre-selected and/or may be pre-determined based on the number of sequences being clustered. Optionally, the number of clusters may be determined based on various criteria known in the art, relying on various criteria known in the art such as criteria that are based on intra-cluster vs. inter-cluster distances.

In some embodiments, a model of a BP may be generated based primarily on sequences of steps corresponding to executions of the BP, which are associated with a certain organization. As such, the model may represent how the BP is executed at the certain organization (e.g., the model may correspond to certain variants used at the certain organization). However, in other embodiments, the model of the BP may be generated based on training data comprising a plurality of executions of the BP, which are associated with a plurality of organizations. For example, the plurality of executions of the BP comprises at least a first execution of the BP associates with a first organization and the second execution of the BP associated with a second organization that is different from the first organization. When a model is generated based on executions associated with multiple organizations, it may be considered a “crowd-based” model. A crowd-based model of the BP may capture various general aspects of how the BP is executed, which may be common for many organizations. Optionally, the crowd-based model of the BP may also reduce the influence of various organization-specific aspects of executing the BP, which for many organizations, are not part of executions the BP. Thus, crowd-based models sometimes have an advantage that they are general, and often suitable for detecting many variants of the BP that may be used in different organizations. This may be helpful when the model is provided to a new organization in order to detect executions of the BP in streams of steps generated from monitoring activity of the new organization. Using a general model of the BP may make it possible to identify executions of the BP associated with the new organization, even if the new organization's method of executing the BP does not accurately conform to any single organization's method of executing the BP (from among the organizations that contributed to the training set used to generate the model).

Referring back to FIG. 26, one or more models of a BP, such as the crowd-based model 118 may be utilized, in some embodiments, to identify to which BPs various candidate sequences correspond. Herein, a sequence of steps is considered to correspond to a BP if the sequence of steps describes steps performed in an execution of the BP; in this case, the sequence may also be considered to “correspond to an execution of the BP”).

The BP-Identifier module 126 is configured, in one embodiment, to utilize the crowd-based model 118 of a BP to identify, from among the candidate sequences 124, one or more sequences of steps that correspond to executions 128 of the BP. Optionally, most of the candidate sequences 124 are not identified as corresponding to executions of the BP. Optionally, at least some of the identified sequences comprise only steps the correspond to the an execution of the BP. Optionally, at least some of the identified sequences may comprise some steps that do not correspond to an execution of the BP, and as such, those sequences may be considered corresponding to nonconsecutive executions of the BP (which are discussed in more detail further below).

In one embodiment, identifying a sequence as corresponding to an execution of the BP involves calculating a value indicative of a distance between the sequence and a pattern from the model 118, which describes a reference sequence of steps corresponding to an execution of the BP. Optionally, a sequence is identified as corresponding to the execution of the BP if the distance between the sequence and the reference sequence described by the pattern reaches a threshold. Optionally, the distance is calculated using a sequence alignment algorithm such as pairwise trace alignment described in Bose, et al. “Trace alignment in process mining: opportunities for process diagnostics”, International Conference on Business Process Management, Springer Berlin Heidelberg, 2010.

In another embodiment, identifying a sequence as corresponding to an execution of a BP involves finding a path in a graphical representation of the BP (e.g., a BPMN model) included in the model 118. Optionally, the BP-Identifier module 126 provides a description of a path in the graph (from among a plurality of possible paths) to which the sequence corresponds.

In yet another embodiment, identifying a sequence as corresponding to an execution of the BP involves providing the sequence as an input to an automaton whose parameters are described in the model 118. Optionally, the result of miming the automaton on the sequence is indicative of whether the sequence corresponds to an execution of the BP (e.g., the sequence corresponds to an execution of the BP if the automaton reaches an accepting state).

In still another embodiment, identifying a sequence as corresponding to an execution of a BP involves generating feature values based on the sequence, and utilizing the model 118 to calculate, based on the feature values, a value indicative of whether the sequence corresponds to an execution of the BP. Optionally, in this embodiment, the model 118 includes parameters of a machine learning-based model that is utilize for calculating the value.

Some of the embodiments described herein involve evaluating the candidate sequences separately. However, when sequences of steps are represented as symbols, then the BP-Identifier module 126 may utilize various efficient techniques known in the art that involve string matching to rapidly identify, from among the candidate sequences 124, sequences corresponding to executions of BPs. In one embodiment, the candidate sequences 124 are stored in a data structure that allows a rapid determination of presence and/or absence of a certain string (e.g., a hash table or a suffix tree). Thus, even a very large number of candidate sequences may be searched quickly to determine which of them match a sequence corresponding to a pattern of a BP. This approach may be extended to enable identification of candidate sequences that are similar, but not necessarily identical, to a sequence corresponding to a pattern of a BP. For example, the BP-Identifier module 126 may utilize various approximate string-matching algorithms to identify the sequences corresponding to executions of BPs. Examples of such algorithms are discussed in detail in Navarro, G. “A guided tour to approximate string matching”, in ACM computing surveys (CSUR) 33.1 (2001): 31-88. In one example, the BP-Identifier module 126 may store candidate sequences in a suffix tree and efficiently detect sequences corresponding to executions of BPs using the approaches discussed in Ukkonen, E. “Approximate string-matching over suffix trees”, in Annual Symposium on Combinatorial Pattern Matching, Springer Berlin Heidelberg, 1993.

6—Additional Considerations

FIG. 27 is a schematic illustration of a computer 400 that is able to realize one or more of the embodiments discussed herein. The computer 400 may be implemented in various ways, such as, but not limited to, a server, a client, a personal computer, a set-top box (STB), a network device, a handheld device (e.g., a smartphone), and/or any other computer form capable of executing a set of computer instructions. Further, references to a computer include any collection of one or more computers that individually or jointly execute one or more sets of computer instructions utilized to perform any one or more of the disclosed embodiments.

The computer 400 includes one or more of the following components: processor 401, memory 402, computer-readable medium 403, user interface 404, communication interface 405, and bus 406. In one example, the processor 401 may include one or more of the following components: a general-purpose processing device, a microprocessor, a central processing unit, a complex instruction set computing (CISC) microprocessor, a reduced instruction set computing (RISC) microprocessor, a very long instruction word (VLIW) microprocessor, a special-purpose processing device, an application specific integrated circuit (ASIC), a field programmable gate array (FPGA), a digital signal processor (DSP), a distributed processing entity, and/or a network processor. Continuing the example, the memory 402 may include one or more of the following memory components: CPU cache, main memory, read-only memory (ROM), dynamic random access memory (DRAM) such as synchronous DRAM (SDRAM), flash memory, static random access memory (SRAM), and/or a data storage device. The processor 401 and the one or more memory components may communicate with each other via a bus, such as bus 406.

Still continuing the example, the communication interface 405 may include one or more components for connecting to one or more of the following: LAN, Ethernet, intranet, the Internet, a fiber communication network, a wired communication network, and/or a wireless communication network. Optionally, the communication interface 405 is used to connect with the network 408. Additionally or alternatively, the communication interface 405 may be used to connect to other networks and/or other communication interfaces. Still continuing the example, the user interface 404 may include one or more of the following components: (i) an image generation device, such as a video display, an augmented reality system, a virtual reality system, and/or a mixed reality system, (ii) an audio generation device, such as one or more speakers, (iii) an input device, such as a keyboard, a mouse, a gesture based input device that may be active or passive, and/or a brain-computer interface.

Functionality of various embodiments may be implemented in hardware, software, firmware, or any combination thereof. If implemented at least in part in software, implementing the functionality may involve a computer program that includes one or more instructions or code stored or transmitted on a computer-readable medium and executed by one or more processors. Computer-readable media may include computer-readable storage media, which corresponds to a tangible medium such as data storage media, or communication media including any medium that facilitates transfer of a computer program from one place to another. Computer-readable medium may be any media that can be accessed by one or more computers to retrieve instructions, code and/or data structures for implementation of the described embodiments. A computer program product may include a computer-readable medium.

In one example, the computer-readable medium 403 may include one or more of the following: RAM, ROM, EEPROM, optical storage, magnetic storage, biologic storage, flash memory, or any other medium that can store computer readable data, Additionally, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL. or wireless technologies such as infrared, radio, and microwave are included in the definition of a medium. It should be understood, however, that computer-readable medium does not include connections, carrier waves, signals, or other transient media, but are instead directed to non-transient, tangible storage media.

A computer program (also known as a program, software, software application, script, program code, or code) can be written in any form of programming language, including compiled or interpreted languages, declarative or procedural languages. The program can be deployed in any form, including as a standalone program or as a module, component, subroutine, object, or another unit suitable for use in a computing environment. A computer program may correspond to a file in a file system, may be stored in a portion of a file that holds other programs or data, and/or may be stored in one or more files that may he dedicated to the program. A computer program may be deployed to be executed on one or more computers that are located at one or more sites that may be interconnected by a communication network,

Computer-readable medium may include a single medium and/or multiple media (e.g., a centralized or distributed database, and/or associated caches and servers) that store the one or more sets of instructions. In various embodiments, a computer program, and/or portions of a computer program, may be stored on a non-transitory computer-readable medium. The non-transitory computer-readable medium may be implemented, for example, via one or more of a volatile computer memory, a non-volatile memory, a hard drive, a flash drive, a magnetic data storage, an optical data storage, and/or any other type of tangible computer memory to be invented that is not transitory signals per se. The computer program may be updated on the non-transitory computer-readable medium and/or downloaded to the non-transitory computer-readable medium via a communication network such as the Internet. Optionally, the computer program may be downloaded from a central repository.

At least some of the methods described in this disclosure, which may also be referred to as “computer-implemented methods”, are implemented on a computer, such as the computer 400. When implementing a method from among the at least some of the methods, at least some of the steps belonging to the method are performed by the processor 401 by executing instructions. Additionally, at least some of the instructions for running methods described in this disclosure and/or for implementing systems described in this disclosure may be stored on a non-transitory computer-readable medium.

Some of the embodiments described herein include a number of modules. Modules may also be referred to herein as “components” or “functional units”. Additionally, modules and/or components may be referred to as being “computer executed” and/or “computer implemented”; this is indicative of the modules being implemented within the context of a computer system that typically includes a processor and memory. Generally, a module is a component of a system that performs certain operations towards the implementation of a certain functionality.

The following is a general comment about the use of reference numerals in this disclosure. It is to be noted that in this disclosure, as a general practice, the same reference numeral is used in different embodiments for a module when the module performs the same functionality (e.g., when given essentially the same type/format of data). Thus, as typically used herein, the same reference numeral may be used for a module that processes data even though the data may be collected in different ways and/or represent different things in different embodiments. For example, the reference numeral 126 is used to denote the BP-Identifier module in various embodiments described herein. The functionality may be the essentially the same in each of the different embodiments—the BP-Identifier module 126 identifies sequences of steps corresponding to executions of a BP; however, in each embodiment, the sequences that are evaluated may be different and/or a model used to evaluate the sequences may be different. For example_{;} in one embodiment, the sequences may be based on interactions of users from a certain organization with instances of a certain software system, and in another embodiment, the sequences may be based on interactions of users from a plurality of organizations interacting with instances of more than one software system.

It is to be further noted that though the use of the convention described above that involves using the same reference numeral for modules is a general practice in this disclosure, it is not necessarily implemented with respect to all embodiments described herein. Modules referred to by different reference numerals may perform the same (or similar) functionality, and the fact that they are referred to in this disclosure by a different reference numeral does not necessarily mean that they might not have the same functionality.

Executing modules included in embodiments described in this disclosure typically involves hardware. For example, a computer system such as the computer system illustrated in FIG. 27 may be used to implement one or more modules. In another example, a module may comprise dedicated circuitry or logic that is permanently configured to perform certain operations (e.g., as a special-purpose processor, or an application-specific integrated circuit (ASIC)). Additionally or alternatively, a module may comprise programmable logic or circuitry (e.g., as encompassed within a general-purpose processor or a field programmable gate array (FPGA)) that is temporarily configured by software/firmware to perform certain operations.

In some embodiments, a processor implements a module by executing instructions that implement at least some of the functionality of the module. Optionally, a memory may store the instructions (e.g., as computer code), which are read and processed by the processor, causing the processor to perform at least some operations involved in implementing the functionality of the module. Additionally or alternatively, the memory may store data (e.g., measurements of affective response), which is read and processed by the processor in order to implement at least some of the functionality of the module. The memory may include one or more hardware elements that can store information that is accessible to a processor. In some cases, at least some of the memory may be considered part of the processor or on the same chip as the processor, while in other cases, the memory may be considered a separate physical element than the processor. Referring to FIG. 27 for example, one or more processors 401, may execute instructions stored in memory 402 (that may include one or more memory devices), which perform operations involved in implementing the functionality of a certain module.

The one or more processors 401 may also operate to support performance of the relevant operations in a “cloud computing” environment. Additionally or alternatively, some of the embodiments may be practiced in the form of a service, such as infrastructure as a service (IaaS), platform as a service (PaaS), software as a service (SaaS), and/or network as a service (NaaS). For example, at least some of the operations involved in implementing a module, may be performed by a group of computers accessible via a network (e.g., the Internet) and/or via one or more appropriate interfaces (e.g., application program interfaces (APIs)). Optionally, some of the modules may be executed in a distributed manner among multiple processors. The one or more processors 401 may be located in a single geographic location (e.g., within a home environment, an office environment, or a server farm), and/or distributed across a number of geographic locations. Optionally, some modules may involve execution of instructions on devices that belong to the users and/or are adjacent to the users. For example, procedures that involve data preprocessing and/or presentation of results may run, in part or in full, on processors belonging to devices of the users (e.g., smartphones and/or wearable computers). In this example, preprocessed data may further be uploaded to cloud-based servers for additional processing. Additionally, preprocessing and/or presentation of results for a user may be performed by a software agent that operates on behalf of the user.

In some embodiments, modules may provide information to other modules, and/or receive information from other modules. Accordingly, such modules may be regarded as being communicatively coupled. Where multiple of such modules exist contemporaneously, communications may be achieved through signal transmission (e.g., over appropriate circuits and buses). In embodiments in which modules are configured and/or instantiated at different times, communications between such modules may be achieved, for example, through the storage and retrieval of information in memory structures to which the multiple modules have access. For example, one module may perform an operation and store the output of that operation in a memory device to which it is communicatively coupled. A different module may then, at a later time, access the memory device to retrieve and process the stored output.

It is to be noted that in the claims, when a dependent system I formulated according to a structure similar to the following: “further comprising module X configured to do Y”, it is to be interpreted as: “the memory is further configured to store module X, the processor is further configured to execute module X, and module X is configured to do Y”.

Modules and other system elements (e.g., databases or models) are typically illustrated in figures in this disclosure as geometric shapes (e.g., rectangles) that may be connected via lines. A line between two shapes typically indicates a relationship between the two elements the shapes represent, such as a communication that involves an exchange of information and/or control signals between the two elements. This does not imply that in every embodiment there is such a relationship between the two elements, rather, it serves to illustrate that in some embodiments such a relationship may exist. Similarly, a directional connection (e.g., an arrow) between two shapes may indicate that, in some embodiments, the relationship between the two elements represented by the shapes is directional, according the direction of the arrow (e.g., one element provides the other with information). However, the use of an arrow does not indicate that the exchange of information between the elements cannot be in the reverse direction too.

The illustrations in this disclosure depict some, but not necessarily all, the connections between modules and/or other system element. Thus, for example, a lack of a line connecting between two elements does not necessarily imply that there is no relationship between the two elements, e.g., involving some form of communication between the two. Additionally, the depiction in an illustration of modules as separate entities is done to emphasize different functionalities of the modules. In some embodiments, modules that are illustrated and/or described as separate entities may in fact be implemented via the same software program, and in other embodiments, a module that is illustrates and/or described as being a single element may in fact be implemented via multiple programs and/or involve multiple hardware elements, possibly at different locations.

With respect to computer systems described herein, various possibilities may exist regarding how to describe systems implementing a similar functionality as a collection of modules. For example, what is described as a single module in one embodiment may be described in another embodiment utilizing more than one module. Such a decision on separation of a system into modules and/or on the nature of an interaction between modules may be guided by various considerations. One consideration, which may be relevant to some embodiments, involves how to clearly and logically partition a system into several components, each performing a certain functionality. Thus, for example, hardware and/or software elements that are related to a certain functionality may belong to a single module. Another consideration that may be relevant for some embodiments, involves grouping hardware elements and/or software elements that are utilized in a certain location together. For example, elements that operate at the user end may belong to a single module, while other elements that operate on a server side may belong to a different module. Still another consideration, which may be relevant to some embodiments, involves grouping together hardware and/or software elements that operate together at a certain time and/or stage in the lifecycle of data.

As used herein, any reference to “one embodiment” or “an embodiment” means that a particular element, feature, structure, or characteristic described in connection with the embodiment is included in at least one embodiment. Moreover, separate references to “one embodiment” or “some embodiments” in this description do not necessarily refer to the same embodiment. Additionally, references to “one embodiment” and “another embodiment” may not necessarily refer to different embodiments, but may be terms used, at times, to illustrate different aspects of an embodiment. Similarly, references to “some embodiments” and “other embodiments” may refer, at times, to the same embodiments.

Herein, a predetermined value, such as a threshold, a predetermined rank, or a predetermined level, is a fixed value and/or a value determined any time before performing a calculation that compares a certain value with the predetermined value. Optionally, a first value may be considered a predetermined value when the logic (e.g., circuitry, computer code, and/or algorithm), used to compare a second value to the first value, is known before the computations used to perform the comparison are started.

Some embodiments may be described using the verb “indicating”, the adjective “indicative”, and/or using variations thereof. Herein, sentences in the form of “X is indicative of Y” mean that X includes information correlated with Y, up to the case where X equals Y. Additionally, sentences in the form of “provide/receive an indication indicating whether X happened” refer herein to any indication method, including but not limited to: sending/receiving a signal when X happened and not sending/receiving a signal when X did not happen, not sending/receiving a signal when X happened and sending/receiving a signal when X did not happen, and/or sending/receiving a first signal when X happened and sending/receiving a second signal X did not happen.

As used herein, the terms “comprises,” “comprising,” “includes,” “including,” “has,” “having”, or any other variation thereof, indicate an open claim language that does not exclude additional limitations. As used herein “a” or “an” are employed to describe “one or more”, and reference to an element in the singular is not intended to mean “one and only one” unless specifically so stated, but rather “one or more”. Additionally, the phrase “based on” is intended to mean “based, at least in part, on”. For example, stating that feature values are generated “based on a sequence” means that generation of at least some of the feature values may utilize, in addition to information derived from the sequence, additional data that is not in the sequence, such as contextual data that involves prior activity (e.g., execution of various BPs by an organization).

Though this disclosure in divided into sections having various titles, this partitioning is done just for the purpose of assisting the reader and is not meant to be limiting in any way. In particular, embodiments described in this disclosure may include elements, features, components, steps, and/or modules that may appear in various sections of this disclosure that have different titles. Furthermore, section numbering and/or location in the disclosure of subject matter are not to be interpreted as indicating order and/or importance. For example, a method may include steps described in sections having various numbers. These numbers and/or the relative location of the section in the disclosure are not to be interpreted in any way as indicating an order according to which the steps are to be performed when executing the method.

It is to be noted that essentially the same embodiments may be described in different ways. In one example, a first description of a computer system may include descriptions of modules used to implement it. A second description of essentially the same computer system may include a description of operations that a processor is configured to execute (which implement the functionality of the modules belonging to the first description). The operations recited in the second description may he viewed, in sonic cases, as corresponding to steps of a method that performs the functionality of the computer system. In another example, a first description of a computer-readable medium may include a description of computer code, which when executed on a processor performs operations corresponding to certain steps of a method. A second description of essentially the same computer-readable medium may include a description of modules that are to be implemented by a computer system having a processor that executes code stored on the computer-implemented medium. The modules described in the second description may be viewed, in some cases, as producing the same functionality as executing the operations corresponding to the certain steps of the method.

While the methods disclosed herein may be described and shown with reference to particular steps performed in a particular order, it is understood that these steps may be combined, sub-divided, and/or reordered to form an equivalent method without departing from the teachings of some of the embodiments. Accordingly, unless specifically indicated herein, the order and grouping of the steps is not a limitation of the embodiments. Furthermore, methods and mechanisms of some of the embodiments will sometimes be described in singular form for clarity. However, some embodiments may include multiple iterations of a method or multiple instantiations of a mechanism unless noted otherwise.

Embodiments described in conjunction with specific examples are presented by way of example, and not limitation. Moreover, it is evident that many alternatives, modifications, and variations will be apparent to those skilled in the art. It is to be understood that other embodiments may be utilized. and structural changes may he made without departing from the scope of the appended claims and their equivalents.

We claim:

1. A system configured to warn about performance of steps that lead to an unsuccessful execution of
a business process (BP), comprising:
memory configured to store computer executable modules; and
one or more processors configured to execute the computer executable modules; the computer executable modules comprising:
a monitoring agent configured to monitor interactions with an instance of a software system belonging to a certain organization and to generate a stream comprising steps performed as part of the interaction; and
a warning module configured to receive a model generated based on training data comprising prefixes of sequences corresponding to unsuccessful executions of one or more BPs, and to utilize the model to make a determination whether the stream comprises a certain sequence of steps that corresponds to a prefix of an unsuccessful execution of a BP; wherein the training data comprises first and second sequences corresponding to executions of the BP associated with first and second organizations, respectively;
the warning module is further configured to issue a warning responsive to a determination that the stream comprises the certain sequence.

2. The system of claim 1, wherein the monitoring agent comprises a software element installed on a client machine on which runs a user interface (UI) used by a user to execute a BP from among the one or more BPs; wherein the software element monitors information exchanged between the client and the instance of the software system, but does not alter the information in a way that affects the execution of the BP; whereby disabling the software element does not impede the execution of the BP. The system of claim 1, wherein the monitoring agent is configured to utilize an Application Program Interface (API) of the software system, which causes the instance of the software system to execute a certain procedure that provides the monitoring agent with data indicative of at least some steps that belong to the stream.

4. The system of claim 1, wherein a user executes a packaged application on the instance of the software system; and wherein the monitoring agent is configured to perform at least one of the following operations: (i) initiate an execution, on the instance of the software system, of a function of the packaged application. (ii) retrieve, via a query sent to the instance of the software system, a record from a database, and (iii) access a log file created by the instance of the software system.

5. The system of claim 1, wherein an execution of a BP is associated with an organization if at least one of the following statements is true: (i) at least some steps involved in the execution of the BP are performed by a user belonging to the organization, and (ii) at least some steps involved in the execution of the BP are executed on a certain instance of a software system belonging to the organization.

6. The system of claim 1, wherein the training data further comprises a third sequence corresponding to an unsuccessful execution of a second BP associated, which is associated with the first organization; and wherein the second BP is different from the BP.

7. The system of claim 1, wherein the certain sequence does not comprise a step indicative of the unsuccessful execution of the BP.

8. The system of claim 1, wherein the warning module is further configured to utilize the model to calculate a value indicative of a probability that the certain sequence is a prefix of a sequence corresponding to an unsuccessful execution of a BP; and wherein when the probability reaches a threshold, the warning module issues the warning.

9. The system of claim 1, wherein the model comprises a description of one or more patterns; and wherein the one or more patterns comprise a pattern describing a sequence of steps involved in unsuccessful executions of one or more BPs.

10. The system of claim 1, wherein the model describes one or more automatons, each configured to recognize a prefix of a sequence corresponding to an unsuccessful execution of one or more BPs.

11. The system of claim 1, wherein the model comprises parameters used by a machine learning-based predictor configured to receive feature values determined based on a sequence of steps and to calculate a value indicative of a probability that the sequence of steps represents a prefix of a sequence corresponding to an unsuccessful execution of a BP.

12. A method for warning about performance of steps that lead to an unsuccessful execution of a business process (BP), comprising:
monitoring interactions with an instance of a software system belonging to a certain organization and generating a stream comprising steps performed as part of the interaction;
receiving, by a system comprising a processor and memory, a model generated based on training data comprising prefixes of sequences corresponding to unsuccessful executions of BPs; wherein the training data comprises first and second sequences corresponding to executions of the BP associated with first and second organizations, respectively;
determining, utilizing the model, whether the stream comprises a certain sequence of steps that corresponds to a prefix of an unsuccessful execution of the BP; and
responsive to a determination that the stream comprises the certain sequence, issuing a warning.

13. The method of claim 12, further comprising generating the model based on the training data.

14. The method of claim 13, wherein generating the model comprises determining one or more patterns based on the sequences belonging to the training data; wherein the one or more patterns comprise a pattern describing a sequence of steps involved in unsuccessful execution of one or more of BPs; and wherein the model comprises a description of the one or more patterns.

15. The method of claim 13, wherein generating the model comprises generating one or more automatons, each configured to recognize a prefix of a sequence corresponding to an unsuccessful execution of one or more of the BPs; and wherein the model comprises a description of the one or more automatons.

16. The method of claim 13, wherein generating the model comprises calculating parameters used by a machine learning-based predictor configured to receive feature values determined based on a sequence of steps and to calculate a value indicative of a probability that the sequence of steps represents a prefix of a sequence corresponding to an unsuccessful execution of a BP from among one or more of BPs; and wherein the model comprises a description of the parameters.

17. The method of claim 12, further comprising utilizing the model to determine a value indicative of a probability that the certain sequence is a prefix of a sequence corresponding to an unsuccessful execution of the BP and issuing the warning when the probability reaches a threshold.

18. A non-transitory computer-readable medium having instructions stored thereon that, in response to execution by a system including a processor and memory, causes the system to perform operations comprising:
monitoring interactions with an instance of a software system belonging to a certain organization and to generate a stream comprising steps performed as part of the interaction;
receiving a model generated based on training data comprising prefixes of sequences corresponding to unsuccessful executions of BPs; wherein the training data comprises first and second sequences corresponding to executions of the BP associated with first and second organizations, respectively;
determining, utilizing the model, whether the stream comprises a certain sequence of steps that corresponds to a prefix of an unsuccessful execution of a BP; and
responsive to a determination that the stream comprises the certain sequence, issuing a warning.

19. The non-transitory computer-readable medium of claim 18, further comprising instructions defining a step of generating the model based on the training data.

20. The non-transitory computer-readable medium of claim 18, further comprising instructions defining a step of utilizing the model to determine a value indicative of a probability that the certain sequence is a prefix of a sequence corresponding to an unsuccessful execution of a BP and issuing the warning when the probability reaches a threshold.
